(19) United States
(12) Patent Application Publication
(10) Pub. No.: US 2026/0234168 A1
(43) Pub. Date: Aug. 13, 2026

(54) Metallocene Catalyst Compounds Having Ferrocenyl Substituents

(71) Applicant: ExxonMobil Technology and Engineering Company, Spring, TX (US)

(72) Inventors: Nikola S. Lambic, Seabrook, TX (US); Gregory J. Smith-Karahalis, Houston, TX (US); Alex E. Carpenter, Austin, TX (US); Alexander Z. Voskoboynikov, Moscow (RU); Jo Ann M. Canich, Houston, TX (US); Dmitry V. Uborsky, Moscow (RU); Oleg V. Samsonov, Moscow (RU); Andrei N. Iashin, Moscow (RU); Alexey A. Tsarev, Moscow (RU); Ilya S. Borisov, Moscow (RU)

(21) Appl. No.: 19/154,681

(22) PCT Filed: Feb. 28, 2024
(86) PCT No.: PCT/US2024/017717

§ 371 Date: Aug. 7, 2025

Related U.S. Application Data
(60) Provisional application No. 63/484,899, filed on Feb. 14, 2023.

(51) Int. Cl. C07F 7/08; C07F 7/28; C07F 19/00; C08F 10/02; C08F 10/06

(52) U.S. Cl. CPC C07F 7/081; C07F 7/28; C07F 19/00; C08F 10/02; C08F 10/06

(57) ABSTRACT

In some embodiments, a catalyst compound is represented by Formula (I):

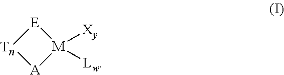

M is a group 3-5 metal, a lanthanide metal atom, or an actinide metal atom. E is a substituted polycyclic arenyl ligand bonded to M and is substituted by at least one ferrocenyl substituent bonded to an aromatic six-membered ring of the polycyclic arenyl ligand. A is a monoanionic ligand bonded to M. n is 0 or 1. T is bonded to A and E, and is a bridging group containing a group 13, 14, 15, or 16 element, and is present when n is one and absent when n is zero. Each instance of X is independently a univalent anionic ligand, or two Xs are joined and bound to M to form a metallocycle ring, or two Xs are joined to form a chelating ligand, a diene ligand, or an alkylidene ligand.

### CROSS REFERENCE TO RELATED APPLICATIONS

This application claims priority to and the benefit of U.S. Provisional Application No. 63/484,899, filed Feb. 14, 2023, the disclosure of which is incorporated herein by reference in its entirety.

### FIELD

The present disclosure relates to metallocene catalyst compounds having ferrocenyl substituents, catalyst systems comprising such compounds, and uses thereof.

### BACKGROUND

Olefin polymerization catalysts are of great use in industry and polyolefins are widely used commercially because of their robust physical properties. Hence, there is interest in finding new catalysts that increase commercialization of the catalysts and allow the production of polymers having improved properties.

For example, various types of polyethylenes, including high density, low density, and linear low density polyethylenes, are commercially valuable. Polyolefins, including polyethylenes or polypropylenes may be synthesized with transition metal catalyst compounds, which are typically activated with alumoxanes or activators containing a non-coordinating anion. The use of catalyst compounds in combination with activators creates a catalyst system that may provide the ability to modulate polyolefin properties including polymer structure and composition, such as molecular weight, comonomer incorporation, melt temperature, and/or (in the case polypropylenes) tacticity. Isotacticity, for example, provides increased crystallinity of a polypropylene polymer chain which provides increased mechanical strength, as compared to atactic polypropylene counterparts. The ability to alter polyolefin properties is a long sought after goal within the field of polymer synthesis. There is a continuing need for improved polymerization catalysts.

Improvements in polymerization catalysis may arise from catalysts with high activities capable of producing polyolefins with: high molecular weights, controllable molecular weights, narrow polydispersity indices, or high comonomer incorporation. A catalyst capable of one or more of the aforementioned improvements is valuable, but even more so if a catalyst combines a number of improvements into an overall advantage over prior catalysts or catalyst systems.

For example, polyolefins, which have high molecular weight, generally have desirable mechanical properties over their lower molecular weight counterparts. However, high molecular weight polyolefins can be difficult to process and can be costly to produce. Furthermore, polyolefins, such as polyethylene, may have a comonomer, such as octene, incorporated into the polyethylene backbone, which can improve processability while maintaining most, if not all, of the mechanical property advantages provided by high molecular weight. The comonomer content of a polyolefin (e.g., wt % of comonomer incorporated into a polyolefin backbone) influences the properties of the polyolefin (and composition of the copolymers) and is affected by the polymerization catalyst.

In addition, even if desired polymer properties could be obtained, conventional catalysts used for forming polyolefins often have low catalyst activity.

There is a need for new and improved catalyst compounds and catalyst systems capable of forming polyolefins at high activity that produce polyolefins having properties, such as controllable molecular weights, high melting point, high comonomer incorporation, narrow polydispersity index, and/or isotacticity.

References for citing in an Information Disclosure Statement (37 C.F.R. 1.97(h)): CN107903346; KR2017087131; DE4417542; U.S. Pat. No. 5,521,265; EP673946; CN107814861; Y. Zhong, et al., Dalton Transactions, 346-354, 50(1), 2021; C. Elschenbroich, et al., Polyhedron, 300-305, 79, 2014; K. Unverhau, et al., Dalton Transactions, 3724-3736, 40(14), 2011; A. Jakob, et al., J. Org. Chem., 3542-3547, 694(22), 2009; P. Witte, et al., Organometallics, 4147-4155, 18(20), 1999; K. Kimura, et al., Chem. Lett., 571-572, (7), 1998; P. Scott, et al., Organometallics, 3094-3101, 12(8), 1993.

### SUMMARY

The present disclosure relates to metallocene catalyst compounds having ferrocenyl substituents, catalyst systems comprising such compounds, and uses thereof.

In some embodiments, a catalyst compound is represented by Formula (I):

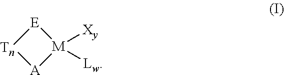

M is a group 3-5 metal, a lanthanide metal atom, or an actinide metal atom. E is a substituted polycyclic arene ligand bonded to M and is substituted by at least one ferrocenyl substituent bonded to an aromatic six-membered ring of the polycyclic arene ligand. A is a monoanionic ligand bonded to M. n is 0 or 1. T is bonded to A and E, and is a bridging group containing a group 13, 14, 15, or 16 element, and is present when n is one and absent when n is zero. Each instance of X is independently a univalent anionic ligand, or two Xs are joined and bound to M to form a metallocycle ring, or two Xs are joined to form a chelating ligand, a diene ligand, or an alkylidene ligand. Each instance of L is independently a Lewis base, or two Ls are joined and bound to M to form a bidentate Lewis base. An X may be joined to an L to form a monoanionic bidentate group. y is 1, 2, or 3. w is 0, 1, or 2. y+w is 4 or less.

In yet another aspect, embodiments of the present disclosure provide a catalyst system comprising an activator and a catalyst compound of the present disclosure.

In still another aspect, embodiments of the present disclosure provide a polymerization process comprising a) contacting one or more olefin monomers with a catalyst system comprising: i) an activator and ii) a catalyst compound of the present disclosure.

### Definitions

For the purposes of this disclosure and the claims herein, the definitions and conventions below shall apply.

For the purposes of the present disclosure, the numbering scheme for the Periodic Table Groups is used as described in Chemical and Engineering News, 63(5), pg. 27 (1985).

The following abbreviations may be used herein: Fc is ferrocenyl, Me is methyl, Et is ethyl, Ph is phenyl, tBu is tertiary butyl, PDI is polydispersity index, MAO is methylalumoxane, SMAO is supported methylalumoxane, NMR is nuclear magnetic resonance, ppm is part per million, THE is tetrahydrofuran, RPM is revolutions per minute.

As used herein, olefin polymerization catalyst(s) refer to any catalyst, such as an organometallic complex or compound that is capable of coordination polymerization addition where successive monomers are added in a monomer chain at the organometallic active center.

The terms “substituent,” “radical,” “group,” and “moiety” may be used interchangeably.

An “olefin,” alternatively referred to as “alkene,” is a linear, branched, or cyclic compound of carbon and hydrogen having at least one double bond. For purposes of this specification, when a polymer or copolymer is referred to as including an olefin, the olefin present in such polymer or copolymer is the polymerized form of the olefin. For example, when a copolymer is said to have an “ethylene” content of 35 wt % to 55 wt %, it is understood that the mer unit in the copolymer is derived from ethylene in the polymerization reaction and said derived units are present at 35 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. “Different” is used to refer to mer units indicates that the mer units differ from each other by at least one atom or are different isomerically. Accordingly, the definition of copolymer, as used herein, includes terpolymers. An “ethylene polymer” or “ethylene copolymer” (both of which are examples of a “polyethylene”) is a polymer or copolymer including at least 50 mol % ethylene derived units. A “propylene polymer” or “propylene copolymer” (both of which are examples of a “polypropylene”) is a polymer or copolymer including at least 50 mol % propylene derived units, and so on. An “ethylene polymer” or “ethylene copolymer” is a polymer or copolymer including at least 50 mol % ethylene derived units, a “propylene polymer” or “propylene copolymer” is a polymer or copolymer including at least 50 mol % propylene derived units, and so on.

As used herein, “polyethylene” can include “ethylene homopolymer”, “ethylene copolymer”, or combinations thereof “Polypropylene” can include “propylene homopolymer”, “propylene copolymer”, or combinations thereof.

The term “alpha-olefin” refers to an olefin having a terminal carbon-to-carbon double bond in the structure thereof ((R″R″′)—C═CH₂, where R″ and R″′ can be independently hydrogen or any hydrocarbyl group; such as R″ is hydrogen and R″′ is an alkyl group). A “linear alpha-olefin” is an alpha-olefin defined in this paragraph wherein R″ is hydrogen, and R″′ is hydrogen or a linear alkyl group.

For the purposes of the present disclosure, ethylene shall be considered an alpha-olefin.

As used herein, and unless otherwise specified, the term “Cₙ” means hydrocarbon(s) having n carbon atom(s) per molecule, wherein n is a positive integer. The term “hydrocarbon” means a class of compounds containing hydrogen bound to carbon, and encompasses (i) saturated hydrocarbon compounds, (ii) unsaturated hydrocarbon compounds, and (iii) mixtures of hydrocarbon compounds (saturated and or unsaturated), including mixtures of hydrocarbon compounds having different values of n. Likewise, a “Cₘ-C_{y}” group or compound refers to a group or compound including carbon atoms at a total number thereof from m to y. Thus, a C₁-C₅₀ alkyl group refers to an alkyl group including carbon atoms at a total number thereof of about 1 to about 50.

Unless otherwise indicated, (e.g., the definition of “substituted hydrocarbyl”, “substituted aromatic”, etc.), the term “substituted” means that at least one hydrogen atom has been replaced with at least one non-hydrogen group, such as a hydrocarbyl group, a heteroatom, or a heteroatom containing group, such as halide (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, where each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “substituted hydrocarbyl” means a hydrocarbyl radical in which at least one hydrogen atom of the hydrocarbyl radical has been substituted with at least one heteroatom (such as halide, e.g., Br, Cl, F or I) or heteroatom-containing group (such as a functional group, e.g., —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, where each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom or heteroatom-containing group (such as a functional group, e.g., —NR*—, —O—, —Se—, —Te—, —PR*—, —AsR*—, —SbR*—, —S—, —BR*₂— —SiR*₂— —GeR*₂— —SnR*₂—, —PbR*₂—, where each R* is as defined above) has been inserted within a hydrocarbyl chain or ring. Substituted excludes ferrocenyl substituents unless specifically included.

The term “substituted aromatic,” means an aromatic group having 1 or more hydrogen groups replaced by a hydrocarbyl, substituted hydrocarbyl, heteroatom or heteroatom containing group.

The term “substituted phenyl,” mean a phenyl group having 1 or more hydrogen groups replaced by a hydrocarbyl, substituted hydrocarbyl, heteroatom or heteroatom containing group.

The terms “hydrocarbyl radical,” “hydrocarbyl group,” or “hydrocarbyl” may be used interchangeably and are defined to mean a group including hydrogen and carbon atoms only. For example, a hydrocarbyl can be a C₁-C₁₀₀ radical that may be linear, branched, or cyclic, and when cyclic, aromatic or non-aromatic. Examples of such radicals may include, but are not limited to, alkyl groups such as methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and aryl groups, such as phenyl, benzyl, naphthyl.

The terms “alkoxy” and “alkoxide” mean an alkyl or aryl group bound to an oxygen atom, such as an alkyl ether or aryl ether group/radical connected to an oxygen atom and can include those where the alkyl/aryl group is a C₁ to C₁₀ hydrocarbyl. The alkyl group may be straight chain, branched, or cyclic. The alkyl group may be saturated or unsaturated. Examples of suitable alkoxy radicals can include methoxy, ethoxy, n-propoxy, iso-propoxy, n-butoxy, iso-butoxy, sec-butoxy, tert-butoxy, phenoxy.

The term “alkenyl” means a straight-chain, branched-chain, or cyclic hydrocarbon radical having one or more double bonds. These alkenyl radicals may be optionally substituted. Examples of suitable alkenyl radicals can include ethenyl, propenyl, allyl, 1,4-butadienyl, cyclopropenyl, cyclobutenyl, cyclopentenyl, cyclohexenyl, cycloctenyl, including their substituted analogues.

The terms “alkyl radical,” “alkyl group,” and “alkyl” are used interchangeably throughout this disclosure. For purposes of this disclosure, “alkyl radical” is defined to be C₁-C₁₀₀ alkyls that may be linear, branched, or cyclic. Examples of such radicals can include methyl, ethyl, n-propyl, isopropyl, n-butyl, isobutyl, sec-butyl, tert-butyl, pentyl, iso-amyl, hexyl, octyl, cyclopropyl, cyclobutyl, cyclopentyl, cyclohexyl, cyclooctyl, including their substituted analogues. Some examples of alkyl may include 1-methylethyl, 1-methylpropyl, 1-methylbutyl, 1-ethylbutyl, 1,3-dimethylbutyl, 1-methyl-1-ethylbutyl, 1,1-diethylbutyl, 1-propylpentyl, 1-phenylethyl, i-propyl, 2-butyl, sec-pentyl, sec-hexyl, and the like.

The term “aryl” or “aryl group” means an aromatic ring and the substituted variants thereof, such as phenyl, 2-methyl-phenyl, xylyl, 4-bromo-xylyl. Likewise, “heteroaryl” means an aryl group where a ring carbon atom (or two or three ring carbon atoms) has been replaced with a heteroatom, such as N, O, or S. As used herein, the term “aromatic” also refers to pseudoaromatic heterocycles which are heterocyclic substituents that have similar properties and structures (nearly planar) to aromatic heterocyclic ligands, but are not by definition aromatic; likewise the term aromatic also refers to substituted aromatics.

For nomenclature purposes, the following numbering schemes are used for cyclopentadienyl, indenyl, fluorenyl, cyclopenta[b]naphthalenyl (also termed benz[e]indenyl), cyclopenta[a]naphthalenyl (also termed benz[f]indenyl), tetrahydro-s-indacenyl and tetrahydro-as-indacenyl. The numbering schemes indicate the positions along the ring(s) to which a moiety can be connected. As an example, a moiety such as a phenanthridinyl moiety, can be coupled to the 4-position of the cyclopentadienyl. It should be noted that indenyl can be considered a cyclopentadienyl with a fused benzene ring. Analogously, fluorenyl can be considered a cyclopentadienyl with two fused benzene rings fused to the cyclopentadienyl ring. Each structure below is drawn and named as an anion.

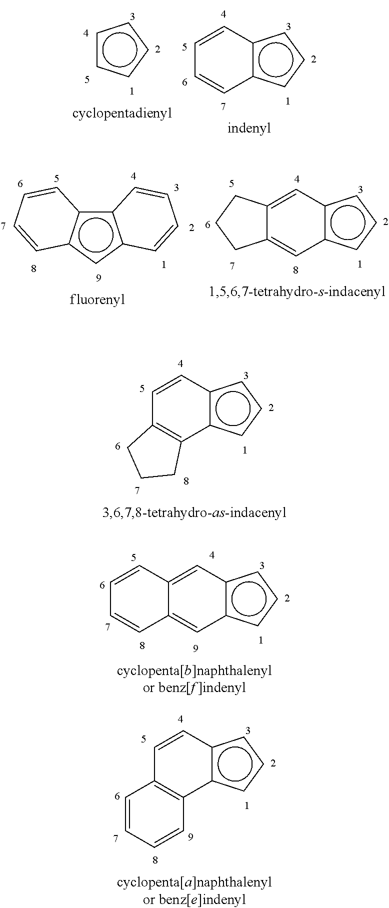

Partially hydrogenated polycyclic arenyl ligands retain the numbering scheme of the parent polycyclic arenyl ligand, namely the numbering schemes defined for indenyl, fluorenyl, cyclopenta[b]naphthalenyl, cyclopenta[a]naphthalenyl tetrahydro-s-indenyl, and tetrahydro-as-indacenyl ligands.

The term “arenyl” ligand is used herein to mean an unsaturated cyclic hydrocarbyl ligand that can consist of one ring, or two or more fused or catenated rings.

The term “monocyclic arenyl ligand” is used herein to mean a substituted or unsubstituted monoanionic C₅ to C₁₀₀ hydrocarbyl ligand that contains an aromatic five-membered single hydrocarbyl ring structure (also referred to as a cyclopentadienyl ring).

The term “polycyclic arenyl ligand” is used herein to mean a substituted or unsubstituted monoanionic C₉ to C₁₀₃ hydrocarbyl ligand that contains an aromatic five-membered hydrocarbyl ring (also referred to as a cyclopentadienyl ring) that is fused to one or two partially unsaturated, or aromatic hydrocarbyl ring structures which may be fused to additional saturated, partially unsaturated, or aromatic hydrocarbyl rings.

Arenyl ligands may be unsubstituted or substituted.

Where isomers of a named alkyl, alkenyl, alkoxide, or aryl group exist (e.g., n-butyl, iso-butyl, sec-butyl, and tert-butyl), reference to an alkyl, alkenyl, alkoxide, or aryl group without specifying a particular isomer (e.g., butyl) expressly discloses all isomers (e.g., n-butyl, iso-butyl, sec-butyl, tert-butyl, and cyclobutyl).

The term “vinyl” means an olefin having the following formula:

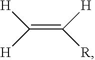

wherein R is a hydrocarbyl group, such as a saturated hydrocarbyl group such as an alkyl group.

The term “vinylidene” means an olefin having the following formula:

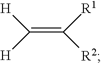

wherein R¹ and R² are each, independently, a hydrocarbyl group, such as a saturated hydrocarbyl group such as alkyl group.
The term “vinylene” or “1,2-di-substituted vinylene” means
(i) an olefin having the following formula:

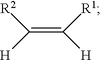

(ii) an olefin having the following formula:

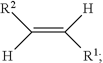

(iii) a mixture of (i) and (ii) at any proportion thereof,
   wherein R¹ and R² are each, independently, a hydrocarbyl group, such as saturated hydrocarbyl group such as alkyl group.

The term “tri-substituted vinylene” means an olefin having the following formula:

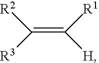

wherein R¹, R², and R³ are each, independently, a hydrocarbyl group, such as a saturated hydrocarbyl group such as alkyl group.

The term “ring atom” means an atom that is part of a cyclic ring structure. By this definition, a benzyl group has six ring atoms and tetrahydrofuran has five ring atoms.

A heterocyclic ring is a ring having a heteroatom in the ring structure as opposed to a heteroatom substituted ring where a hydrogen on a ring atom is replaced with a heteroatom. For example, tetrahydrofuran is a heterocyclic ring and 4-N,N-dimethylamino-phenyl is a heteroatom-substituted ring. Other examples of heterocycles may include pyridine, imidazole, and thiazole.

As used herein, Mn is number average molecular weight, Mw is weight average molecular weight, and Mz is z average molecular weight, wt % is weight percent, and mol % is mole percent. Molecular weight distribution (MWD), also referred to as polydispersity (PDI), is defined to be Mw divided by Mn. Unless otherwise noted, all molecular weight units (e.g., Mw, Mn, Mz) are g/mol.

The terms “catalyst compound”, “catalyst complex”, “transition metal complex”, “transition metal compound”, “precatalyst compound”, and “precatalyst complex” are used interchangeably.

A “catalyst system” is a combination of at least one catalyst compound, at least one activator, an optional coactivator, and an optional support material. When “catalyst system” is used to describe such a pair before activation, it means the unactivated catalyst complex (precatalyst) together with an activator and, optionally, a coactivator. When it is used to describe such a pair after activation, it means the activated complex and the activator or other charge-balancing moiety. The catalyst compound may be neutral as in a precatalyst, or a charged species with a counter ion as in an activated catalyst system. For the purposes of the present disclosure and the claims thereto, when catalyst systems are described as including neutral stable forms of the components, it is well understood by one of ordinary skill in the art, that the ionic form of the component is the form that reacts with the monomers to produce polymers. A polymerization catalyst system is a catalyst system that can polymerize monomers to polymer. Furthermore, catalyst compounds and activators represented by formulae herein are intended to embrace both neutral and ionic forms of the catalyst compounds and activators.

An “anionic ligand” is a negatively charged ligand which donates one or more pairs of electrons to a metal ion. A “Lewis base” or “neutral donor ligand” is a neutrally charged ligand which donates one or more pairs of electrons to a metal ion. Examples of Lewis bases include ethylether, trimethylamine, pyridine, tetrahydrofuran, dimethylsulfide, and triphenylphosphine. The term “heterocyclic Lewis base” refers to Lewis bases that are also heterocycles. Examples of heterocylic Lewis bases include pyridine, imidazole, thiazole, and furan.

A scavenger is a compound that can be added to facilitate polymerization by scavenging impurities. Some scavengers may also act as activators and may be referred to as coactivators. A coactivator, that is not a scavenger, may also be used in conjunction with an activator in order to form an active catalyst. In at least one embodiment, a coactivator can be pre-mixed with the transition metal compound to form an alkylated transition metal compound.

The term “continuous” means a system that operates without interruption or cessation for an extended period of time. For example a continuous process to produce a polymer would be one where the reactants are continually introduced into one or more reactors and polymer product is continually withdrawn.

A solution polymerization means a polymerization process in which the polymer is dissolved in a liquid polymerization medium, such as an inert solvent or monomer(s) or their blends. A solution polymerization can be homogeneous. A homogeneous polymerization is one where the polymer product is dissolved in the polymerization medium. Suitable systems may be not turbid as described in J. Vladimir Oliveira, C. Dariva and J. C. Pinto, Ind. Eng. Chem. Res., 2000, Vol. 29, p. 4627.

A bulk polymerization means a polymerization process in which the monomers and or comonomers being polymerized are used as a solvent or diluent using little or no inert solvent as a solvent or diluent. A small fraction of inert solvent might be used as a carrier for catalyst and scavenger. A bulk polymerization system contains less than 25 wt % of inert solvent or diluent, such as less than 10 wt %, such as less than 1 wt %, such as 0 wt %.

The term “single catalyst compound” refers to a catalyst compound corresponding to a single structural formula, although such a catalyst compound may comprise and be used as a mixture of isomers, e.g., stereoisomers.

A catalyst system that utilizes a single catalyst compound means a catalyst system that is prepared using only a single catalyst compound in the preparation of the catalyst system. Thus, such a catalyst system is distinguished from, for example, “dual” catalyst systems, which are prepared using two catalyst compounds having different structural formulas, e.g., the connectivity between the atoms, the number of atoms, and/or the type of atoms in the two catalyst compounds is different. Thus, one catalyst compound is considered different from another if it differs by at least one atom, either by number, type, or connection. For example bisindenyl zirconium dichloride is different from (indenyl)(2-methylindenyl) zirconium dichloride which is different from (indenyl)(2-methylindenyl) hafnium dichloride. Catalyst compounds that differ only in that they are stereoisomers of each other are not considered to be different catalyst compounds. For example, rac-dimethylsilylbis(2-methyl 4-phenyl)hafnium dimethyl and meso-dimethylsilylbis(2-methyl 4-phenyl)hafnium dimethyl are considered to be not different from one another.

The terms “cocatalyst” and “activator” are used herein interchangeably and are defined to be any compound which can activate any one of the catalyst compounds described above by converting the neutral catalyst compound to a catalytically active catalyst compound cation.

Noncoordinating anion (NCA) means an anion either that does not coordinate to the catalyst metal cation or that does coordinate to the metal cation, but only weakly. The term NCA is also defined to include multicomponent NCA-containing activators, such as N,N-dimethylanilinium tetrakis(pentafluorophenyl)borate, that contain an acidic cationic group and the non-coordinating anion. The term NCA is also defined to include neutral Lewis acids, such as tris(pentafluorophenyl)boron, that can react with a catalyst to form an activated species by abstraction of an anionic group. An NCA coordinates weakly enough that a neutral Lewis base, such as an olefinically or acetylenically unsaturated monomer can displace it from the catalyst center. Any metal or metalloid that can form a compatible, weakly coordinating complex may be used or contained in the noncoordinating anion. Suitable metals include, but are not limited to, aluminum, gold, and platinum. Suitable metalloids include, but are not limited to, boron, aluminum, phosphorus, and silicon. The term non-coordinating anion activator includes neutral activators, ionic activators, and Lewis acid activators. The terms “non-coordinating anion activator” and “ionizing activator” are used interchangeably herein.

The terms “process” and “method” are used interchangeably.

Additional definitions and conventions may be set forth below in other portions of the present disclosure.

### DETAILED DESCRIPTION

The present disclosure relates to metallocene catalyst compounds, to catalyst systems comprising such compounds, and to uses thereof. The inventors discovered that metallocene catalyst compounds having a ferrocene moiety at the 4-position of an indenyl ligand can provide isotactic polypropylenes and ethylene copolymers at high activities. The polymers formed can have one or more of a high molecular weight, high comonomer incorporation, high melt temperature, narrow polydispersity index, and/or (in the case polypropylenes) isotacticity. Ethylene copolymers formed using catalysts of the present disclosure can have high molecular weight and high comonomer incorporation, where the high comonomer incorporation can improve processability of the ethylene copolymer formed while maintaining most, if not all, of the mechanical property advantages provided by high molecular weight.

Interestingly, isotactic polypropylene can be obtained by embodiments described herein. In addition, high activity of catalysts of the present disclosure can be obtained even though the ferrocenyl substituent is located on a 6-membered ring of the indenyl, as compared to a ferrocenyl substituent located on a 5-membered ring of the indenyl which is the ring closer to the catalytic metal atom. Without being bound by theory, increased or maintained catalyst activity of catalyst compounds of the present disclosure may be realized because the ferrocenyl substituent located on a 6-membered ring of an indenyl provides reduced steric bulk around the catalytic metal atom, as compared to a ferrocenyl substituent located on a 5-membered ring of the indenyl closer to the catalytic metal atom.

The inventors have further discovered that by using an oxidizing agent to form the catalyst compound, the iron atom(s) of a catalyst compound of the present disclosure can be oxidized from Fe(II) to Fe(III) oxidation states. Likewise, a reducing agent can be used to form the catalyst compound by reduction of Fe(III) to Fe(II) oxidation states. The varying oxidation state of iron of a catalyst compound of the present disclosure provides tunable and controllable polymer properties of polymers formed using catalysts of the present disclosure.

### Catalyst Compounds

This disclosure relates to metallocene catalyst compounds represented by Formula (I):

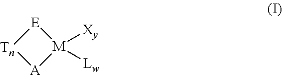

wherein:
M is a group 3-5 metal of the periodic table of elements, a lanthanide metal atom, or an actinide metal atom;
E is a substituted polycyclic arenyl ligand bonded (e.g., pi-bonded) to M and is substituted by at least one ferrocenyl substituent bonded to an aromatic six-membered ring of the polycyclic arenyl ligand;
A is a monoanionic ligand bonded to M;
T is bonded to A and E, and is a bridging group containing a group 13, 14, 15, or 16 element, and is present when n is one and absent when n is zero;
n is 0 or 1;
each X is independently a univalent anionic ligand, or two Xs are joined and bound to M to form a metallocycle ring, or two Xs are joined to form a chelating ligand, a diene ligand, or an alkylidene ligand;
each L is independently a Lewis base, or two Ls are joined and bound to M to form a bidentate Lewis base;
an X may be joined to an L to form a monoanionic bidentate group;
y is 1, 2, or 3;
w is 0, 1, or 2; and
y+w is 4 or less.

In some embodiments, the at least one ferrocenyl substituent of Formula (I) is represented by Formula (Ia):

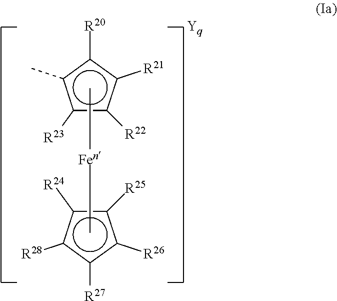

wherein Fe is Fe(II) or Fe(III) and each of R²⁰, R²¹, R²², R²³, R²⁴, R²⁵, R²⁶, R²⁷, and R²⁸ is independently hydrogen, hydrocarbyl, or any adjacent R²⁰, R²¹, R²², R²³, R²⁴, R²⁵, R²⁶, R²⁷, and R²⁸ may optionally be joined to form one or more hydrocarbyl rings or heterocyclic rings each having 5, 6, 7, or 8 ring atoms, such as substituted or unsubstituted indenyl or fluorenyl and the dashed line indicates the bond to the polycyclic arenyl ligand of E of Formula (I); n′ is the charge on Fe wherein n′ is zero when Fe is Fe(II), and n′ is +1 when Fe is Fe(III);
Y, when present, is a coordinating or non-coordinating anion (preferrably non-coordinating) with a charge of −1 and is present when q is 1 and n′ is +1, and is absent when q is 0 and n′ is 0. In some embodiments, Fe of Formula (Ia) is preferably Fe(II) and n′=0 (e.g. neutral Fe center) and q is 0 (i.e. Y is absent). When n′=+1 in some embodiments, Fe of Formula (Ia) is Fe(III) (e.g. cationic Fe center), q is 1 and Y is present. Non-limiting examples of counter anions, Y, include halide (e.g., chloride), tetrakis(3,5-bis(trifluoromethyl)phenyl borate, tetrafluoroborate, antimonyhexafluoride, phosphoroushexafluoride, tetrakis(perfluorophenylborate), and tetraphenylborate.

In some embodiments, E of Formula (I) is selected from substituted indenyl, fluorenyl, cyclopenta[b]naphthalenyl, cyclopenta[a]naphthalenyl, tetrahydro-s-indacenyl, or tetrahydro-as-indacenyl. In some embodiments, a ferrocenyl substituent of Formula (I) is located at the 4-position of an indenyl, fluorenyl, cyclopenta[b]naphthalenyl, cyclopenta[a]naphthalenyl, tetrahydro-s-indacenyl, or tetrahydro-as-indacenyl. In some embodiments, a ferrocenyl substituent of Formula (I) is located at the 5 position of an indenyl, cyclopenta[a]naphthalenyl, or tetrahydro-as-indacenyl. In some embodiments, a ferrocenyl substituent of Formula (I) is located at the 4-position of an indenyl, cyclopenta[b]naphthalenyl or tetrahydro-s-indacenyl, such as indenyl.

In some embodiments, A of Formula (I) is a monocyclic or polycyclic arenyl ligand that is bonded (e.g., pi-bonded) to M, such as A is a substituted or unsubstituted cyclopentadienyl, indenyl, fluorenyl, cyclopenta[b]naphthalenyl, cyclopenta[a]naphthalenyl, tetrahydro-s-indacenyl or tetrahydro-as-indacenyl. If A is a substituted polycyclic arenyl ligand, A may optionally be the same as E.

Alternatively, A is a monoanionic ligand of the formula JR″ₘ₋₁₋ₙ where J is a heteroatom with a coordination number of three from group 15 or with a coordination number of two from group 16 of the Periodic Table of Elements; each R″ is, independently, substituted or unsubstituted hydrocarbyl, n is 0 or 1 and indicates the presence (n=1) or absence (n=0) of the bridging group T, and m is the coordination number of the heteroatom J such that “m−1−n” indicates the number of R″ substituents bonded to J.

In some embodiments, each X is independently hydrogen, hydrocarbyl, or both X are joined and bound to the metal atom to form a metallocycle ring containing from about 3 to about 20 carbon atoms; or both together can be an olefin, diolefin, aryne, or alkylidene ligand. In some embodiments, each X may independently be a halogen, hydride, alkoxide, sulfide, aryloxide, amide, phosphide or other univalent anionic ligand or both X can be joined to form a dianionic chelating ligand.

In some embodiments, T of Formula (I) is a bridging group bonded to A and E and containing at least one Group 13, 14, 15, or 16 element, such as boron or a Group 14, 15, or 16 element. Examples of suitable bridging groups include P(═S)R*, P(═Se)R*, P(═O)R*, R*₂C, R*₂Si, R*₂Ge, R*₂CCR*₂, R*₂CCR*₂CR*₂, R*₂CCR*₂CR*₂CR*₂, R*C═CR*, R*C═CR*CR*₂, R*₂CCR*═CR*CR*₂, R*C═CR*CR*═CR*, R*C═CR*CR*₂CR*₂, R*₂CSiR*₂, R*₂SiSiR*₂, R*₂SiOSiR*₂, R*₂CSiR*₂CR*₂, R*₂SiCR*₂SiR*₂, R*C═CR*SiR*₂, R*₂CGeR*₂, R*₂GeGeR*₂, R*₂CGeR*₂CR*₂, R*₂GeCR*₂GeR*₂, R*₂SiGeR*₂, R*C═CR*GeR*₂, R*B, R*₂C—BR*, R*₂C—BR*—CR*₂, R*₂C—O—CR*₂, R*₂CR*₂C—O—CR*₂CR*₂, R*₂C—O—CR*₂CR*₂, R*₂C—O—CR*═CR*, R*₂C—S—CR*₂, R*₂CR*₂C—S—CR*₂CR*₂, R*₂C—S—CR*₂CR*₂, R*₂C—S—CR*═CR*, R*₂C—Se—CR*₂, R*₂CR*₂C—Se—CR*₂CR*₂, R*₂C—Se—CR*₂CR*₂, R*₂C—Se—CR*═CR*, R*₂C—N═CR*, R*₂C—NR*—CR*₂, R*₂C—NR*—CR*₂CR*₂, R*₂C—NR*—CR*═CR*, R*₂CR*₂C—NR*—CR*₂CR*₂, R*₂C—P═CR*, R*₂C—PR*—CR*₂, O, S, Se, Te, NR*, PR*, AsR*, SbR*, O—O, S—S, R*N—NR*, R*P—PR*, O—S, O—NR*, O—PR*, S—NR*, S—PR*, and R*N—PR* where R* is hydrogen or a C₁-C₂₀ hydrocarbyl, halocarbyl, silylcarbyl or germylcarbyl substituent and optionally two or more adjacent R* may join to form a saturated, partially unsaturated or aromatic, cyclic or polycyclic substituent. Some examples of the bridging group T include CH₂, CH₂CH₂, SiMe₂, SiPh₂, SiMePh, Si(CH₂)₃, Si(CH₂)₄, O, S, NPh, PPh, NMe, PMe, NEt, NPr, NBu, PEt, PPr, Me₂SiOSiMe₂, and PBu.

In some embodiments, each instance of L of Formula (I) is independently selected from an ether, an amine, a phosphine, a thioether, and an ester. In some embodiments of Formula (I), L is selected from Et₂O, MeOtBu, Et₃N, PhNMe₂, MePh₂N, tetrahydrofuran, methyl acetate, and dimethylsulfide, and each instance of X is independently selected from methyl, benzyl, trimethylsilyl, methylene(trimethylsilyl), neopentyl, ethyl, propyl, butyl, phenyl, hydrido, chloro, fluoro, bromo, iodo, trifluoromethanesulfonate, dimethylamido, diethylamido, dipropylamido, and diisopropylamido.

In some embodiments, a metallocene catalyst compound of Formula (I) is represented by Formula (IIa), Formula (IIb), Formula (IIIa), Formula (IIIb), Formula (IVa), or Formula (IVb):

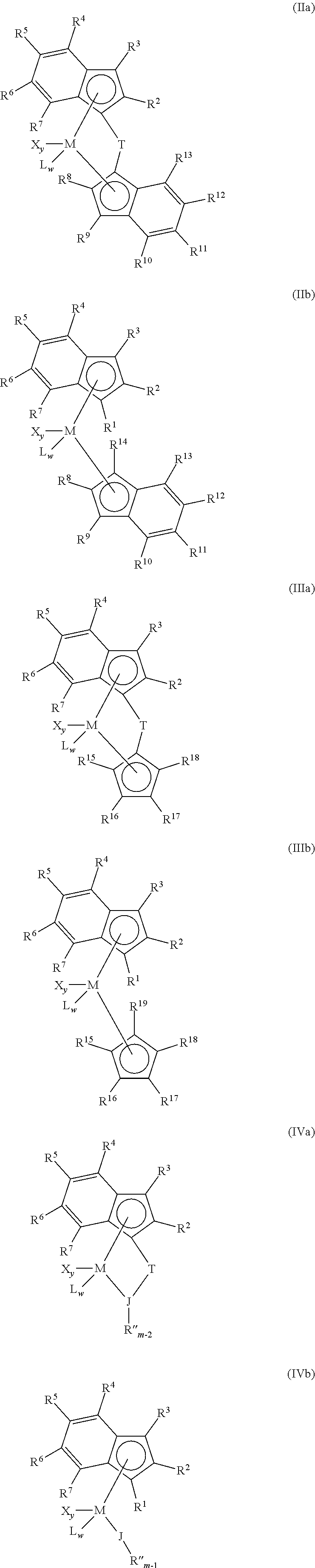

wherein:
M, T, L, X, y, w, J, R″, and m are as described above for Formula (I) and/or Formula (Ia);
each of R⁴, R⁵, R⁶ and R⁷ of Formula (IIa), Formula (IIb), Formula (IIIa), Formula (IIIb), Formula (IVa), and Formula (IVb) is independently a hydrogen, a substituted or unsubstituted hydrocarbyl, a heteroatom or heteroatom-containing group, or a ferrocenyl substituent provided that at least one of R⁴, R⁵, R⁶ or R⁷ is a ferrocenyl substituent. Any adjacent R⁴, R⁵, R⁶, and R⁷ that are not ferrocenyl may be joined to form one or more substituted hydrocarbyl rings or heterocyclic rings each having 5, 6, 7, or 8 ring atoms;
each of R¹⁰, R¹¹, R¹² and R¹³ of Formula (IIa) and Formula (IIb) is independently a hydrogen, substituted or unsubstituted hydrocarbyl, a heteroatom or heteroatom-containing group, or ferrocenyl substituent, and any adjacent R¹⁰, R¹¹, R¹² and R¹³ that are not ferrocenyl may be joined to form one or more substituted or unsubstituted hydrocarbyl rings or heterocyclic rings each having 5, 6, 7, or 8 ring atoms; and
each of (when present) R¹, R², R³, R⁸, R⁹, R¹⁴, R¹⁵, R¹⁶, R¹⁷, R¹⁸, and R¹⁹ of Formula (IIa), Formula (IIb), Formula (IIIa), Formula (IIIb), Formula (IVa), and/or Formula (IVb) is independently a hydrogen, substituted or unsubstituted hydrocarbyl, a heteroatom or heteroatom-containing group, and any two adjacent R¹, R², R³, R⁸, R⁹, R¹⁴, R¹⁵, R¹⁶, R¹⁷, R¹⁸, and R¹⁹ may optionally be joined to form one or more substituted or unsubstituted. hydrocarbyl rings or heterocyclic rings each having 5, 6, 7, or 8 ring atoms.

In some embodiments of Formula (I), Formula (IIa), Formula (IIb), Formula (IIIa), Formula (IIIb), Formula (IVa), or Formula (IVb), M is a group 4 metal, such as titanium (Ti), zirconium (Zr), or hafnium (Hf), such as Zr or Hf. In some embodiments of Formula (I), Formula (IIa), Formula (IIb), Formula (IIIa), Formula (IIIb), Formula (IVa), or Formula (IVb) y is 2.

In some embodiments of Formula (IIa), Formula (IIb), Formula (IIIa), or Formula (IIIb), M is Zr or Hf, and y is 2. In some embodiments of Formula (IVa) or Formula (IVb), M is Ti, and y is 1 or 2, such as y is 2.

In some embodiments of Formula (I), Formula (IIa), Formula (IIb), Formula (IIIa), Formula (IIb), Formula (IVa), or Formula (IVb), R⁴ or R⁵ is ferrocenyl. In some embodiments of Formula (I), Formula (IIa), Formula (IIb), Formula (IIIa), Formula (IIIb), Formula (IVa), or Formula (IVb), R⁴ is ferrocenyl.

In some embodiments of Formula (IIa) or Formula (IIb), R⁴ or R⁵ and R¹⁰ or R¹¹ is ferrocenyl. In some embodiments of Formula (IIa) or Formula (IIb), each of R⁴ and R¹⁰ is ferrocenyl.

In some embodiments of Formula (IIa) or Formula (IIb), one or both of R⁴ and R¹⁰ is ferrocenyl and each of R² and R⁸ is independently C₁-C₁₀ hydrocarbyl. In some embodiments, R² and R⁸ are independently methyl, ethyl, propyl, or butyl.

In some embodiments of Formula (IIa) or Formula (IIb), R⁴ and R¹⁰ are ferrocenyl, each of R², R⁶, R⁸ and R¹² is independently C₁-C₁₀ hydrocarbyl (such as methyl, ethyl, propyl or butyl), each of R⁵ and R¹¹ is independently C₁-C₁₀ hydrocarbyl or alkoxy (such as methoxy).

In some embodiments of Formula (IIa) or Formula (IIb), R⁴ and R¹⁰ are ferrocenyl, each of R² and R⁸ is independently C₁-C₁₀ hydrocarbyl (such as methyl, ethyl, propyl or butyl), each of R⁵, R⁶, R¹¹, and R¹² is independently C₁-C₁₀ hydrocarbyl (such as methyl, ethyl, propyl or butyl), and R⁵ and R⁶ and/or R¹¹ and R¹² optionally are joined to form a hydrocarbyl ring or a heterocyclic ring each having 5, 6, 7, or 8 ring atoms (such as 5 or 6 ring atoms).

In some embodiments of Formula (IIIa) or Formula (IIIb), R⁴ or R⁵ are ferrocenyl, and each of R¹⁵, R¹⁶, R¹⁷, R¹⁸, and R¹⁹ is independently hydrogen or C₁-C₁₀ hydrocarbyl (such as methyl).

In some embodiments of Formula (IIIa) or Formula (IIIb), R⁴ is ferrocenyl, each of R¹⁵, R¹⁶, R¹⁷, R¹⁸, and R¹⁹ is independently hydrogen or C₁-C₁₀ hydrocarbyl (such as methyl), and each of R⁵ and R⁶ is independently C₁-C₁₀ hydrocarbyl, or are optionally joined to form a hydrocarbyl ring or heterocyclic ring each having 5, 6, 7, or 8 ring atoms (such as 5 or 6 ring atoms).

In some embodiments of Formula (IIIa) or Formula (IIIb), R⁴ is ferrocenyl, each of R² and R⁶ is independently a C₁-C₁₀ hydrocarbyl (such as methyl, ethyl, propyl or butyl), R⁵ is C₁-C₁₀ hydrocarbyl, a heteroatom, or heteroatom-containing group (such as alkoxy, such as methoxy).

In some embodiments of Formula (IVa) or Formula (IVb), R⁴ is ferrocenyl, J is nitrogen or oxygen (preferably nitrogen), and each instance of R″ is independently C₁-C₃₀ hydrocarbyl, such as C₄-C₂₀ hydrocarbyl, such as tert-butyl, neopentyl, cyclohexyl, cyclooctyl, cyclodecyl, cyclododeceyl, adamantan-1-yl, adamantan-2-yl, norborn-1-yl, norborn-2-yl, benzyl, or ethylphenyl, such as tert-butyl, cyclododecyl or adamantan-1-yl.

In some embodiments of Formula (IVa) or Formula (IVb), R⁴ is ferrocenyl, each of R² and R⁶ is independently a C₁-C₁₀ hydrocarbyl (such as methyl, ethyl, propyl or butyl), R⁵ is C₁-C₁₀ hydrocarbyl, a heteroatom, or heteroatom-containing group (such as alkoxy, such as methoxy), J is nitrogen or oxygen (preferably nitrogen), and each instance of R″ is independently C₁-C₃₀ hydrocarbyl, such as C₄-C₂₀ hydrocarbyl, such as tert-butyl, neopentyl, cyclohexyl, cyclooctyl, cyclodecyl, cyclododeceyl, adamantan-1-yl, adamantan-2-yl, norborn-1-yl, norborn-2-yl, benzyl, or ethylphenyl, such as tert-butyl, cyclododecyl or adamantan-1-yl.

In some embodiments of Formula (IVa) or Formula (IVb), R⁴ is ferrocenyl, each of R², R⁵, and R⁶ is C₁-C₁₀ hydrocarbyl, and each of R⁵ and R⁶ is optionally joined to form hydrocarbyl ring or heterocyclic ring each having 5, 6, 7, or 8 ring atoms (such as 5 or 6 ring atoms), J is nitrogen or oxygen (such as nitrogen), and each instance of R″ is independently C₁-C₃₀ hydrocarbyl, such as C₄-C₂₀ hydrocarbyl, such as tert-butyl, neopentyl, cyclohexyl, cyclooctyl, cyclodecyl, cyclododeceyl, adamantan-1-yl, adamantan-2-yl, norborn-1-yl, norborn-2-yl, benzyl, or ethylphenyl, such as tert-butyl, cyclododecyl or adamantan-1-yl.

In some embodiments of Formula (IIa), Formula (IIIa), or Formula (IVa), T is represented by the formula (R″′₂G)_{g}, where each instance of G is independently C, Si, or Ge, g is 1 or 2, and each instance of R″′ is independently hydrogen, halogen, or C₁ to C₂₀ hydrocarbyl, and two or more R″′ can form a cyclic structure including aromatic, partially saturated, or saturated cyclic or fused ring system. In some embodiments of Formula (IIa), Formula (IIIa), or Formula (IVa), T is selected from CH₂, CH₂CH₂, C(CH₃)₂, CPh₂, SiMe₂, SiPh₂, SiMePh, Si(CH₂)₃, Si(CH₂)₄, or Si(CH₂)₅.

In some embodiments of Formula (I), Formula (IIa), Formula (IIb), Formula (IIIa), Formula (IIIb), Formula (IVa), or Formula (IVb), each instance of X can be independently selected from methyl, benzyl, trimethylsilyl, methylene(trimethylsilyl), neopentyl, ethyl, propyl, butyl, phenyl, hydrido, chloro, fluoro, bromo, iodo, trifluoromethanesulfonate, dimethylamido, diethylamido, dipropylamido, and diisopropylamido. In at least one embodiment of any of the formulae above, each instance of X is independently chloro, benzyl, or methyl.

In some embodiments of any of the formulae above, w is 0, y is 2, and each instance of X is independently chloro, benzyl, or methyl.

In some embodiments, a C₁-C₁₀ hydrocarbyl as used herein may be a C₁-C₁₀ alkyl.

In some embodiments of Formula (I), Formula (IIa), Formula (IIb), Formula (IIIa), Formula (IIIb), Formula (IVa), or Formula (IVb), each instance of a ferrocenyl substituent is independently represented by Formula (Ia) above wherein each of R²⁰, R²¹, R²², R²³, R²⁴, R²⁵, R²⁶, R²⁷, and R²⁸ of Formula (Ia) is independently hydrogen, hydrocarbyl, or any adjacent R²⁰, R²¹, R²², R²³, R²⁴, R²⁵, R²⁶, R²⁷, and R²⁸ may optionally be joined to form one or more hydrocarbyl rings or heterocyclic rings each having 5, 6, 7, or 8 ring atoms, and the dashed line indicates the bond to the catalyst compound of Formula (I), Formula (IIa), Formula (IIb), Formula (IIIa), Formula (IIIb), Formula (IVa), or Formula (IVb).

In some embodiments of Formula (I), Formula (IIa), Formula (IIb), Formula (IIIa), Formula (IIIb), Formula (IVa), or Formula (IVb), each instance of a ferrocenyl substituent is independently represented by Formula (Ia) above wherein each of R²⁰, R²¹, R²², R²³, R²⁴, R²⁵, R²⁶, R²⁷, and R²⁸ of Formula (Ia) is hydrogen and the dashed line indicates the bond to the catalyst compound of Formula (I), Formula (IIa), Formula (IIb), Formula (IIIa), Formula (IIIb), Formula (IVa), or Formula (IVb).

In some of the preferred embodiments above, catalysts of Formula (IIa), Formula (IIIa), and Formula (IVa) are preferred.

In some embodiments, a catalyst compound represented by one or more of Formula (I), Formula (IIa), Formula (IIb), Formula (IIIa), Formula (IIIb), Formula (IVa), or Formula (IVb) is selected from:
rac-dimethylsilanediyl-bis(η⁵-4-ferrocenyl-2-methylinden-1-yl)zirconium dichloride,
rac-dimethylsilanediyl-bis(η⁵-4-ferrocenyl-2-methylinden-1-yl)zirconium dimethyl,
rac-dimethylsilanediyl-bis(η⁵-4-ferrocenyl-2-methylinden-1-yl)hafnium dichloride,
rac-dimethylsilanediyl-bis(η⁵-4-ferrocenyl-2-methylinden-1-yl)hafnium dimethyl,
rac-dimethylsilanediyl-bis(η⁵-2-butyl-4-ferrocenylinden-1-yl)zirconium dichloride,
rac-dimethylsilanediyl-bis(η⁵-2-butyl-4-ferrocenylinden-1-yl)zirconium dimethyl,
rac-dimethylsilanediyl-bis(η⁵-2-butyl-4-ferrocenylinden-1-yl)hafnium dichloride,
rac-dimethylsilanediyl-bis(η⁵-2-butyl-4-ferrocenylinden-1-yl)hafnium dimethyl,
rac-dimethylsilanediyl-bis(η⁵-6-tert-butyl-4-ferrocenyl-5-methoxy-2-methylinden-1-yl)zirconium dichloride,
rac-dimethylsilanediyl-bis(η⁵-6-tert-butyl-4-ferrocenyl-5-methoxy-2-methylinden-1-yl)zirconium dimethyl,
rac-dimethylsilanediyl-bis(η⁵-6-tert-butyl-4-ferrocenyl-5-methoxy-2-methylinden-1-yl)hafnium dichloride,
rac-dimethylsilanediyl-bis(η⁵-6-tert-butyl-4-ferrocenyl-5-methoxy-2-methylinden-1-yl)hafnium dimethyl,
rac-dimethylsilanediyl-bis(η⁵-4-ferrocenyl-2,6,6-trimethyl-1,5,6,7-tetrahydro-s-indacen-1-yl)zirconium dichloride,
rac-dimethylsilanediyl-bis(η⁵-4-ferrocenyl-2,6,6-trimethyl-1,5,6,7-tetrahydro-s-indacen-1-yl)zirconium dimethyl,
rac-dimethylsilanediyl-bis(η⁵-4-ferrocenyl-2,6,6-trimethyl-1,5,6,7-tetrahydro-s-indacen-1-yl)hafnium dichloride,
rac-dimethylsilanediyl-bis(η⁵-4-ferrocenyl-2,6,6-trimethyl-1,5,6,7-tetrahydro-s-indacen-1-yl)hafnium dimethyl,
(dimethylsilanediyl)(η⁵-2-butyl-4-ferrocenylinden-1-yl)(κ¹-tert-butylamido)dimethyltitanium,
(dimethylsilanediyl)(η⁵-2-butyl-4-ferrocenylinden-1-yl)(κ¹-tert-butylamido)dimethylzirconium,
(dimethylsilanediyl)(η⁵-2-butyl-4-ferrocenylinden-1-yl)(i-tert-butylamido)dimethylhafnium,
(dimethylsilanediyl)(η⁵-2-butyl-4-ferrocenylinden-1-yl)(κ¹-tert-butylamido)titanium dichloride,
(dimethylsilanediyl)(η⁵-2-butyl-4-ferrocenylinden-1-yl)(κ¹-tert-butylamido)zirconium dichloride,
(dimethylsilanediyl)(η⁵-2-butyl-4-ferrocenylinden-1-yl)(κ¹-tert-butylamido)hafnium dichloride,
(dimethylsilanediyl)(η⁵-6-tert-butyl-4-ferrocenyl-5-methoxy-2-methyl-1H-inden-1-yl)-(κ¹-tert-butylamido)dimethyltitanium,
(dimethylsilanediyl)(η⁵-6-tert-butyl-4-ferrocenyl-5-methoxy-2-methyl-1H-inden-1-yl)-(κ¹-tert-butylamido)dimethylzirconium,
(dimethylsilanediyl)(η⁵-6-tert-butyl-4-ferrocenyl-5-methoxy-2-methyl-1H-inden-1-yl)-(κ¹-tert-butylamido)dimethylhafnium,
(dimethylsilanediyl)(η⁵-6-tert-butyl-4-ferrocenyl-5-methoxy-2-methyl-1H-inden-1-yl)-(κ¹-tert-butylamido)titanium dichloride,
(dimethylsilanediyl)(η⁵-6-tert-butyl-4-ferrocenyl-5-methoxy-2-methyl-1H-inden-1-yl)-(κ¹-tert-butylamido)zirconium dichloride,
(dimethylsilanediyl)(η⁵-6-tert-butyl-4-ferrocenyl-5-methoxy-2-methyl-1H-inden-1-yl)-(κ¹-tert-butylamido)hafnium dichloride,
(dimethylsilanediyl)(η⁵-4-ferrocenyl-2,6,6-trimethyl-1,5,6,7-tetrahydro-s-indacen-1-yl)(κ¹-tert-butylamido)dimethyltitanium,
(dimethylsilanediyl)(η⁵-4-ferrocenyl-2,6,6-trimethyl-1,5,6,7-tetrahydro-s-indacen-1-yl)(κ¹-tert-butylamido)dimethylzirconium,
(dimethylsilanediyl)(η⁵-4-ferrocenyl-2,6,6-trimethyl-1,5,6,7-tetrahydro-s-indacen-1-yl)(κ¹-tert-butylamido)dimethylhafnium,
(dimethylsilanediyl)(η⁵-4-ferrocenyl-2,6,6-trimethyl-1,5,6,7-tetrahydro-s-indacen-1-yl)(κ¹-tert-butylamido)titanium dichloride,
(dimethylsilanediyl)(η⁵-4-ferrocenyl-2,6,6-trimethyl-1,5,6,7-tetrahydro-s-indacen-1-yl)(κ¹-tert-butylamido)zirconium dichloride,
(dimethylsilanediyl)(η⁵-4-ferrocenyl-2,6,6-trimethyl-1,5,6,7-tetrahydro-s-indacen-1-yl)(κ¹-tert-butylamido)hafnium dichloride,
dimethylsilanediyl(η⁵-4-ferrocenyl-2-methylinden-1-yl)(tetramethylcyclopentadienyl)zirconium dichloride,
dimethylsilanediyl(η⁵-4-ferrocenyl-2-methylinden-1-yl)(tetramethylcyclopentadienyl)zirconium dimethyl,
dimethylsilanediyl(η⁵-4-ferrocenyl-2-methylinden-1-yl)(tetramethylcyclopentadienyl)hafnium dichloride,
dimethylsilanediyl(η⁵-4-ferrocenyl-2-methylinden-1-yl)(tetramethylcyclopentadienyl)hafnium dimethyl,
dimethylsilanediyl(η⁵-4-ferrocenyl-2-isopropylinden-1-yl)(tetramethylcyclopentadienyl)zirconium dichloride,
dimethylsilanediyl(η⁵-4-ferrocenyl-2-isopropylinden-1-yl)(tetramethylcyclopentadienyl)zirconium dimethyl,
dimethylsilanediyl(η⁵-4-ferrocenyl-2-isopropylinden-1-yl)(tetramethylcyclopentadienyl)hafnium dichloride,
dimethylsilanediyl(η⁵-4-ferrocenyl-2-isopropylinden-1-yl)(tetramethylcyclopentadienyl)hafnium dimethyl,
dimethylsilanediyl(η⁵-6-tert-butyl-4-ferrocenyl-5-methoxy-2-methylinden-1-yl) (tetramethylcyclopentadienyl)zirconium dichloride,
dimethylsilanediyl(η⁵-6-tert-butyl-4-ferrocenyl-5-methoxy-2-methylinden-1-yl) (tetramethylcyclopentadienyl)zirconium dimethyl,
dimethylsilanediyl(η⁵-6-tert-butyl-4-ferrocenyl-5-methoxy-2-methylinden-1-yl) (tetramethylcyclopentadienyl)hafnium dichloride,
dimethylsilanediyl(η⁵-6-tert-butyl-4-ferrocenyl-5-methoxy-2-methylinden-1-yl) (tetramethylcyclopentadienyl)hafnium dimethyl,
dimethylsilanediyl(η⁵-4-ferrocenyl-2-methyl-1,5,6,7-tetrahydro-s-indacen-1-yl)(tetramethylcyclopentadienyl)zirconium dichloride,
dimethylsilanediyl(η⁵-4-ferrocenyl-2-methyl-1,5,6,7-tetrahydro-s-indacen-1-yl)(tetramethylcyclopentadienyl)zirconium dimethyl,
dimethylsilanediyl(η⁵-4-ferrocenyl-2-methyl-1,5,6,7-tetrahydro-s-indacen-1-yl)(tetramethylcyclopentadienyl)hafnium dichloride,
dimethylsilanediyl(η⁵-4-ferrocenyl-2-methyl-1,5,6,7-tetrahydro-s-indacen-1-yl)(tetramethylcyclopentadienyl)hafnium dimethyl,
dimethylsilanediyl(η⁵-4-ferrocenyl-2,6,6-trimethyl-1,5,6,7-tetrahydro-s-indacen-1-yl)(tetramethylcyclopentadienyl)zirconium dichloride,
dimethylsilanediyl(η⁵-4-ferrocenyl-2,6,6-trimethyl-1,5,6,7-tetrahydro-s-indacen-1-yl)(tetramethylcyclopentadienyl)zirconium dimethyl,
dimethylsilanediyl(η⁵-4-ferrocenyl-2,6,6-trimethyl-1,5,6,7-tetrahydro-s-indacen-1-yl)(tetramethylcyclopentadienyl)hafnium dichloride, and
dimethylsilanediyl(η⁵-4-ferrocenyl-2,6,6-trimethyl-1,5,6,7-tetrahydro-s-indacen-1-yl)(tetramethylcyclopentadienyl)hafnium dimethyl.

In at least one embodiment, two or more different catalyst compounds are present in a catalyst system. In at least one embodiment, two or more different catalyst compounds are present in the reaction zone of a reactor where the polymerization process(es) of the present disclosure occur. When two catalyst compounds are used in one reactor as a mixed catalyst system, the two catalyst compounds can be chosen such that the two are compatible. A simple screening method such as by ¹H or ¹³C NMR, known to those of ordinary skill in the art, can be used to determine which catalyst compounds are compatible. The same activator can be used for both catalyst compounds, however, two different activators, such as a non-coordinating anion activator and an alumoxane, can be used in combination. If one or more catalyst compounds contain an X ligand which is not a hydride, hydrocarbyl, or substituted hydrocarbyl, then the alumoxane may be contacted with the catalyst compound(s) prior to addition of the non-coordinating anion activator.

The two or more catalyst compounds may be used in any suitable ratio. For example, molar ratios of (A) transition metal compound to (B) transition metal compound can be (A:B) of 1:1000 to 1000:1, alternatively 1:100 to 500:1, alternatively 1:10 to 200:1, alternatively 1:1 to 100:1, alternatively 1:1 to 75:1, and alternatively 5:1 to 50:1. The suitable ratio chosen will depend on the exact catalyst compounds chosen, the method of activation, and the polymer product desired. In at least one embodiment, when using the two catalyst compounds, where both are activated with the same activator, mole percentages, based upon the molecular weight of the catalyst compounds, can be about 10% to about 99.9% A to about 0.1% to about 90% B, alternatively about 25% to about 99% A to about 0.5% to about 75% B, alternatively about 50% to about 99% A to about 1% to about 50% B, and alternatively about 75% to about 99% A to about 1% to about 10% B.

### Methods of Preparing the Catalyst Compounds

All air sensitive syntheses are carried out in nitrogen purged dry boxes. All solvents are available from commercial sources.

Ferrocenyl substituents can be substituted onto aryl compounds, the reaction product of which is subsequently used a ligand for a catalyst compound of the present disclosure. To form the above reaction product, a ferrocene compound is treated with a strong base, such as potassium tert-butoxide and/or butyl lithium. To this mixture, a Lewis acid, such as ZnCl₂ is added to form an organozinc compound. A bromo-aryl compound, such as a bromo-indene compound, and a palladium catalyst, such as bis(tri-tert-butylphosphine) palladium, is introduced with the organozinc compound to form a ferrocenyl substituted aryl compound.

For bridged catalyst compounds of the present disclosure, the ferrocenyl substituted aryl compound may be treated with a strong base, such as a butyl lithium, and treated with chlorinated bridging compound, such as dichlorodimethylsilane to form a dimeric ferrocenyl substituted aryl compound bridged by the bridging compound.

For bridged catalyst compounds of the present disclosure, the dimeric ferrocenyl substituted aryl compound bridged by the bridging compound can be treated with a strong base, such as a butyl lithium, and a metal tetrachloride to form a bridged dichloro-catalyst compound of the present disclosure. Similarly, for unbridged catalyst compounds of the present disclosure, the monomeric ferrocenyl substituted aryl compound can be treated with a strong base, such as a butyl lithium, and a metal tetrachloride to form an unbridged dichloro-catalyst compound of the present disclosure.

Metal-alkylated embodiments of catalyst compounds can be formed by treating the above catalyst compound (having dichloro substitutions at the catalytic metal) with an alkyl Grignard reagent or an alkyl lithium reagent to form a catalyst compound having dialkyl substitutions at the metal.

The inventors have further discovered that by using an oxidizing agent to form the catalyst compound, the iron atom(s) of a catalyst compound of the present disclosure can be oxidized from Fe(II) to Fe(III) oxidation states. For example, a catalyst compound described above can be treated with an oxidizing agent. Likewise, a reducing agent can be used to form the catalyst compound by reduction of Fe(III) to Fe(II) oxidation states. For example, a catalyst compound containing a Fe(II) ferrocenyl substituent as described above can be treated with an oxidizing agent to make a catalyst compound containing a Fe(III) ferrocenyl substituent. Fc substituents in the Fe(III) oxidation state will be cationic, and have an associated counter anion to counter balance the charge. Suitable redox agents can be chosen for each complex using cyclic voltammetry and determining the half-wave potentials (E_{1/2}).

The varying oxidation state of iron of a catalyst compound of the present disclosure provides tunable and controllable polymer properties of polymers formed using catalysts of the present disclosure.

### Oxidizing Agents

An oxidizing agent used to form a catalyst compound of the present disclosure can be any suitable oxidizing agent capable of oxidizing Fe(II) of a ferrocenyl substituent to Fe(III).

In some embodiments, an oxidizing agent is selected from silver tetrakis(3,5-bis(trifluoromethyl)phenyl borate, acetylferrocenium tetrakis(3,5-bis(trifluoromethyl)phenyl borate, nitrosonium tetrakis(3,5-bis(trifluoromethyl)phenyl, acetylferrocenium tetrafluoroborate, and nitrosonium tetrafluoroborate, nitrosonium antimonyhexafluoride, nitrosonium phosphoroushexafluoride, nitrosonium tetrakis(perfluorophenylborate), acetylferrocenium tetrafluoroborate, acetylferrocenium antimonyhexafluoride, acetylferrocenium phosphoroushexafluoride, acetylferrocenium tetrakis(perfluorophenylborate), or combinations thereof.

### Reducing Agents

A reducing agent used to form a catalyst compound of the present disclosure can be any suitable reducing agent capable of reducing Fe(III) of a ferrocenyl substituent to Fe(II).

In some embodiments, a reducing agent is selected from cobaltocene, bis(pentamethylcyclopentadienyl)iron, bis(pentamethylcyclopentadienyl)cobalt, sodium, potassium, lithium, acenaphtalenide, benzophenonide, or combinations thereof.

### Catalyst Systems

In one or more embodiments, the catalyst system of the present disclosure comprises an activator and any of the catalyst compounds described above. While the catalyst systems of the present disclosure may utilize any of the catalyst compounds described above in combination with each other or with one or more catalyst compounds not described above, in some embodiments, the catalyst systems utilize a single catalyst compound corresponding to one of the catalyst compounds of the present disclosure.

In yet other embodiments, a catalyst system further includes a support material. In some embodiments, a support material is silica. In some embodiments, the activator includes one or more of alumoxanes, aluminum alkyls, ionizing activators, or combinations thereof.

In another embodiment, the present disclosure relates to a method for preparing a catalyst system by contacting a catalyst compound of the present disclosure with an activator, where the catalyst compound is a single catalyst compound and the single catalyst compound is the only catalyst compound contacted by an activator in said method. In yet another embodiment, the present disclosure relates to a method of polymerizing olefins comprising contacting at least one olefin with a catalyst system and obtaining a polyolefin. In still another embodiment, the present disclosure relates to a method of polymerizing olefins comprising contacting two or more different olefins with a catalyst system and obtaining a polyolefin. In a further embodiment, the present disclosure relates to a catalyst system comprising the catalyst compound of any of the embodiments described above, where the catalyst system includes a single catalyst compound. In a still further embodiment, the present disclosure relates to a catalyst system including the catalyst compound of any of the embodiments described above, where the catalyst system consists essentially of a single catalyst compound.

### Activators

The terms “cocatalyst” and “activator” are used herein interchangeably.

The catalyst systems described herein may comprise a catalyst complex as described above and an activator such as alumoxane or a non-coordinating anion and may be formed by combining the catalyst compounds described herein with activators in any manner known from the literature including combining them with supports, such as silica. The catalyst systems may also be added to or generated in solution polymerization or bulk polymerization (in the monomer). Catalyst systems of the present disclosure may have one or more activators and one, two or more catalyst components. Activators are defined to be any compound which can activate any one of the catalyst compounds described above by converting the neutral metal compound to a catalytically active metal compound cation. Non-limiting activators, for example, may include alumoxanes, aluminum alkyls, ionizing activators, which may be neutral or ionic, and conventional-type cocatalysts. Suitable activators may include alumoxane compounds, modified alumoxane compounds, and ionizing anion precursor compounds that abstract a reactive, σ-bound, metal ligand making the metal compound cationic and providing a charge-balancing non-coordinating or weakly coordinating anion, e.g., a non-coordinating anion.

In at least one embodiment, the catalyst system includes an activator, a catalyst compound of Formula (I), Formula (IIa), Formula (IIb), Formula (IIIa), Formula (IIIb), Formula (IVa), or Formula (IVb), and an optional support.

### Alumoxane Activators

Alumoxane activators are utilized as activators in the catalyst systems described herein. Alumoxanes are generally oligomeric compounds containing —Al(Rₐ″′)—O— sub-units, where R^{a}″′ is an alkyl group. Examples of alumoxanes include methylalumoxane (MAO), modified methylalumoxane (MMAO), ethylalumoxane and isobutylalumoxane. Alkylalumoxanes and modified alkylalumoxanes are suitable as catalyst activators, such as when the abstractable ligand is an alkyl, halide, alkoxide or amide. Mixtures of different alumoxanes and modified alumoxanes may also be used. It may be suitable to use a visually clear methylalumoxane. A cloudy or gelled alumoxane can be filtered to produce a clear solution or clear alumoxane can be decanted from the cloudy solution. A useful alumoxane is a modified methyl alumoxane (MMAO) cocatalyst type 3A (commercially available from Akzo Chemicals, Inc. under the trade name Modified Methylalumoxane type 3A, covered under patent number U.S. Pat. No. 5,041,584, which is incorporated by reference herein). Another useful alumoxane is solid polymethylaluminoxane as described in U.S. Pat. Nos. 9,340,630, 8,404,880, and 8,975,209, which are incorporated by reference herein.

When the activator is an alumoxane (modified or unmodified), and in at least one embodiment, an amount of activator at up to a 5,000-fold molar excess Al/M over the catalyst compound (per metal catalytic site) may be used. The minimum activator-to-catalyst-compound may be a 1:1 molar ratio. Alternate ranges may include about 1:1 to about 500:1, alternately about 1:1 to about 200:1, alternately about 1:1 to about 100:1, or alternately about 1:1 to about 50:1.

In an alternate embodiment, little or no alumoxane is used in the polymerization processes described herein. For example, alumoxane can be present at zero mol %, alternately the alumoxane can be present at a molar ratio of aluminum to catalyst compound transition metal less than 500:1, such as less than 300:1, such as less than 100:1, such as less than 1:1.

### Ionizing/Non-Coordinating Anion Activators

The term “non-coordinating anion” (NCA) means an anion which either does not coordinate to a cation or which is only weakly coordinated to a cation thereby remaining sufficiently labile to be displaced by a Lewis base. “Compatible” non-coordinating anions are those which are not degraded to neutrality when the initially formed complex decomposes. Further, the anion will not transfer an anionic substituent or fragment to the cation so as to cause it to form a neutral transition metal compound and a neutral by-product from the anion. Non-coordinating anions useful in accordance with the present disclosure are those that are compatible, stabilize the transition metal cation in the sense of balancing its ionic charge at +1, and yet retain sufficient lability to permit displacement during polymerization. Suitable ionizing activators may include an NCA, such as a compatible NCA.

It is within the scope of the present disclosure to use an ionizing activator, neutral or ionic. It is also within the scope of the present disclosure to use neutral or ionic activators alone or in combination with alumoxane or modified alumoxane activators.

For descriptions of some suitable activators please see U.S. Pat. Nos. 8,658,556 and 6,211,105, incorporated by reference herein. Additional suitable activators are described in U.S. Patent Publication 2021/0179650, incorporated by reference herein.

In some embodiments, an activator can be one or more of N,N-dimethylanilinium tetrakis(perfluorophenyl)borate, N,N-dimethylanilinium tetrakis(perfluoronaphthyl)borate, dioctadecylmethylammonium tetrakis(perfluorophenyl)borate, N,N-dimethylanilinium tetrakis(perfluorobiphenyl)borate, N,N-dimethylanilinium tetrakis(3,5-bis(trifluoromethyl)phenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate, or triphenylcarbenium tetra(perfluorophenyl)borate.

In at least one embodiment, the activator is selected from one or more of a triaryl carbenium (such as triphenylcarbenium tetraphenylborate, triphenylcarbenium tetrakis(pentafluorophenyl)borate, triphenylcarbenium tetrakis-(2,3,4,6-tetrafluorophenyl)borate, triphenylcarbenium tetrakis(perfluoronaphthyl)borate, triphenylcarbenium tetrakis(perfluorobiphenyl)borate, or triphenylcarbenium tetrakis(3,5-bis(trifluoromethyl)phenyl)borate).

Particularly useful activators are also described in PCT Application number PCT/US2020/044865 (publication number WO2021/086467), U.S. patent application Ser. No. 16/394,174 (published as US2019/0330394) and PCT Application number PCT/US2019/029056 (published as WO2019/210026) describing non-aromatic-hydrocarbon soluble activator compounds such as N-methyl-4-nonadecyl-N-octadecylanilinium [tetrakis(pentafluorophenyl)borate], N-methyl-4-nonadecyl-N-octadecylanilinium [tetrakis(heptafluoronaphthalenyl)borate], N-methyl-N-octadecyl-4-(octadecyloxy)anilinium [tetrakis(pentafluorophenyl)borate)], N-methyl-N-octadecyl-4-(octadecyloxy)anilinium [tetrakis(heptafluoronaphthalenyl) borate], N,N-di(hydrogenated tallow)methylammonium [tetrakis(pentafluorophenyl)borate], N,N-di(hydrogenated tallow)methylammonium [tetrakis(heptafluoronaphthalenyl)borate], N,N-di(octadecyl)methylammonium [tetrakis(pentafluorophenyl)borate], N,N-di(octadecyl)methylammonium [tetrakis(heptafluoronaphthalenyl)borate], N,N-di(hexadecyl)methylammonium [tetrakis(pentafluorophenyl)borate], N,N-di(hexadecyl)methylammonium [tetrakis(heptafluoronaphthalenyl)borate], N-octadecyl-N-hexadecylmethylammonium [tetrakis(pentafluorophenyl)borate], and N-octadecyl-N-hexadecylmethylammonium [tetrakis(heptafluoronaphthalenyl)borate].

Suitable activator-to-catalyst ratio, e.g., all NCA activators-to-catalyst ratio may be about a 1:1 molar ratio. Alternate ranges include about 0.1:1 to about 100:1, alternately about 0.5:1 to about 200:1, alternately about 1:1 to about 500:1, alternately about 1:1 to about 1000:1. Suitable ranges can be about 0.5:1 to about 10:1, such as about 1:1 to about 5:1.

It is also within the scope of the present disclosure that the catalyst compounds can be combined with combinations of alumoxanes and NCA's (see for example, U.S. Pat. Nos. 5,153,157; 5,453,410; EP 0573120 B1; WO 1994/007928; and WO 1995/014044, incorporated herein by reference, which discuss the use of an alumoxane in combination with an ionizing activator).

Chain transfer agents may be used in polymerization processes of the present disclosure. Useful chain transfer agents can be hydrogen, alkylalumoxanes, a compound represented by the formula AlR₃, ZnR₂ (where each R is, independently, a C₁-C₈ aliphatic radical, such as methyl, ethyl, propyl, butyl, pentyl, hexyl octyl or an isomer thereof) or a combination thereof, such as diethyl zinc, methylalumoxane, trimethylaluminum, triisobutylaluminum, trioctylaluminum, or a combination thereof.

Furthermore, a catalyst system of the present disclosure may include a metal hydrocarbenyl chain transfer agent represented by the formula:

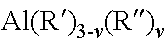

where each R′ can be independently a C₁-C₃₀ hydrocarbyl group, and or each R″, can be independently a C₄-C₂₀ hydrocarbenyl group having an end-vinyl group; and v can be from 0.1 to 3.

### Optional Support Materials

In embodiments herein, the catalyst system may include an inert support material. The supported material can be a porous support material, for example, talc, and inorganic oxides. Other support materials include zeolites, clays, organoclays, or another organic or inorganic support material, or mixtures thereof.

The support material can be an inorganic oxide. The inorganic oxide can be in a finely divided form. Suitable inorganic oxide materials for use in catalyst systems herein may include groups 2, 4, 13, and 14 metal oxides, such as silica, alumina, and mixtures thereof. Other inorganic oxides that may be employed either alone or in combination with the silica, or alumina can be magnesia, titania, zirconia. Other suitable support materials, however, can be employed, for example, finely divided functionalized polyolefins, such as finely divided polyethylene. Examples of suitable supports may include magnesia, titania, zirconia, montmorillonite, phyllosilicate, zeolites, talc, clays. Also, combinations of these support materials may be used, for example, silica-chromium, silica-alumina, silica-titania. In at least one embodiment, the support material is selected from Al₂O₃, ZrO₂, SiO₂, SiO₂/Al₂O₃, SiO₂/TiO₂, silica clay, silicon oxide/clay, or mixtures thereof.

The support material, such as an inorganic oxide, can have a surface area of about 10 m²/g to about 700 m²/g, pore volume of about 0.1 cm³/g to about 4.0 cm³/g and average particle size of about 5 μm to about 500 μm. The surface area of the support material can be of about 50 m²/g to about 500 m²/g, pore volume of about 0.5 cm³/g to about 3.5 cm³/g and average particle size of about 10 μm to about 200 μm. For example, the surface area of the support material can be about 100 m²/g to about 400 m²/g, pore volume of about 0.8 cm³/g to about 3.0 cm³/g and average particle size can be about 5 μm to about 100 μm. The average pore size of the support material useful in the present disclosure can be of about 10 Å to about 1000 Å, such as about 50 Å to about 500 Å, and such as about 75 Å to about 350 Å. In at least one embodiment, the support material is a high surface area, amorphous silica (surface area=300 m²/gm; pore volume of 1.65 cm³/gm). For example, suitable silicas can be the silicas marketed under the tradenames of DAVISON™ 952 or DAVISON™ 955 by the Davison Chemical Division of W.R. Grace and Company. In other embodiments, DAVISON™ 948 is used. Alternatively, a silica can be ES-70™ silica (PQ Corporation, Malvern, Pennsylvania) that has been calcined, for example (such as at 875° C.).

The support material should be dry, that is, free or substantially free of absorbed water. Drying of the support material can be effected by heating or calcining at about 100° C. to about 1000° C., such as at least about 600° C. When the support material is silica, it is heated to at least 200° C., such as about 200° C. to about 850° C., and such as at about 600° C.; and for a time of about 1 minute to about 100 hours, about 12 hours to about 72 hours, or about 24 hours to about 60 hours. The calcined support material must have at least some reactive hydroxyl (OH) groups to produce supported catalyst systems of the present disclosure. The calcined support material is then contacted with at least one polymerization catalyst including at least one catalyst compound and an activator.

The support material, having reactive surface groups, such as hydroxyl groups, is slurried in a non-polar solvent and the resulting slurry is contacted with a solution of a catalyst compound and an activator. In at least one embodiment, the slurry of the support material is first contacted with the activator for a period of time of about 0.5 hour to about 24 hours, about 2 hours to about 16 hours, or about 4 hours to about 8 hours. The solution of the catalyst compound is then contacted with the isolated support/activator. In at least one embodiment, the supported catalyst system is generated in situ. In alternate embodiments, the slurry of the support material is first contacted with the catalyst compound for a period of time of about 0.5 hour to about 24 hours, about 2 hours to about 16 hours, or about 4 hours to about 8 hours. The slurry of the supported catalyst compound is then contacted with the activator solution.

The mixture of the catalyst(s), activator(s) and support is heated about 0° C. to about 70° C., such as about 23° C. to about 60° C., such as at room temperature. Contact times can be about 0.5 hours to about 24 hours, such as about 2 hours to about 16 hours, or about 4 hours to about 8 hours.

Suitable non-polar solvents are materials in which all of the reactants used herein, e.g., the activator and the catalyst compound, are at least partially soluble and which are liquid at polymerization temperatures. Non-polar solvents can be alkanes, such as isopentane, hexane, n-heptane, octane, nonane, and decane, although a variety of other materials including cycloalkanes, such as cyclohexane, aromatics, such as benzene, toluene, and ethylbenzene, may also be employed.

In at least one embodiment, the support material is a supported methylalumoxane (SMAO), which is an MAO activator treated with silica (e.g., ES-70-875 silica).

### Polymerization Processes

The present disclosure also relates to polymerization processes where monomer (e.g., ethylene; propylene), and optionally a comonomer, are contacted with a catalyst system including an activator and at least one catalyst compound of the present disclosure. The catalyst compound and activator may be combined in any suitable order. The catalyst compound and activator may be combined prior to contacting with the monomer. Alternatively the catalyst compound and activator may be introduced into the polymerization reactor separately, wherein the catalyst compound and activator subsequently react to form the active catalyst.

Monomers may include substituted or unsubstituted C₂ to C₄₀ alpha olefins, such as C₂ to C₂₀ alpha olefins, such as C₂ to C₁₂ alpha olefins, such as ethylene, propylene, butene, pentene, hexene, heptene, octene, nonene, decene, undecene, dodecene and isomers thereof. In at least one embodiment, the monomer includes ethylene and an optional comonomer including one or more C₃ to C₄₀ olefins, such as C₄ to C₂₀ olefins, such as C₆ to C₁₂ olefins. The C₃ to C₄₀ olefin monomers may be linear, branched, or cyclic. The C₃ to C₄₀ cyclic olefins may be strained or unstrained, monocyclic or polycyclic, and may optionally include heteroatoms and or one or more functional groups. In another embodiment, the monomer includes propylene and an optional comonomer including one or more ethylene or C₄ to C₄₀ olefins, such as C₄ to C₂₀ olefins, such as C₆ to C₁₂ olefins. The C₄ to C₄₀ olefin monomers may be linear, branched, or cyclic. The C₄ to C₄₀ cyclic olefins may be strained or unstrained, monocyclic or polycyclic, and may optionally include heteroatoms and or one or more functional groups.

Exemplary C₂ to C₄₀ olefin monomers and optional comonomers may include ethylene, propylene, butene, pentene, hexene, heptene, octene, nonene, decene, undecene, dodecene, norbornene, ethylidenenorbornene, vinylnorbornene, norbornadiene, dicyclopentadiene, cyclopentene, cycloheptene, cyclooctene, cyclooctadiene, cyclododecene, 7-oxanorbornene, 7-oxanorbornadiene, substituted derivatives thereof, and isomers thereof, such as hexene, heptene, octene, nonene, decene, dodecene, cyclooctene, 1,5-cyclooctadiene, 1-hydroxy-4-cyclooctene, 1-acetoxy-4-cyclooctene, 5-methylcyclopentene, cyclopentene, dicyclopentadiene, norbornene, norbornadiene, and their respective homologs and derivatives, such as norbornene, norbornadiene, and dicyclopentadiene.

Polymerization processes of the present disclosure can be carried out in any suitable manner. Any suitable suspension, homogeneous, bulk, solution, slurry, or gas phase polymerization process can be used. Such processes can be run in a batch, semi-batch, or continuous mode. Homogeneous polymerization processes and slurry processes can be employed. (A homogeneous polymerization process is defined to be a process where at least 90 wt % of the product is soluble in the reaction media.) A homogeneous polymerization process can be a bulk homogeneous process. (A bulk process is defined to be a process where monomer concentration in all feeds to the reactor is 70 volume % or more.) Alternately, no solvent or diluent is present or added in the reaction medium, (except for the small amounts used as the carrier for the catalyst system or other additives, or amounts found with the monomer; e.g., propane in propylene). In another embodiment, the process is a slurry process. As used herein, the term “slurry polymerization process” means a polymerization process where a supported catalyst is employed and monomers are polymerized on the supported catalyst particles. At least 95 wt % of polymer products derived from the supported catalyst are in granular form as solid particles (not dissolved in the diluent).

Suitable diluents/solvents for polymerization may include non-coordinating, inert liquids. Examples of diluents/solvents for polymerization may include straight and branched-chain hydrocarbons, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as can be found commercially (e.g., Isopar™); perhalogenated hydrocarbons, such as perfluorinated C₄ to C₁₀ alkanes, chlorobenzene, and aromatic and alkyl substituted aromatic compounds, such as benzene, toluene, mesitylene, and xylene. Suitable solvents may also include liquid olefins which may act as monomers or comonomers including ethylene, propylene, 1-butene, 1-hexene, 1-pentene, 3-methyl-1-pentene, 4-methyl-1-pentene, 1-octene, 1-decene, and mixtures thereof. In at least one embodiment, aliphatic hydrocarbon solvents are used as the solvent, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof. In another embodiment, the solvent is not aromatic, such as aromatics are present in the solvent at less than 1 wt %, such as less than 0.5 wt %, such as 0 wt % based upon the weight of the solvents.

In at least one embodiment, a feedstream to the reactor has a feed concentration of the monomers and comonomers for the polymerization is 60 vol % solvent or less, such as 40 vol % or less, such as 20 vol % or less, based on the total volume of the feedstream. In at least one embodiment, the polymerization is run in a bulk process.

Polymerizations can be run at any temperature and or pressure suitable to obtain the desired polymers. Suitable temperatures and or pressures include a temperature of about 0° C. to about 300° C., such as about 20° C. to about 200° C., such as about 35° C. to about 160° C., such as about 80° C. to about 160° C., such as about 85° C. to about 140° C. Polymerizations can be run at a pressure of about 0.1 MPa to about 25 MPa, such as about 0.45 MPa to about 6 MPa, or about 0.5 MPa to about 4 MPa.

In a suitable polymerization, the run time of the reaction can be up to about 300 minutes, such as about 5 minutes to about 250 minutes, such as about 10 minutes to about 120 minutes, such as about 20 minutes to about 90 minutes, such as about 30 minutes to about 60 minutes. In a continuous process the run time may be the average residence time of the reactor. In at least one embodiment, the run time of the reaction is up to about 45 minutes. In a continuous process the run time may be the average residence time of the reactor.

In at least one embodiment, hydrogen is present in the polymerization reactor at a partial pressure of about 0.001 psig to about 50 psig (0.007 kPa to 345 kPa), such as about 0.01 psig to about 25 psig (0.07 kPa to 172 kPa), such as about 0.1 psig to about 10 psig (0.7 kPa to 70 kPa).

In at least one embodiment, the hydrogen content is about 0.0001 ppm to about 2,000 ppm, such as about 0.0001 ppm to about 1,500 ppm, such as about 0.0001 ppm to about 1,000 ppm, such as about 0.0001 ppm to about 500 ppm. Alternately, hydrogen can be present at zero ppm.

In at least one embodiment, little or no alumoxane is used in the process to produce the polymers. For example, alumoxane can be present at zero mol %, alternately the alumoxane can be present at a molar ratio of aluminum to transition metal less than 500:1, such as less than 300:1, such as less than 100:1, such as less than 1:1.

Unless otherwise indicated, “catalyst productivity” is a measure of how many grams of polymer (P) are produced using a polymerization catalyst comprising W g of catalyst (cat), over a period of time of T hours; and may be expressed by the following formula: P/(T×W) and expressed in units of gPgcat⁻¹hr⁻¹. Unless otherwise indicated, “catalyst activity” is a measure of how active the catalyst is and is reported as the mass of product polymer (P) produced per mole of catalyst (cat) used (kgP/molcat) or as the mass of product polymer (P) produced per mass of catalyst (cat) used (gP/gcat). Catalyst activity may also be expressed over a period of time T of hours and reported as the mass of product polymer (P) produced per mole or millimole of catalyst (cat) used and expressed in units of gPmmolcat⁻¹hr⁻¹.

In at least one embodiment, according to the present disclosure, a catalyst system has a catalyst activity of greater than about 10,000 gPmmolcat⁻¹hr⁻¹, such as greater than about 100,000 gPmmolcat⁻¹hr⁻¹, such as greater than about 500,000 gPmmolcat⁻¹hr⁻¹, such as about 50,000 gPmmolcat⁻¹hr⁻¹ to about 2,800,000 gPmmolcat⁻¹hr⁻¹, such as about 50,000 gPmmolcat⁻¹hr⁻¹ to about 1,200,000 gPmmolcat⁻¹hr⁻¹, such as about 200,000 gPmmolcat⁻¹hr⁻¹ to about 1,000,000 gPmmolcat⁻¹hr⁻¹, such as about 200,000 gPmmolcat⁻¹hr⁻¹ to about 500,000 gPmmolcat⁻¹hr⁻¹, such as about 300,000 gPmmolcat⁻¹hr⁻¹ to about 500,000 gPmmolcat⁻¹hr⁻¹, alternatively about 500,000 gPmmolcat⁻¹hr⁻¹ to about 950,000 gPmmolcat⁻¹hr⁻¹, such as about 800,000 gPmmolcat⁻¹hr⁻¹ to about 950,000 gPmmolcat⁻¹hr⁻¹.

In at least one embodiment, the polymerization: 1) is conducted at temperatures of about 0° C. to about 300° C. (such as about 25° C. to about 250° C., such as about 50° C. to about 160° C., such as about 80° C. to about 140° C.); 2) is conducted at a pressure of atmospheric pressure to about 10 MPa (such as about 0.35 MPa to about 10 MPa, such as about 0.45 MPa to about 6 MPa, such as about 0.5 MPa to about 4 MPa); 3) is conducted in an aliphatic hydrocarbon solvent (such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as where aromatics are present in the solvent at less than 1 wt %, such as less than 0.5 wt %, such as at 0 wt % based upon the weight of the solvents); 4) wherein the catalyst system used in the polymerization comprises less than 0.5 mol %, such as about 0 mol % alumoxane, alternately the alumoxane is present at a molar ratio of aluminum to transition metal less than 500:1, such as less than 300:1, such as less than 100:1, such as less than 1:1; 5) the polymerization occurs in one reaction zone; 6) optionally scavengers (such as trialkyl aluminum compounds) are absent (e.g., present at zero mol %, alternately the scavenger is present at a molar ratio of scavenger metal to transition metal of less than 100:1, such as less than 50:1, such as less than 15:1, such as less than 10:1); and 7) optionally hydrogen is present in the polymerization reactor at a partial pressure of about 0.001 psig to about 50 psig (0.007 kPa to 345 kPa) (such as about 0.01 psig to about 25 psig (0.07 kPa to 172 kPa), such as about 0.1 psig to about 10 psig (0.7 kPa to 70 kPa)). In at least one embodiment, the catalyst system used in the polymerization includes no more than one catalyst compound. A “reaction zone” also referred to as a “polymerization zone” is a vessel where polymerization takes place, for example a stirred-tank reactor or a loop reactor. When multiple reactors are used in a continuous polymerization process, each reactor is considered as a separate polymerization zone. For a multi-stage polymerization in a batch polymerization process, each polymerization stage is considered as a separate polymerization zone. In at least one embodiment, the polymerization occurs in one reaction zone. Room temperature is 23° C. unless otherwise noted.

Other additives may also be used in the polymerization, as desired, such as one or more scavengers, hydrogen, aluminum alkyls, or chain transfer agents such as alkylalumoxanes, a compound represented by the formula AlR₃ or ZnR₂ (where each R is, independently, a C₁-C₈ aliphatic radical, such as methyl, ethyl, propyl, butyl, pentyl, hexyl octyl or an isomer thereof) or a combination thereof, such as diethyl zinc, methylalumoxane, trimethylaluminum, triisobutylaluminum, trioctylaluminum, or a combination thereof.

### Polyolefin Products

The present disclosure also relates to compositions of matter produced by the methods described herein.

In at least one embodiment, a process described herein produces C₂ to C₂₀ olefin homopolymers (e.g., ethylene homopolymer; propylene homopolymer), or C₂ to C₂₀ olefin copolymers (e.g., ethylene-octene, ethylene-propylene, propylene ethylene) and or other propylene-alpha-olefin copolymers, such as C₃ to C₂₀ copolymers (such as propylene-hexene, or propylene-octene).

A process of the present disclosure produces olefin polymers, such as polyethylene and propylene homopolymers and copolymers. In at least one embodiment, the polymers produced herein are homopolymers of ethylene or copolymers of ethylene having, for example, about 0.00001 wt % to about 40 wt % (alternately about 5 wt % to about 42 wt %, such as about 10 wt % to about 35 wt %, such as about 10 wt % to about 20 wt %, alternatively about 20 wt % to about 30 wt %, such as about 25 wt % to about 30 wt %, of one or more C₃ to C₂₀ olefin comonomer (such as C₃ to C₁₂ alpha-olefin, such as propylene, butene, hexene, octene, decene, dodecene, such as propylene, butene, hexene, octene). For example, it has been discovered that catalyst compounds of the present disclosure can provide ethylene copolymers having high comonomer content, providing controllable/tunable melt temperature depending on desired comonomer content. In at least one embodiment, the monomer is ethylene and the comonomer is hexene or octene, such as about 10 wt % to about 35 wt % hexene or octene, such as about 10 wt % to about 20 wt % hexene or octene, such as about 15 wt % to about 25 wt % hexene or octene, alternatively about 25 wt % to about 33 wt %, based on the weight of the polymer.

In at least one embodiment, the polymers produced herein are homopolymers of propylene or are copolymers of propylene having, for example, about 0.00001 wt % to about 8 wt % (alternately about 0.00001 wt % to about 7 wt %, such as about 0.05 wt % to about 5 wt %, such as about 0.5 wt % to about 2.5 wt %) of one or more of C₂ or C₄ to C₂₀ olefin comonomer (such as ethylene or C₄ to C₁₂ alpha-olefin, such as ethylene, butene, hexene, octene, decene, dodecene, such as ethylene, butene, hexene, octene). In at least one embodiment, the monomer is propylene and the comonomer is ethylene, such as about 0.00001 wt % to about 5 wt % ethylene, such as about 0.00001 wt % to about 4 wt % ethylene, such as about 0.00001 wt % to about 2.5 wt % ethylene, based on the weight of the polymer.

In at least one embodiment, a polymer produced herein has a unimodal or multimodal molecular weight distribution as determined by Gel Permeation Chromatography (GPC). By “unimodal” is meant that the GPC trace has one peak or inflection point. By “multimodal” is meant that the GPC trace has at least two peaks or inflection points. An inflection point is that point where the second derivative of the curve changes in sign (e.g., from negative to positive or vice versus).

In at least one embodiment, a propylene homopolymer or propylene copolymer of the present disclosure has an Mw about 10,000 g/mol to about 600,000 g/mol, such as about 50,000 g/mol to about 450,000 g/mol, such as about 100,000 g/mol to about 250,000 g/mol, such as about 150,000 g/mol to about 225,000 g/mol, alternatively about 250,000 g/mol to about 500,000 g/mol, such as about 250,000 g/mol to about 450,000 g/mol, such as about 300,000 g/mol to about 400,000 g/mol, alternatively about 50,000 g/mol to about 100,000 g/mol, alternatively about 100,000 g/mol to about 200,000 g/mol.

In at least one embodiment, a propylene homopolymer or propylene copolymer of the present disclosure has an Mn about 1,000 g/mol to about 300,000 g/mol, such as about 5,000 g/mol to about 250,000 g/mol, such as about 5,000 g/mol to about 100,000 g/mol, such as about 40,000 g/mol to about 85,000 g/mol, alternatively about 100,000 g/mol to about 250,000 g/mol, such as about 180,000 g/mol to about 225,000 g/mol, alternatively about 120,000 g/mol to about 170,000 g/mol.

In at least one embodiment, a propylene homopolymer or propylene copolymer of the present disclosure has an Mz about 100,000 g/mol to about 1,100,000 g/mol, such as about 200,000 g/mol to about 800,000 g/mol, such as about 400,000 g/mol to about 800,000 g/mol, such as about 600,000 g/mol to about 800,000 g/mol, alternatively about 800,000 g/mol to about 1,100,000 g/mol, alternatively about 200,000 g/mol to about 400,000 g/mol, such as about 200,000 g/mol to about 300,000 g/mol, alternatively about 100,000 g/mol to about 200,000 g/mol.

In at least one embodiment, a propylene homopolymer or propylene copolymer of the present disclosure has an Mw/Mn (PDI) value about 1 to about 8, such as about 1 to about 5, such as about 1 to about 3, such as about 1 to about 2.5, such as about 1 to about 2.

In at least one embodiment, a propylene homopolymer or propylene copolymer of the present disclosure can have a Tm (° C.) of about 120° C. to about 150° C., such as about 122.5° C. to about 150° C., such as about 135° C. to about 147° C., such as about 140° C. to about 145° C., alternatively about 145° C. to about 150° C., alternatively about 130° C. to about 140° C., such as about 130° C. to about 135° C., alternatively about 135° C. to about 140° C.

The stereoregularity of isotactic propylene homopolymers and copolymers can be determined by the catalyst, total monomer concentrations, and reactor temperature. Isotactic propylene homopolymers (or copolymers) made according to processes of the present disclosure may comprise up to 99.99% m-dyads based on the total number of dyads present in the polymer, such as a meso dyad (m-dyad) content (m %) of about 85% to about 99.99%, such as about 90% to about 99%, such as about 92% to about 98%, such as about 92% to about 95%, alternatively about 95% to about 98%, as determined by ¹³C NMR, the remainder balance being r-dyad content (r %).

In some embodiments, an isotactic propylene homopolymer has an [rrrr] pentad content of about 0% to about 1.6%, such as about 0.2% to about 1.2%, such as about 0.3% to about 0.9%, as determined by ¹³C NMR. In some embodiments, an isotactic propylene homopolymer has an [mmmm] pentad content of about 80% to about 99%, such as about 85% to about 97%, such as about 90% to about 97%, alternatively about 80% to about 90%, such as about 85% to about 89%, alternatively about 80% to about 85%, as determined by ¹³C NMR. In some embodiments, an isotactic propylene homopolymer has an [mmmr] pentad content of about 0.1% to about 10%, such as about 1% to about 10%, such as about 1% to about 5%, alternatively about 5% to about 10%, as determined by ¹³C NMR. In some embodiments, an isotactic propylene homopolymer has an [rmmr] pentad content of about 0.1% to about 2%, such as about 0.2% to about 1.1%, such as about 0.3% to about 0.8%, as determined by ¹³C NMR. In some embodiments, an isotactic propylene homopolymer has an [mmrr] pentad content of about 0.1% to about 7%, such as about 0.2% to about 4%, such as about 1% to about 3%, alternatively about 3% to about 5%, as determined by ¹³C NMR. In some embodiments, an isotactic propylene homopolymer has an [mmrm+rmrr] pentad content of about 0.1% to about 9%, such as about 0.2% to about 2%, such as about 0.4% to about 1%, as determined by ¹³C NMR. In some embodiments, an isotactic propylene homopolymer has an [rmrm] pentad content of about 0.1% to about 5%, such as about 0.1% to about 1%, alternatively about 1% to about 2%, as determined by ¹³C NMR. In some embodiments, an isotactic propylene homopolymer has an [mrrr] pentad content of about 0.1% to about 3%, such as about 0.2% to about 1%, as determined by ¹³C NMR. In some embodiments, an isotactic propylene homopolymer has an [mrrm] pentad content of about 0.1% to about 4%, such as about 0.2% to about 1%, alternatively about 1% to about 2.8%, as determined by ¹³C NMR.

Regio Defect Concentrations by ¹³Carbon (¹³C NMR): ¹³C NMR spectroscopy is used to measure stereo and regio defect concentrations of polypropylene. ¹³C NMR spectra are acquired as described in more detail below.

The regio defects each give rise to multiple peaks in the ¹³Carbon NMR spectrum, and these are all integrated and averaged (to the extent that they are resolved from other peaks in the spectrum), to improve the measurement accuracy. The chemical shift offsets of the resolvable resonances used in the analysis are tabulated below. The precise peak positions may shift as a function of NMR solvent choice.

| Regio defect | Chemical shift range (ppm) |
|---|---|
| 2,1-erythro | 42.3, 38.6, 36.0, 35.9, 31.5, 30.6, 17.6, 17.2 |
| 2,1-threo | 43.4, 38.9, 35.6, 34.7, 32.5, 31.2, 15.4, 15.0 |
| 3,1 insertion | 37.6, 30.9, 27.7 |

The stereodefects measured as “stereo defects/10,000 monomer units” are calculated from the sum of the intensities of mmrr, mmrm+rrmr, and rmrm resonance peaks times 5,000. The intensities used in the calculations are normalized to the total number of monomers in the sample polymer. Methods for measuring 2,1 regio defects/10,000 monomers and 1,3 regio defects/10,000 monomers follow standard methods. Additional references include Grassi, A. et. al. Macromolecules, 1988, 21, 617-622 and Busico et. al. Macromolecules, 1994, 27, pp. 7538-7543. The average meso run length=10000/[(stereo defects/10000 C)+(2,1-regio defects/10000 C)+(1,3-regio-defects/10000 C)].

A low amount of regio defects provides a low or eliminated amount of haze of isotactic polypropylene films. Isotactic polypropylenes of the present disclosure can have a low amount of regio defects. In some embodiments, a polypropylene (or copolymer thereof) advantageously has less than 200 regio defects (defined as the sum of 2,1-erythro and 2,1-threo insertions, and 3,1-isomerizations) per 10,000 propylene units, alternatively more than 5, 10 or 25 and less than 150, 100, or 75 regio defects per 10,000 propylene units.

In some embodiments, a propylene homopolymer or propylene copolymer advantageously has less than 125 2,1-regio defects (defined as the sum of 2,1-erythro and 2,1-threo insertions) per 10,000 propylene units, such as more than 5, 15 or 25 and less than 75, 60, or 50 2,1-regio defects per 10,000 propylene units. In some embodiments, a propylene homopolymer or propylene copolymer advantageously has less than 100 1,3-regio defects (defined as 3,1 isomerizations) per 10,000 propylene units, such as more than 5, 7 or 15 and less than 75, 55, or 40 1,3-regio defects per 10,000 propylene units.

In some embodiments, a propylene homopolymer or propylene copolymer has less than 1,100 stereo defects per 10,000 propylene units, alternatively more than 50, 100 or 200 and less than 500, 400, or 350 stereo defects per 10,000 propylene units. In some embodiments, a propylene homopolymer or propylene copolymer has an average meso run length of about 20 to about 130, such as about 40 to about 100, alternatively about 20 to about 50.

In at least one embodiment, an ethylene homopolymer or ethylene copolymer of the present disclosure has an Mw about 10,000 g/mol to about 2,500,000 g/mol, such as about 200,000 g/mol to about 800,000 g/mol, such as about 200,000 g/mol to about 600,000 g/mol, such as about 250,000 g/mol to about 350,000 g/mol, alternatively about 600,000 g/mol to about 1,500,000 g/mol, such as about 900,000 g/mol to about 1,300,000 g/mol, such as about 1,000,000 g/mol to about 1,200,000 g/mol, alternatively about 1,200,000 g/mol to about 2,000,000 g/mol.

In at least one embodiment, an ethylene homopolymer or ethylene copolymer of the present disclosure has an Mn about 50,000 g/mol to about 2,000,000 g/mol, such as about 100,000 g/mol to about 800,000 g/mol, such as about 150,000 g/mol to about 300,000 g/mol, alternatively about 300,000 g/mol to about 500,000 g/mol, alternatively about 500,000 g/mol to about 850,000 g/mol, such as about 550,000 g/mol to about 700,000 g/mol, such as about 600,000 g/mol to about 700,000 g/mol.

In at least one embodiment, an ethylene homopolymer or ethylene copolymer of the present disclosure has an Mz about 200,000 g/mol to about 5,000,000 g/mol, such as about 400,000 g/mol to about 1,000,000 g/mol, such as about 500,000 g/mol to about 800,000 g/mol, alternatively about 1,000,000 g/mol to about 5,000,000 g/mol, alternatively about 2,000,000 g/mol to about 3,000,000 g/mol, alternatively about 3,000,000 g/mol to about 4,000,000 g/mol, alternatively about 4,000,000 g/mol to about 5,000,000 g/mol.

In at least one embodiment, an ethylene homopolymer or ethylene copolymer of the present disclosure has an Mw/Mn (PDI) value about 1 to about 8, such as about 1 to about 5, such as about 1 to about 3, such as about 1 to about 2.5, such as about 1 to about 2, alternatively about 3 to about 5.

In at least one embodiment, an ethylene homopolymer or ethylene copolymer of the present disclosure can have a Tm (° C.) of about 70° C. to about 150° C., such as about 100° C. to about 150° C., such as about 130° C. to about 140° C., alternatively about 100° C. to about 115° C., alternatively about 70° C. to about 85° C.

### GPC 4-D

Unless otherwise indicated, for purposes of the Claims, the distribution and the moments of molecular weight (Mw, Mn, Mz, Mw/Mn, etc.), the comonomer content are determined by using a high temperature Gel Permeation Chromatography (Polymer Char GPC-IR) equipped with a multiple-channel band-filter based Infrared detector IR5 with a multiple-channel band filter based infrared detector ensemble IR5 with band region covering about 2700 cm⁻¹ to about 3000 cm⁻¹ (representing saturated C—H stretching vibration), an 18-angle light scattering detector and a viscometer. Three Agilent PLgel 10-μm Mixed-B LS columns are used to provide polymer separation. Reagent grade 1,2,4-trichlorobenzene (TCB) (from Sigma-Aldrich) comprising ~300 ppm antioxidant BHT can be used as the mobile phase at a nominal flow rate of ~1.0 mL/min and a nominal injection volume of ~200 μL. The whole system including transfer lines, columns, and detectors can be contained in an oven maintained at ~145° C. A given amount of sample can be weighed and sealed in a standard vial with ~10 L flow marker (heptane) added thereto. After loading the vial in the auto-sampler, the oligomer or polymer may automatically be dissolved in the instrument with ~8 mL added TCB solvent at ~160° C. with continuous shaking. The sample solution concentration can be from ~0.2 to ~2.0 mg/ml, with lower concentrations used for higher molecular weight samples. The concentration, c, at each point in the chromatogram can be calculated from the baseline-subtracted IR5 broadband signal, I, using the equation: c=αI, where a is the mass constant determined with polyethylene or polypropylene standards. The mass recovery can be calculated from the ratio of the integrated area of the concentration chromatography over elution volume and the injection mass which is equal to the pre-determined concentration multiplied by injection loop volume. The conventional molecular weight (IR MW) is determined by combining universal calibration relationship with the column calibration which is performed with a series of monodispersed polystyrene (PS) standards ranging from 700 to 10M gm/mole. The MW at each elution volume is calculated with following equation:

$$log M = \frac{log ( {K}_{PS} / K )}{α + 1} + \frac{{α}_{PS} + 1}{α + 1} log {M}_{PS}$$

where the variables with subscript “PS” stand for polystyrene while those without a subscript are for the test samples. In this method, α_{PS}=0.67 and K_{PS}=0.000175, α and K for other materials are as calculated by GPC ONE™ software (Polymer Characterization, S.A., Valencia, Spain). Concentrations are expressed in g/cm³, molecular weight is expressed in g/mole, and intrinsic viscosity (hence K in the Mark-Houwink equation) is expressed in dL/g unless otherwise noted.

The comonomer composition is determined by the ratio of the IR5 detector intensity corresponding to CH₂ and CH₃ channel calibrated with a series of PE and PP homo/copolymer standards whose nominal value are predetermined by NMR or FTIR. In particular, this provides the methyls per 1000 total carbons (CH₃/1000 TC) as a function of molecular weight. The short-chain branch (SCB) content per 1000 TC (SCB/1000 TC) is then computed as a function of molecular weight by applying a chain-end correction to the CH₃/1000 TC function, assuming each chain to be linear and terminated by a methyl group at each end. The weight % comonomer is then obtained from the following expression in which f is 0.3, 0.4, 0.6, 0.8, and so on for C₃, C₄, C₆, C₈, and so on co-monomers, respectively:

$$w 2 = f * SCB / 1000 TC$$

The bulk composition of the polymer from the GPC-IR and GPC-4D analyses is obtained by considering the entire signals of the CH₃ and CH₂ channels between the integration limits of the concentration chromatogram. First, the following ratio is obtained

$$Bulk IR ratio = \frac{Area of {CH}_{3} signal within integration limits}{Area of {CH}_{2} signal within integration limits}$$

Then the same calibration of the CH₃ and CH₂ signal ratio, as mentioned previously in obtaining the CH₃/1000 TC as a function of molecular weight, is applied to obtain the bulk CH₃/1000 TC. A bulk methyl chain ends per 1000 TC (bulk CH₃end/1000 TC) is obtained by weight-averaging the chain-end correction over the molecular-weight range. Then

$$w 2 b = f * bulk CH 3 / 1000 TC$$

$$bulk SCB / 1000 TC = bulk CH 3 / 1000 TC - bulk CH 3 end / 1000 TC$$

and bulk SCB/1000 TC is converted to bulk w2 in the same manner as described above.

The LS detector is the 18-angle Wyatt Technology High Temperature DAWN HELEOSII. The LS molecular weight (M) at each point in the chromatogram is determined by analyzing the LS output using the Zimm model for static light scattering (Light Scattering from Polymer Solutions; Huglin, M. B., Ed.; Academic Press, 1972.).

$$\frac{{K}_{o} c}{Δ R ( θ )} = \frac{1}{MP ( θ )} + 2 {A}_{2} c$$

Here, ΔR(θ) is the measured excess Rayleigh scattering intensity at scattering angle θ, c is the polymer concentration determined from the IR5 analysis, A2 is the second virial coefficient, P(θ) is the form factor for a monodisperse random coil, and Ko is the optical constant for the system:

$${K}_{o} = \frac{4 {π}^{2} {{n}^{2} ( dn / dc )}^{2}}{{λ}^{4} {N}_{A}}$$

where NA is Avogadro's number, and (dn/dc) is the refractive index increment for the system, n=1.500 for TCB at 145° C. and λ=665 nm. For analyzing polyethylene homopolymers, ethylene-hexene copolymers, and ethylene-octene copolymers, dn/dc=0.1048 ml/mg and A2=0.0015; for analyzing ethylene-butene copolymers, dn/dc=0.1048*(1-0.00126*w2) ml/mg and A2=0.0015 where w2 is weight percent butene comonomer.

A high temperature Agilent (or Viscotek Corporation) viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, ηₛ, for the solution flowing through the viscometer is calculated from their outputs. The intrinsic viscosity, [η], at each point in the chromatogram is calculated from the equation [η]=ηs/c, where c is concentration and is determined from the IR5 broadband channel output. The viscosity MW at each point is calculated as M=K_{PS}M^{α}^{_{PS}}⁺¹/[η] where aps is 0.67 and Kₚₛ is 0.000175.

### Blends

In some embodiments, the polymer (such as the polyethylene, polypropylene, or copolymers thereof) produced herein is combined with one or more additional polymers prior to being formed into a film, molded part or other article. Other useful polymers include polyethylene, isotactic polypropylene, highly isotactic polypropylene, syndiotactic polypropylene, random copolymer of propylene and ethylene, and or butene, and or hexene, polybutene, ethylene vinyl acetate, low density polyethylene (LDPE), linear low density polyethylene (LLDPE), high density polyethylene (HDPE), ethylene vinyl acetate, ethylene methyl acrylate, copolymers of acrylic acid, polymethylmethacrylate or any other polymers polymerizable by a high-pressure free radical process, polyvinylchloride, polybutene-1, isotactic polybutene, ABS resins, ethylene-propylene rubber (EPR), vulcanized EPR, ethylene-propylene-diene monomer (EPDM) polymers, block copolymers, styrenic block copolymers, polyamides, polycarbonates, polyethylene terephthalate (PET) resins, cross linked polyethylene, copolymers of ethylene and vinyl alcohol (EVOH), polymers of aromatic monomers such as polystyrene, poly-1 esters, polyacetal, polyvinylidine fluoride, polyethylene glycols, and or polyisobutylene.

In at least one embodiment, the polymer (such as the polyethylene, polypropylene) is present in the above blends, at about 10 wt % to about 99 wt %, based upon the weight of the polymers in the blend, such as about 20 wt % to about 95 wt %, such as at least about 30 wt % to about 90 wt %, such as at least about 40 wt % to about 90 wt %, such as at least about 50 wt % to about 90 wt %, such as at least about 60 wt % to about 90 wt %, such as at least about 70 to about 90 wt %.

Additionally, additives may be included in the blend, in one or more components of the blend, and or in a product formed from the blend, such as a film, as desired. Such additives are well known in the art, and can include, for example: fillers; antioxidants (e.g., hindered phenolics such as IRGANOX™ 1010 or IRGANOX™ 1076 available from Ciba-Geigy); phosphites (e.g., IRGAFOS™ 168 available from Ciba-Geigy); anti-cling additives; tackifiers, such as polybutenes, terpene resins, aliphatic and aromatic hydrocarbon resins, alkali metal and glycerol stearates, and hydrogenated rosins; UV stabilizers; heat stabilizers; anti-blocking agents; release agents; anti-static agents; pigments; colorants; dyes; waxes; silica; fillers; talc.

### Films

Any of the foregoing polymers, or blends thereof, may be used in a variety of end-use applications. Such applications include, for example, mono- or multi-layer blown, extruded, and or shrink films. These films may be formed by any number of well-known extrusion or coextrusion techniques, such as a blown bubble film processing technique, wherein the composition can be extruded in a molten state through an annular die and then expanded to form a uni-axial or biaxial orientation melt prior to being cooled to form a tubular, blown film, which can then be axially slit and unfolded to form a flat film. Films may be subsequently unoriented, uniaxially oriented, or biaxially oriented to the same or different extents. One or more of the layers of the film may be oriented in the transverse and or longitudinal directions to the same or different extents. The uniaxially orientation can be accomplished using suitable cold drawing or hot drawing methods. Biaxial orientation can be accomplished using tenter frame equipment or a double bubble processes and may occur before or after the individual layers are brought together. For example, an ethylene layer can be extrusion coated or laminated onto an oriented polypropylene layer or the polyethylene and polypropylene can be coextruded together into a film then oriented. Likewise, oriented polypropylene could be laminated to oriented polyethylene or oriented polyethylene could be coated onto polypropylene then optionally the combination could be oriented even further. However, in another embodiment the film is oriented to the same extent in both the MD and TD directions.

The films may vary in thickness depending on the intended application; however, films of a thickness of about 1 μm to about 50 μm can be suitable. Films intended for packaging can be about 10 μm to about 50 μm thick. The thickness of the sealing layer can be about 0.2 μm to about 50 μm. There may be a sealing layer on both the inner and outer surfaces of the film or the sealing layer may be present on only the inner or the outer surface.

### EXPERIMENTAL

The experimental methods and analytical techniques utilized in Examples below are described in this section.

Chemical structures and isomers of catalyst compounds of the present disclosure were determined by ¹H NMR. ¹H NMR data are collected at 23° C. in a 5 mm probe using a 400 MHz Bruker spectrometer with deuterated methylene chloride or deuterated benzene. Data is recorded using a maximum pulse width of 45°, 8 seconds between pulses and signal averaging 16 transients. The spectrum is reported relative to residual protium in the deuterated benzene, which is referenced to 7.16 ppm.

Room temperature is 23° C. unless otherwise noted.

The pre-catalysts synthesized are illustrated below:

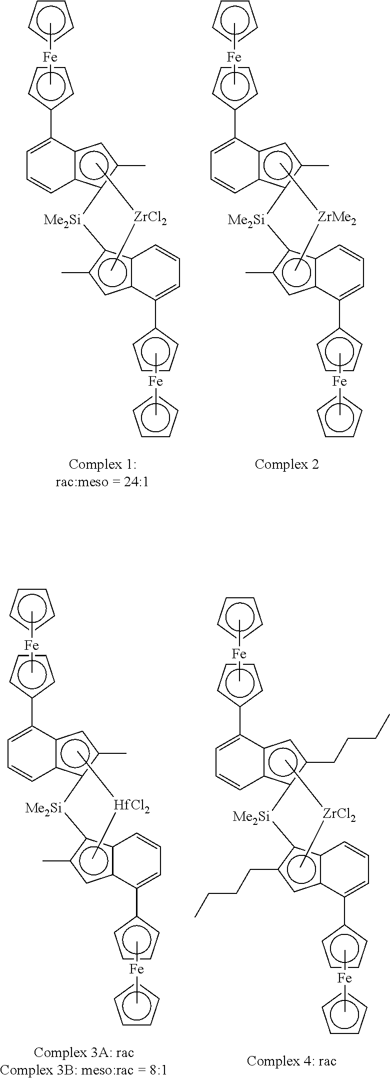

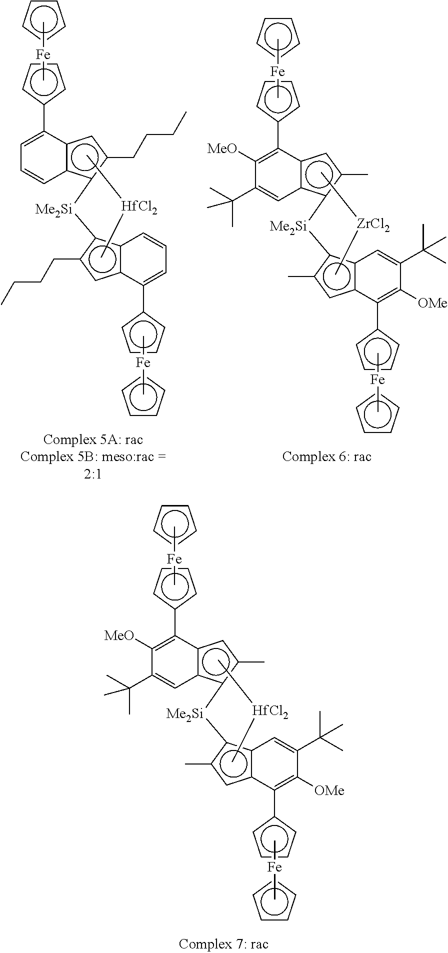

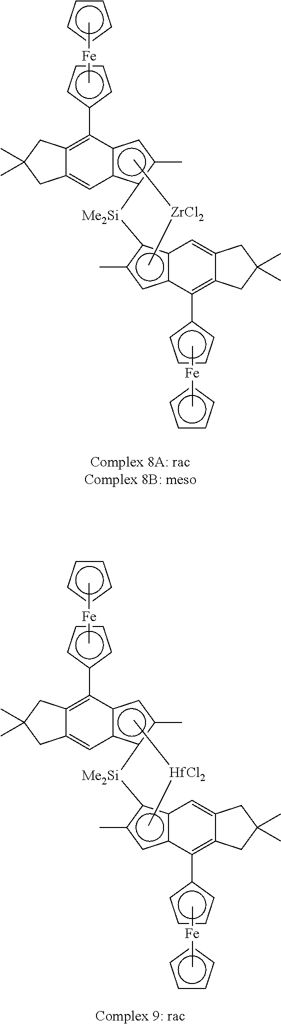

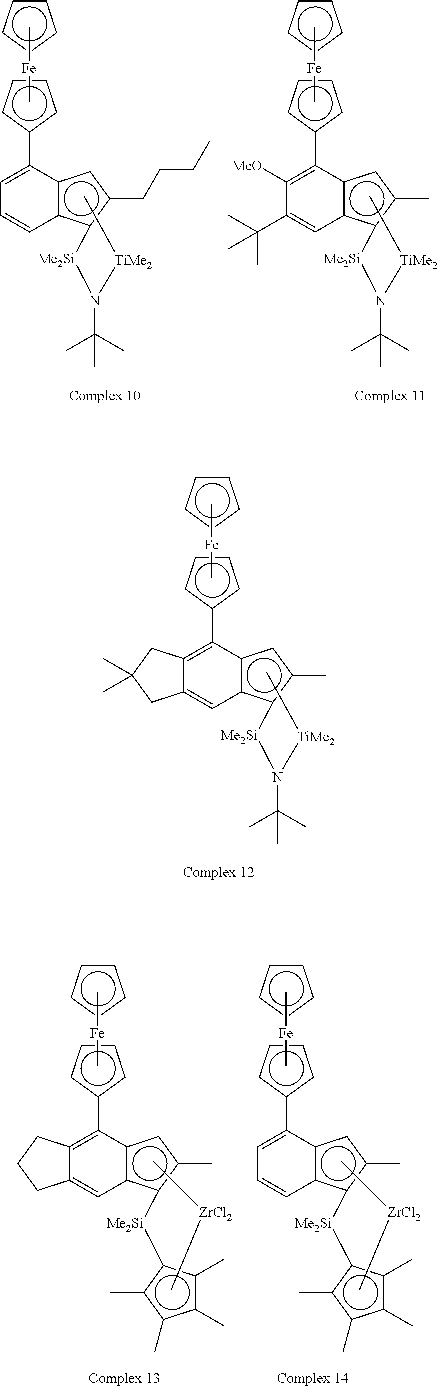

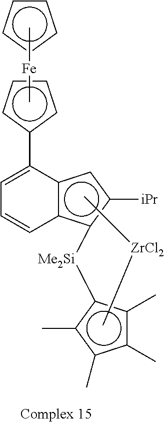

### Pre-Catalyst Synthesis

Starting Reagents: Ferrocene (abbr. Fc; Acros), ⁿBuLi in hexanes (Acros), ^{t}BuLi in pentane (Acros), MeLi in diethyl ether (Aldrich), MeMgBr in diethyl ether (Aldrich), TiCl₄ (Merck), ZrCl₄(THF)₂ (Aldrich), HfCl₄ (Strem), AlCl₃ (Merck), potassium tert-butoxide (Acros), sodium ethoxide (Acros), 2-bromobenzyl bromide (ABCR), tert-butylamine (Acros), N-methylimidazole (Acros), dichlorodimethylsilane (Merck), diethyl 2-butylmalonate (Aldrich), bis(tri-tert-butylphosphine)palladium (Aldrich), Pd₂dba₃ (dba=dibenzylideneacetone, Aldrich), tri-tert-butylphosphine (Aldrich), SOCl₂ (Acros), NaBH₄ (Acros), TsOH (Ts=toluenesulfonyl, Aldrich), Na₂SO₄ (Merck), K₂CO₃ (Merck), Na₂CO₃ (Merck), silica gel 60 (40-63 um) (Merck), KOH (Merck), 12 M HCl (Merck), dry ethanol (Merck), methanol (Merck), dichloromethane (Merck) for extractions of organic products, and Celite (Aldrich) were used as received. THF and diethyl ether were freshly distilled over sodium benzophenone ketyl and stored over 4 A molecular sieves. Toluene (Merck), benzene (Aldrich), pentane (Merck), hexane (Merck), dichloromethane (Merck) as well as CDCl₃ (Deutero GmbH) and CD₂Cl₂ (Deutero GmbH) for NMR experiments were stored over 4 Å molecular sieves. ZnCl₂ (Merck) was dried in vacuum at 120° C. 7-Bromo-2-methyl-1H-indene was prepared as described in [Izmer, V. V.; Lebedev, A. Y.; Nikulin, M. V.; Ryabov, A. N.; Asachenko, A. F.; Lygin, A. V.; Sorokin, D. A.; Voskoboynikov, A. Z. Organometallics 2006, 25, pg. 1217]. 4-Bromo-6-(tert-butyl)-5-methoxy-2-methyl-2,3-dihydro-1H-inden-1-one was prepared as described in [Nifant'ev, I. E.; Ivchenko, P. V.; Bagrov, V. V.; Churakov, A. V.; Mercandelli, P. Organometallics 2012, 31, pp. 4962-4970]. 2,6,6-Trimethyl-3,5,6,7-tetrahydro-s-indacen-1(2H)-one was prepared as described in [Canich, J. A. M.; Atienza, C. C. H.; Izmer, V. V.; Kononovich, D. S.; Voskoboynikov, A. Z. US 2016/0244535 A1].

### Example 1: Preparation of rac-Dimethylsilanediyl-bis(η⁵-4-ferrocenyl-2-methylinden-1-yl)zirconium dichloride (Complex 1)

### 7-(Ferrocen-1-yl)-2-methyl-1H-indene

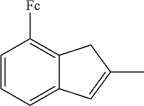

To a mixture of ferrocene (26.0 g, 140 mmol) and potassium tert-butoxide (1.91 g, 17.0 mmol) in 500 ml of THF, ^{t}BuLi (1.9 M in pentane, 147 ml, 280 mmol) was added dropwise for 20 minutes at −78° C. The resulting suspension was warmed to −20° C. and stirred at this temperature for 1 hour. Then, ZnCl₂ (21.0 g, 154 mmol) was added at −78° C., and the obtained mixture was warmed to ambient temperature. To the obtained organozinc compound, 7-bromo-2-methyl-1H-indene (29.3 g, 140 mmol) and bis(tri-tert-butylphosphine)palladium (0.15 M in toluene, 93.0 ml, 14.0 mmol) were subsequently added. The reaction mixture was refluxed overnight, cooled to ambient temperature, poured into water (1000 ml), and the crude product was extracted with dichloromethane (3×200 ml). The combined extract was passed through thin layer of silica gel 60 (40-63 um), the elute was dried over Na₂SO₄ and then evaporated to dryness. The residue was triturated with 300 ml of pentane, then the obtained suspension was filtered through a glass frit (G3), and the precipitate was dried in vacuum. Yield: 42.0 g (96%) of an orange solid as a mixture of isomers. HRMS (APPI): [M+H]⁺ Calcd. for C₂₀H₁₉Fe⁺: 315.0831; Found: 315.0836. ¹H NMR (400 MHz, CDCl₃) of the major isomer: δ 7.38 (d, J=7.8 Hz, 1H), 7.22 (t, J=7.5 Hz, 1H), 7.15 (d, J=7.3 Hz, 1H), 6.52 (m, 1H), 4.74-4.72 (m, 2H), 4.35-4.33 (m, 2H), 4.09 (s, 5H), 3.45 (s, 2H), 2.21 (s, 3H). ¹H NMR (400 MHz, CDCl₃) of the minor isomer: δ 7.44 (d, J=7.7 Hz, 1H), 7.30-7.25 (m, 2H), 7.03 (br.s., 1H), 4.66-4.62 (m, 2H), 4.35-4.32 (m, 2H), 4.14 (s, 5H), 3.35 (s, 2H), 2.22 (s, 3H). ¹³C NMR (101 MHz, CDCl₃) of mixture of the isomers: δ 146.3, 145.7, 145.6, 143.8, 143.1, 139.6, 133.9, 130.4, 127.1, 126.9, 126.5, 126.5, 123.4, 123.3, 121.3, 117.7, 86.4, 85.2, 69.4, 68.5, 68.4, 68.2, 67.8, 43.6, 42.7, 17.0, 16.8.

### Bis(4-ferrocenyl-2-methyl-1H-inden-1-yl)dimethylsilane

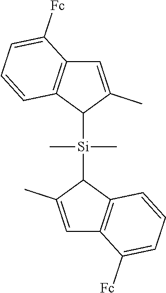

To a solution of 7-(ferrocen-1-yl)-2-methyl-1H-indene (22.0 g, 70.0 mmol) in 500 ml of diethyl ether, ⁿBuLi (2.5 M in hexanes, 28.0 ml, 70.0 mmol) was slowly added at −30° C. The resulting suspension was stirred overnight at ambient temperature, then cooled to −78° C., and N-methylimidazole (100 mg) was added. The obtained mixture was stirred for 5 minutes at −78° C., then dichlorodimethylsilane (4.52 g, 35.0 mmol) was added in one portion. This mixture was stirred overnight at ambient temperature, then passed through a short pad of silica gel 60 (40-63 um) which was additionally washed by dichloromethane (2×100 ml). The combined elute was evaporated to dryness, and the residue was purified by flash chromatography on silica gel 60 (40-63 um, eluent: hexane-dichloromethane=5:1, vol.). Yield: 15.0 g (63%) of the title product as an orange foam. According to NMR spectra the product was a mixture of rac- and meso-isomers. HRMS (ESI): [M]⁺ Calcd. for C₄₂H₄₀Fe₂Si⁺: 684.1593; Found: 684.1595. ¹H NMR (400 MHz, CDCl₃): δ 7.46-7.36 (m, 4H in rac or meso), 7.31-7.25 (m, 4H in meso or rac), 7.22-7.16 (m, 4H in rac and meso), 7.11-7.03 (m, 4H in meso and rac), 4.72-4.63 (m, 8H in rac or meso), 4.37-4.33 (8H in meso or rac), 4.13 (s, 10H, in rac or meso), 4.13 (s, 10H, in meso or rac), 3.78 (br. s., 4H in rac and meso), 2.31 (s, 6H in rac or meso), 2.24 (s, 6H in meso or rac), −0.21 (s, 3H in meso), −0.21 (s, 6H in rac), −0.24 (s, 3H in meso). ¹³C NMR (101 MHz, CDCl₃): δ 146.9, 146.7, 145.3, 145.3, 142.5, 142.4, 130.6, 126.7, 126.6, 125.3, 125.2, 122.6, 122.6, 121.2, 121.1, 86.6, 86.5, 69.4, 68.4, 68.4, 68.4, 68.3, 47.2, 47.1, 18.2, 18.1, −5.7, −5.7, −5.8.

### rac-Dimethylsilanediyl-bis(η⁵-4-ferrocenyl-2-methylinden-1-yl)zirconium dichloride (Complex 1)

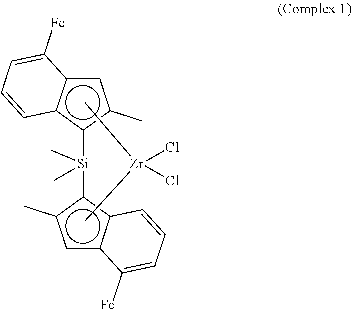

To a −40° C. solution of bis(4-ferrocenyl-2-methyl-1H-inden-1-yl)dimethylsilane (11.9 g, 17.4 mmol) in 600 ml of diethyl ether, ⁿBuLi (2.5 M in hexanes, 13.9 ml, 34.7 mmol) was added in one portion. This mixture was stirred overnight at ambient temperature, the resulting orange suspension was cooled to −78° C., and then of ZrCl₄(THF)₂ (6.56 g, 17.4 mmol) was added. The reaction mixture was stirred for 24 hours at room temperature and then evaporated to dryness. The residue was heated with toluene (200 ml), and the formed hot suspension was filtered through a short pad of Celite. The filtrate was evaporated to dryness giving a ca. 1:1 mixture of rac- and meso-complexes. This crude product was recrystallized from toluene yielding rac-complex (2.05 g, 14%) contaminated with ca. 4% of meso-complex as a red-orange powder. Anal. calc. for C₄₂H₃₈Cl₂Fe₂SiZr: C, 59.72; H, 4.53. Found: C, 59.96; H, 4.70. ¹H NMR (400 MHz, CD₂Cl₂) of rac-complex: δ 7.61 (d, J=8.6 Hz, 2H), 7.47 (d, J=7.0 Hz, 2H), 7.26 (s, 2H), 7.01 (dd, J=8.6, 7.1 Hz, 2H), 4.77-4.63 (m, 4H), 4.40-4.27 (m, 4H), 4.11 (s, 10H), 2.28 (s, 6H), 1.34 (s, 6H). ¹³C NMR (101 MHz, CD₂Cl₂): δ 137.4, 135.8, 132.0, 128.5, 125.9, 125.5, 123.6, 123.5, 85.3, 84.2, 70.8, 69.9, 69.7, 69.0, 66.8, 19.0, 2.7. ¹H NMR (400 MHz, CD₂Cl₂) of meso-complex: δ 7.56 (d, J=8.8 Hz, 2H), 7.25 (d, J=7.8 Hz, 2H), 7.11 (s, 2H), 6.73-6.77 (m, 2H), 4.59-4.61 (m, 4H), 4.31-4.33 (m, 4H), 4.08 (s, 10H), 3.51 (s, 6H), 1.45 (s, 3H), 1.26 (s, 3H).

### Example 2: Preparation of rac-Dimethylsilanediyl-bis(η⁵-4-ferrocenyl-2-methylinden-1-yl)zirconium dimethyl (Complex 2)

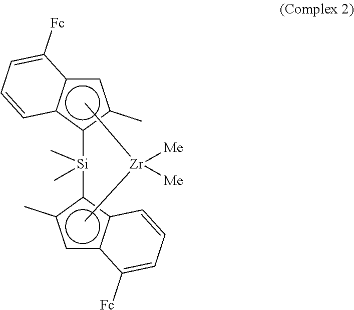

rac-Dimethylsilanediyl-bis(η⁵-4-ferrocenyl-2-methylinden-1-yl)zirconium dichloride (100 mg, 0.118 mmol) was dissolved in 15 ml benzene. To this solution, MeLi (1.6 M in diethyl ether, 0.222 ml, 0.355 mmol) was added and the mixture was allowed to stir at room temperature for two days. Next, the mixture was filtered through Celite, and the Celite was rinsed three times with 2 ml benzene. The resulting orange filtrate was placed under reduced pressure and the C₆H₆ lyophilized to afford a fine orange powder. This material was suspended in pentane (20 mL) and filtered to afford the product as a bright orange solid (yield 64.3 mg; 68% yield).

### Example 3: Preparation of rac-Dimethylsilanediyl-bis(η⁵-4-ferrocenyl-2-methylinden-1-yl)hafnium dichloride (Complex 3)

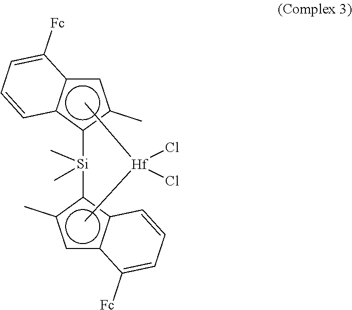

To a −40° C. solution of bis(4-ferrocenyl-2-methyl-1H-inden-1-yl)dimethylsilane (5.00 g, 7.30 mmol) in 250 ml of diethyl ether, ⁿBuLi (2.5 M in hexanes, 5.84 ml, 14.6 mmol) was added in one portion. This mixture was stirred overnight at ambient temperature, then the resulting orange suspension was cooled to −78° C., and HfCl₄ (2.34 g, 7.30 mmol) was added. This mixture was stirred for 24 hours at room temperature and then evaporated to dryness. The residue was heated with toluene (100 ml), and the formed hot suspension was filtered through a short pad of Celite. The filtrate was evaporated to dryness giving a ca. 1:1 mixture of rac- and meso-complexes. This crude product was recrystallized from toluene yielding 0.38 g (6%) of pure rac-complex (Cat ID 3A) and 0.10 g (1%) a ca. 1:8 mixture of rac/meso-complexes (Cat ID 3B). Rac-complex. Anal. calc. for C₄₂H₃₈Cl₂Fe₂SiHf: C, 54.13; H, 4.11. Found: C, 54.27; H, 4.24. ¹H NMR (400 MHz, CDCl₃): δ 7.63 (d, J=8.7 Hz, 2H), 7.50 (d, J=7.0 Hz, 2H), 7.16 (s, 3H), 7.02-6.96 (m, 2H), 4.72 (br.s., 2H), 4.70 (br.s., 2H), 4.33 (br.s., 4H), 4.14 (s, 10H), 2.38 (s, 6H), 1.33 (s, 6H). ¹³C NMR (101 MHz, CDCl₃): δ 136.8, 132.5, 131.4, 126.3, 125.3, 125.3, 122.8, 121.3, 85.1, 84.5, 70.5, 69.6, 69.0, 68.5, 66.6, 18.6, 2.5. Meso-complex. ¹H NMR (600 MHz, CDCl₃): δ 7.58 (d, J=8.8 Hz, 2H), 7.21-7.15 (m, 2H), 7.00 (s, 2H), 6.74 (dd, J=7.1, 8.7 Hz, 2H), 4.65-4.58 (m, 4H), 4.32-4.26 (m, 4H), 4.10 (s, 10H), 2.62 (s, 6H), 1.45 (s, 3H), 1.26 (s, 3H). ¹³C NMR (151 MHz, CDCl₃): δ 135.5, 134.7, 134.4, 126.5, 125.0, 124.1, 124.1, 118.8, 85.9, 85.3, 70.2, 69.6, 68.6, 68.4, 67.1, 18.8, 2.8, 2.6.

### Example 4: Preparation of rac-Dimethylsilanediyl-bis(η⁵-2-butyl-4-ferrocenylinden-1-yl)zirconium (Complex 4)

### 2-(2-Bromobenzyl)hexanoyl chloride

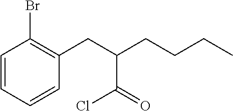 [SMILES: CCCCC(Cc1ccccc1Br)C(=O)Cl]

To a solution of sodium ethoxide (prepared from sodium metal (10.9 g, 472 mmol) and 400 ml of dry ethanol), diethyl 2-butylmalonate (100 g, 463 mmol) was added dropwise over 15 minutes. This mixture was stirred for 15 minutes, then, 2-bromobenzyl bromide (116 g, 463 mmol) was added dropwise. This mixture was refluxed for 4 hours and then cooled to room temperature. A solution of KOH (104 g, 1.85 mol) in 200 ml of water was then added. This mixture was refluxed for 3 hours to saponificate the ester formed. Ethanol and water were distilled off. To the residue, water (500 ml) and then 12 M HCl (to pH 1) were added. The substituted butylmalonic acid was extracted with dichloromethane (3×100 ml). The combined organic extract was dried over Na₂SO₄ and then evaporated to dryness. Crude 2-(2-bromobenzyl)hexanoic acid was obtained after decarboxylation of the substituted butylmalonic acid for 2 hours at 160° C. The product was used without further purification. A mixture of the obtained 2-(2-bromobenzyl)hexanoyl acid and SOCl₂ (100 ml, 166 g, 1.39 mol) was stirred for 12 hours at room temperature. An excess of SOCl₂ was distilled off in vacuum, and the following distillation of the residual product, b.p. 120° C.-150° C./2 mbar, gave 108 g (89%) of a yellowish liquid. Anal. calc. for C₁₃H₁₆BrClO: C, 51.43; H, 5.31. Found: C, 51.32; H, 5.40. ¹H NMR (400 MHz, CDCl₃): δ 7.57 (d, J=7.98 Hz, 1H), 7.28-7.24 (m, 2H), 7.16-7.10 (m, 1H), 3.33-3.22 (m, 1H), 3.20-3.12 (m, 1H), 3.04-3.27 (m, 1H), 1.91-1.79 (m, 1H), 1.73-1.62 (m, 1H), 1.50-1.29 (m, 4H), 0.92 (t, J=7.0 Hz, 3H). ¹³C NMR (101 MHz, CDCl₃): δ 176.3, 137.0, 133.0, 131.3, 128.6, 127.5, 124.4, 56.7, 38.0, 31.5, 28.6, 22.4, 13.7.

### 4-Bromo-2-butyl-2,3-dihydro-1H-inden-1-one

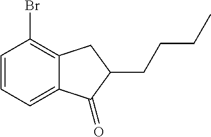

To a suspension of AlCl₃ (59.3 g, 444 mmol) in 1000 ml of dichloromethane, a solution of 2-(2-bromobenzyl)hexanoyl chloride (108 g, 355 mmol) in 50 ml of dichloromethane was added dropwise at 0° C. This mixture was stirred for 20 hours at room temperature and then poured on 2000 cm³ of crushed ice. The organic layer was separated, and the aqueous layer was extracted with dichloromethane (3×200 ml). The combined organic extract was washed by 10% K₂CO₃, dried over anhydrous K₂CO₃, then passed through a short column of silica gel 60 (40-63 um). The obtained elute was evaporated to dryness. Distillation of the residue, b.p. 138° C.-140° C./2 mbar, gave 70.1 g (88%) of a colorless oil. HRMS (ESI): [M+Na]⁺ Calcd. for C₁₃H₁₅BrNaO⁺: 289.0198; Found: 289.0191. ¹H NMR (400 MHz, CDCl₃): δ 7.76 (dd, J=0.8 Hz, 7.8 Hz, 1H), 7.70 (d, J=7.5 Hz, 1H), 7.28 (t, J=7.7 Hz, 1H), 3.28 (dd, J=7.6 Hz, 17.5 Hz, 1H), 2.80-2.65 (m, 2H), 2.05-1.89 (m, 1H), 1.57-1.25 (m, 5H), 0.91 (t, J=7.1 Hz, 3H). ¹³C NMR (101 MHz, CDCl₃): δ 207.8, 153.2, 138.7, 137.1, 128.9, 122.5, 122.0, 47.2, 33.8, 30.9, 29.3, 22.5, 13.8.

### 7-Bromo-2-butyl-1H-indene

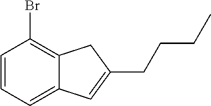

To a solution of 4-bromo-2-butyl-2,3-dihydro-1H-inden-1-one (62.2 g, 233 mmol) in 500 ml of THF, NaBH₄ (13.2 g, 350 mmol) was added at 5° C. To the resulting suspension, 250 ml of methanol was added dropwise by vigorous stirring at 5° C. The reaction mixture was stirred overnight at room temperature. The volatiles were evaporated, and the residue was diluted with 1000 ml of water. The crude product was extracted with dichloromethane (300 ml). The organic extract was evaporated to dryness. The residue was dissolved in 500 ml of toluene, and 1.0 g of TsOH was added. The resulting mixture was refluxed with Dean-Stark head for 1 hour, then cooled to room temperature and washed by 10% Na₂CO₃. The organic layer was separated, dried over K₂CO₃, passed through short column with silica gel 60 (40-63 um). The obtained elute was evaporated to dryness. Distillation of the residue, b.p. 132° C.-135° C./6 mbar, gave 52.6 g (90%) of a colorless oil. HRMS (ESI): [M+Na]⁺ Calcd. for C₁₃H₁₅BrNa⁺: 273.0249; Found: 273.0243. ¹H NMR (400 MHz, CDCl₃): δ 7.29-7.24 (m, 1H), 7.24-7.19 (m, 1H), 7.16-7.09 (m, 1H), 7.58-6.53 (m, 1H), 3.33 (s, 2H), 2.53 (t, J=7.6 Hz, 2H), 1.64 (quin, 7.6 Hz, 2H), 1.49-1.36 (m, 2H), 0.99 (t, J=7.3 Hz, 3H). ¹³C NMR (101 MHz, CDCl₃): δ 151.5, 147.1, 143.0, 128.1, 126.5, 126.0, 118.7, 118.4, 42.6, 31.0, 30.8, 22.5, 13.9.

### 2-Butyl-7-ferrocenyl-1H-indene

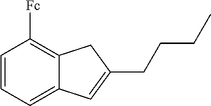

To a mixture of ferrocene (8.19 g, 44.0 mmol) and 0.67 g (6.00 mmol) of potassium tert-butoxide in 160 ml of THF, ^{t}BuLi (1.9 M in pentane, 46.3 ml, 88.0 mmol) was added dropwise for 20 minutes at −78° C. The resulting suspension was warmed to −20° C. and stirred for 1 hour at this temperature. Next, ZnCl₂ (6.54 g, 48.0 mmol) was added at −78° C., and the obtained mixture was warmed to ambient temperature. To the obtained solution of organozinc compound, 7-bromo-2-butyl-1H-indene (10.1 g, 40.0 mmol), Pd₂dba₃ (0.73 g, 0.80 mmol), and tri-tert-butylphosphine (0.65 g, 3.20 mmol) were subsequently added. The reaction mixture was refluxed overnight, cooled to ambient temperature, then poured into water (1000 ml). The crude product was extracted with dichloromethane (3×200 ml). The combined organic extract was passed through thin layer of silica gel 60 (40-63 um). The elute was dried over Na₂SO₄ and then evaporated to dryness. The residue was purified by flash chromatography on silica gel 60 (40-63 um, eluent: hexane-dichloromethane=10:1, vol.). Yield: 11.6 g (81%) as a red solid. HRMS (APPI): [M+H]⁺ Calcd. for C₂₃H₂₅Fe⁺: 357.1300; Found: 357.1302. ¹H NMR (400 MHz, CDCl₃): δ 7.46-7.42 (m, 1H), 7.31-7.26 (m, 1H), 7.25-7.20 (m, 1H), 6.61-6.57 (m, 1H), 4.80-4.75 (m, 2H), 4.41-4.38 (m, 2H) 4.14 (br.s., 5H), 3.51 (s, 2H), 2.59 (t, J=7.6 Hz, 2H), 1.75-1.65 (m, 2H), 1.54-1.43 (m, 2H), 1.03 (t, J=7.3 Hz, 3H). ¹³C NMR (101 MHz, CDCl₃): δ 150.5, 146.1, 139.5, 133.9, 126.5, 126.0, 123.3, 117.9, 85.3, 69.4, 68.3, 67.9, 41.9, 31.2, 30.9, 22.5, 14.0.

### Bis(2-butyl-4-ferrocenyl-1H-inden-1-yl)dimethylsilane

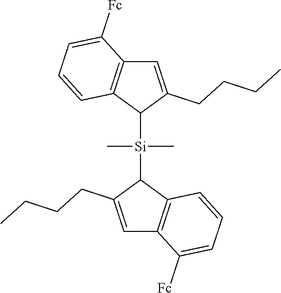

To a solution of 2-butyl-7-ferrocenyl-1H-indene (8.00 g, 22.5 mmol) in 200 ml of diethyl ether, ⁿBuLi (2.5 M in hexanes, 8.98 ml, 22.5 mmol) was slowly added at −30° C. The resulting suspension was stirred overnight at ambient temperature, then the resulting solution was cooled to −78° C., and N-methylimidazole (50 mg) was added. The obtained mixture was stirred for 5 minutes at −78° C., then dichlorodimethylsilane (1.45 g, 11.2 mmol) was added in one portion. This mixture was stirred overnight at ambient temperature, then filtered through a short pad of silica gel 60 (40-63 um) which was additionally washed by dichloromethane (2×30 ml). The combined elute was evaporated to dryness, and the residue was purified by flash chromatography on silica gel 60 (40-63 um, eluent: hexane-dichloromethane=10:1, vol.). Yield: 7.79 g (90%) of the product as an orange foam. According to NMR spectra, this product has two diastereomers. HRMS (ESI): [M]⁺ Calcd. for C₄₈H₅₂Fe₂Si⁺: 768.2532; Found: 768.2536. ¹H NMR (400 MHz, CDCl₃): δ 7.48-7.40 (m, 4H in rac and meso+2H in rac or meso), 7.35-7.29 (m, 4H in rac and meso), 7.25 (br.s, 2H in meso or rac), 7.12 (t, J=7.5, 2H, in rac or meso), 7.11 (t, J=7.5, 2H, in meso or rac), 4.75-4.67 (m, 8H in rac or meso), 4.42-4.36 (m, 8H in meso or rac), 4.18 (s, 10H, in rac or meso), 4.18 (s, 10H, in meso or rac), 3.87 (s, 2H, in rac or meso), 3.86 (s, 2H, in meso or rac), 2.77-2.39 (m, 8H in rac and meso), 1.87-1.58 (m, 8H in rac and meso), 1.54-1.36 (m, 8H in rac and meso), 1.02 (t, J=6.6 Hz, 6H, in rac or meso), 0.99 (t, J=6.6 Hz, 6H, in meso or rac), −0.15 (s, 3H, in meso), −0.15 (s, 6H, in rac), −0.26 (s, 3H, in meso). ¹³C NMR (101 MHz, CDCl₃) for rac and meso: δ 152.1, 151.9, 145.2, 145.0, 142.4, 142.3, 130.6, 130.6, 125.2, 125.2, 125.0, 125.0, 122.6, 121.2, 86.6, 86.6, 77.3, 76.7, 69.3, 68.6, 68.6, 68.3, 68.2, 68.2, 68.2, 46.0, 46.0, 31.6, 31.5, 22.6, 22.6, 14.1, 14.0, −5.2, −5.2, −5.5.

### rac-Dimethylsilanediyl-bis(rf-2-butyl-4-ferrocenylinden-1-yl)zirconium dichloride (Complex 4)

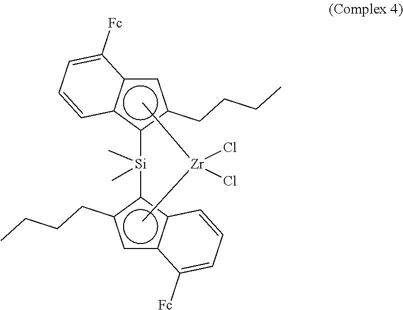

To a cooled to −40° C. solution of bis(2-butyl-4-ferrocenyl-1H-inden-1-yl)dimethylsilane (3.60 g, 4.68 mmol) in 250 ml of diethyl ether ⁿBuLi (2.5 M in hexanes, 3.75 ml, 9.37 mmol) was added in one portion. This mixture was stirred overnight at ambient temperature. The resulting orange suspension was cooled to −78° C., and ZrCl₄(THF)₂ (1.77 g, 4.68 mmol) was added. The reaction mixture was warmed to ambient temperature, stirred for 24 hours, and then evaporated to dryness. The residue was heated with toluene (100 ml), and the formed hot suspension was filtered through a short pad of Celite. The filtrate was evaporated to dryness giving a ca. 1:1 mixture of rac- and meso-complexes. This crude product was recrystallized from toluene yielding 0.73 g (17%) of rac-complex and 0.60 g (14%) of rac-complex contaminated with 5% of meso-complex as dark-red crystalline solids. Rac-complex. Anal. calc. for C₄₈H₅₀Cl₂Fe₂SiZr: C, 62.07; H, 5.43. Found: C, 62.25; H, 5.60. ¹H NMR (400 MHz, CDCl₃): δ 7.59 (d, J=8.7 Hz, 2H), 7.49 (d, J=7.0 Hz, 2H), 7.32 (s, 2H), 7.01 (dd, J=7.1, 8.6 Hz, 2H), 4.81-4.73 (m, 2H), 4.70 (m, 2H), 4.38-4.31 (m, 4H), 4.14 (s, 10H), 2.83-2.73 (m, 2H), 2.49-2.33 (m, 2H), 1.53 (m, 4H), 1.37-1.24 (m, 4H), 1.34 (s, 6H), 0.89 (t, J=7.3 Hz, 6H). ¹³C NMR (101 MHz, CDCl₃): δ 141.0, 137.3, 131.9, 127.9, 125.5, 125.2, 123.0, 121.6, 85.1, 82.7, 70.7, 69.5, 69.3, 68.5, 66.4, 35.1, 32.5, 22.4, 13.9, 3.3.

### Example 5: Preparation of rac-Dimethylsilanediyl-bis(η⁵-2-butyl-4-ferrocenylinden-1-yl)hafnium dichloride (Complex 5)

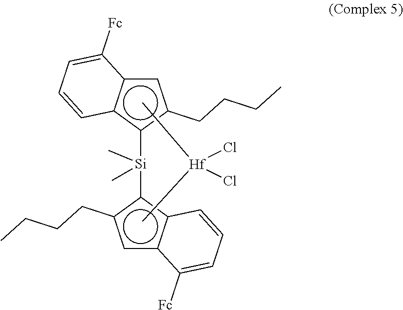

To a −40° C. solution of bis(2-butyl-4-ferrocenyl-1H-inden-1-yl)dimethylsilane (3.70 g, 4.81 mmol) in 200 ml of diethyl ether, ⁿBuLi (2.5 M in hexanes, 3.85 ml, 9.63 mmol) was added in one portion. This mixture was stirred overnight at ambient temperature. The resulting orange suspension was cooled to −78° C., and HfCl₄ (1.54 g, 4.81 mmol) was added. The reaction mixture was stirred for 24 hours at room temperature and then evaporated to dryness. The residue was heated with toluene (100 ml), and the formed hot suspension was filtered through a short pad of Celite. The filtrate was evaporated to dryness giving a ca. 1:1 mixture of rac- and meso-complexes. This crude product was recrystallized from toluene yielding crops of pure rac-complex (0.17 g, 3%) (Cat ID 5A) and rac/meso mixtures (0.06 g, 83% meso, yield 1%; 0.41 g, 84% rac, yield 8%; 1.03 g, 68% meso-complex (Cat ID 5B), yield 21%) as pale-orange crystalline solids. Rac-complex. Anal. calc. for C₄₈H₅₀Cl₂Fe₂HfSi: C, 56.74; H, 4.96. Found: C, 56.93; H, 5.15. ¹H NMR (400 MHz, CDCl₃): δ 7.64 (d, J=8.7 Hz, 2H), 7.47 (d, J=7.0 Hz, 2H), 7.23 (s, 2H), 6.99 (dd, J=7.1, 8.7 Hz, 2H), 4.78-4.73 (m, 2H), 4.71-4.66 (m, 2H), 4.34 (s, 4H), 4.13 (s, 10H), 2.93-2.82 (m, 2H), 2.52-2.41 (m, 2H), 1.57-1.46 (m, 4H), 1.37-1.23 (m, 4H), 1.33 (s, 6H), 0.89 (t, J=7.3 Hz, 6H). ¹³C NMR (101 MHz, CDCl₃) for rac: 3138.3, 136.8, 131.4, 126.3, 125.2, 125.0, 123.0, 119.7, 85.2, 83.7, 70.6, 69.5, 69.2, 68.5, 66.3, 35.4, 32.4, 22.5, 13.9, 3.2. Meso-complex. ¹H NMR (400 MHz, CDCl₃): δ 7.59 (d, J=8.7 Hz, 2H), 7.22 (d, J=6.8 Hz, 2H), 7.06 (s, 2H), 6.72 (dd, J=7.2, 8.6 Hz, 2H), 4.65-4.56 (m, 4H), 4.29 (br. S., 4H), 4.09 (s, 10H), 2.92 (t, J=7.2 Hz, 4H), 1.69-1.53 (m, 4H), 1.46 (s, 3H), 1.41-1.31 (m, 4H), 1.23 (s, 3H), 0.92 (t, J=7.3 Hz, 6H). ¹³C NMR (101 MHz, CDCl₃): δ 140.3, 135.6, 134.2, 126.7, 124.7, 124.2, 124.1, 117.5, 85.3, 85.1, 70.3, 69.5, 68.8, 68.3, 66.7, 35.9, 35.4, 32.8, 22.6, 13.9, 3.5, 3.1.

### Example 6: Preparation of rac-Dimethylsilanediyl-bis(η⁵-6-tert-butyl-4-ferrocenyl-5-methoxy-2-methylinden-1-yl)zirconium dichloride (Complex 6)

### 7-Bromo-5-tert-butyl-6-methoxy-2-methyl-1H-indene

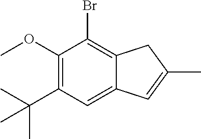

To a solution of 4-bromo-6-(tert-butyl)-5-methoxy-2-methyl-2,3-dihydro-1H-inden-1-one (16.6 g, 53.2 mmol) in 100 ml of THF, NaBH₄ (3.02 g, 79.8 mmol) was added at 5° C. To the resulting suspension 50 ml of methanol was added dropwise at 5° C., and the reaction mixture was stirred at room temperature overnight and then evaporated to dryness. The residue was diluted with 1 L of water, and the crude product was extracted with dichloromethane (3×100 ml). The organic extract was evaporated to dryness. The residue was dissolved in 500 ml of toluene, and 0.06 g of TsOH was added. The resulting mixture was refluxed with Dean-Stark head for 1 hour, then cooled to room temperature and washed by 10% Na₂CO₃. The organic layer was separated, dried over K₂CO₃, passed through short column with silica gel 60 (40-63 um), and thus obtained elute was evaporated to dryness. Yield: 12.5 g (80%) of a colorless oil. HRMS (ESI): [M+Na]⁺ Calcd. for C₁₅H₁₉BrNaO⁺: 317.0511; Found: 317.0516. ¹H NMR (400 MHz, CDCl₃): δ 7.18 (s, 1H), 6.47-6.45 (m, 1H), 3.96 (s, 3H), 3.28 (s, 2H), 2.16 (s, 3H), 1.44 (s, 9H). ¹³C NMR (101 MHz, CDCl₃): δ 153.1, 145.7, 143.3, 143.0, 141.6, 126.9, 117.2, 114.5, 77.3, 76.7, 61.9, 44.8, 35.4, 31.1, 16.6.

### 5-tert-Butyl-7-ferrocenyl-6-methoxy-2-methyl-1H-indene

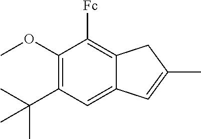

To a mixture of ferrocene (8.00 g, 43.0 mmol) and potassium tert-butoxide (0.58 g, 5.20 mmol) in 400 ml of THF, ^{t}BuLi (1.8 M in pentane, 47.8 ml, 88.0 mmol) was added dropwise for 20 minutes at −78° C. The resulting suspension was warmed to −20° C. and stirred for 1 hour at this temperature. Next, ZnCl₂ (6.45 g, 47.3 mmol) was added at −78° C., and the obtained mixture was warmed to ambient temperature. To the obtained organozinc compound, 7-bromo-5-tert-butyl-6-methoxy-2-methyl-1H-indene (11.5 g, 39.1 mmol), Pd₂dba₃ (0.72 g, 0.78 mmol) and tri(tert-butyl)phosphine (0.63 g, 3.13 mmol) were subsequently added. The reaction mixture was refluxed overnight, cooled to ambient temperature, poured into water (1000 ml), and then the crude product was extracted with dichloromethane (3×200 ml). The combined organic extract was passed through a thin layer of silica gel 60 (40-63 um), dried over Na₂SO₄, and the elute was evaporated to dryness. The residue was purified by flash chromatography on silica gel 60 (40-63 um, eluent: hexane-dichloromethane=10:1, vol.). Yield: 10.0 g (64%) as a red solid. HRMS (APPI): [M+H]⁺ Calcd. for C₂₅H₂₉FeO⁺: 401.1562; Found: 401.1563. ¹H NMR (400 MHz, CDCl₃): δ 7.21 (s, 1H), 6.53-6.44 (m, 1H), 4.93 (br. s., 2H), 4.42-4.39 (m, 2H), 4.12 (s, 5H), 3.72 (s, 2H), 3.34 (s, 3H), 2.27 (s, 3H), 1.50 (s, 9H). ¹³C NMR (101 MHz, CDCl₃): δ 155.9, 144.2, 141.1, 141.0, 140.6, 127.1, 126.7, 116.5, 83.2, 69.8, 69.2, 67.5, 60.8, 44.4, 35.1, 31.1, 16.7.

### Bis(6-tert-butyl-4-ferrocenyl-5-methoxy-2-methyl-1H-inden-1-yl)dimethylsilane

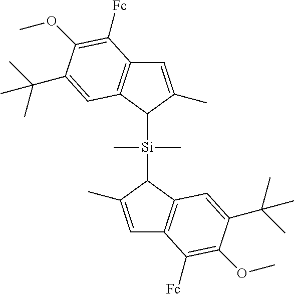

To a solution of 5-tert-butyl-7-ferrocenyl-6-methoxy-2-methyl-1H-indene (7.00 g, 17.5 mmol) in 200 ml of diethyl ether, ⁿBuLi (2.5 M in hexanes, 6.99 ml, 17.5 mmol) was slowly added at −30° C. The formed suspension was stirred overnight at ambient temperature, then cooled to −78° C., and 50 mg of N-methylimidazole was added. The obtained mixture was stirred for 5 minutes at −78° C. followed by addition of dichlorodimethylsilane (1.13 g, 8.74 mmol) in one portion. The obtained mixture was stirred overnight at ambient temperature, then filtered through a short pad of silica gel 60 (40-63 um) which was additionally washed by dichloromethane (2×30 ml). The combined filtrate was evaporated to dryness, and the residue was purified by flash chromatography on silica gel 60 (40-63 um, eluent: hexane-dichloromethane=10:1, vol.). Yield: 4.23 g (56%) of the title product as an orange foam. According to NMR spectra the product is a ca. 1:3 mixture of two diastereomers. HRMS (ESI): [M]⁺ Calcd. for C₅₂H₆₀Fe₂O₂Si⁺: 856.3056; Found: 856.3052. ¹H NMR (400 MHz, CDCl₃): δ 7.61 (s, 4H in rac and meso), 7.46 (s, 2H in rac), 7.33 (s, 2H in meso), 4.79-4.68 (m, 8H in rac or meso), 4.41-4.36 (m, 8H in meso or rac), 4.20 (s, 10H in rac), 4.19 (s, 10H in meso), 3.73 (s, 2H in rac), 3.67 (s, 2H in meso), 3.26 (s, 6H in rac), 3.25 (s, 6H in meso), 2.37 (s, 6H in rac), 2.35 (s, 6H in meso), 1.45 (s, 18H in meso), 1.44 (s, 18H in rac), −0.09 (s, 3H in meso), −0.10 (s, 3H in meso), −0.16 (s, 6H in rac). ¹³C NMR (101 MHz, CDCl₃): δ 156.9, 146.1, 143.1, 139.7, 139.7, 137.4, 137.3, 128.0, 127.9, 123.0, 123.0, 120.1, 120.0, 83.7, 83.7, 70.8, 70.7, 69.3, 67.5, 67.3, 60.5, 46.6, 35.1, 31.4, 31.4, 18.4, 18.2, −5.0, −5.2, −5.7.

### rac-Dimethylsilanediyl-bis(rf-6-tert-butyl-4-ferrocenyl-5-methoxy-2-methylinden-1-yl)zirconium dichloride (Complex 6)

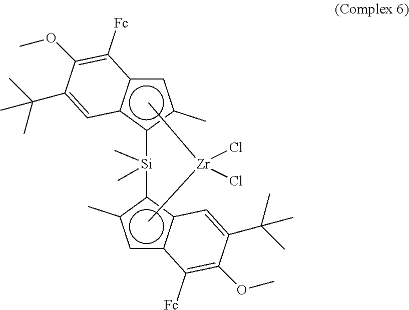

To a cooled to −40° C. solution of bis(6-tert-butyl-4-ferrocenyl-5-methoxy-2-methyl-1H-inden-1-yl)dimethylsilane (2.00 g, 2.33 mmol) in 250 ml of diethyl ether, ⁿBuLi (2.5 M in hexanes, 1.87 ml, 4.67 mmol) was added in one portion. This mixture was stirred overnight at ambient temperature. The resulting orange suspension was cooled to −78° C., and ZrCl₄(THF)₂ (0.88 g, 2.33 mmol) was added. The reaction mixture was warmed to ambient temperature, stirred for 24 hours at this temperature, and then evaporated to dryness. The residue was triturated with 50 ml of toluene, and the formed hot suspension was filtered through a short pad of Celite. The filtrate was evaporated to dryness giving a ca. 2:1 mixture of rac- and meso-complexes. This crude product was recrystallized from toluene to yield pure rac-complex (0.40 g, 17%) as a dark-red crystalline solid. Anal. calc. for C₅₂H₅₈Cl₂Fe₂O₂SiZr: C, 61.42; H, 5.75. Found: C, 61.65; H, 8.82. ¹H NMR (400 MHz, CDCl₃) for rac: 37.58 (s, 2H), 7.49 (s, 2H), 4.87 (br. s., 2H), 4.71 (br. s., 2H), 4.34 (br. s., 2H), 4.31 (br. s., 2H), 4.03 (s, 10H), 3.45 (s, 6H), 2.28 (s, 6H), 1.40 (s, 18H), 1.34 (s, 6H). ¹³C NMR (101 MHz, CDCl₃) for rac: δ 161.0, 144.2, 134.3, 132.2, 124.9, 123.7, 123.2, 119.9, 82.1, 81.4, 71.8, 69.4, 69.3, 68.7, 67.5, 63.0, 35.7, 30.5, 18.6, 2.4.

### Example 7: Preparation of rac-Dimethylsilanediyl-bis(η⁵-6-tert-butyl-4-ferrocenyl-5-methoxy-2-methyl-1H-inden-1-yl)hafnium dichloride (Complex 7)

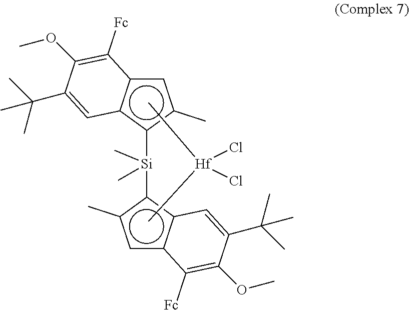

To a cooled to −40° C. solution of bis(6-tert-butyl-4-ferrocenyl-5-methoxy-2-methyl-1H-inden-1-yl)dimethylsilane (1.84 g, 2.15 mmol) in 200 ml of diethyl ether, ⁿBuLi (2.5 M in hexanes, 1.72 ml, 4.30 mmol) was added in one portion. This mixture was stirred overnight at ambient temperature. To the resulting orange suspension cooled to −78° C., HfCl₄ (0.69 g, 2.15 mmol) was added. This mixture was stirred for 24 hours and then evaporated to dryness. The residue was triturated with 50 ml of toluene, and the formed hot suspension was filtered through a short pad of Celite. The filtrate was evaporated to dryness giving a ca. 2:1 mixture of rac- and meso-complexes. This crude product was recrystallized from toluene yielding pure rac-complex (0.21 g, 9%) as a pale-orange crystalline solid. Anal. calc. for C₅₂H₅₈C₁₂Fe₂HfO₂: C, 56.56; H, 5.29. Found: C, 56.77; H, 5.40. ¹H NMR (400 MHz, CDCl₃): δ 7.54 (s, 2H), 7.47 (s, 2H), 4.88 (br. s., 2H), 4.68 (br. s., 2H), 4.34 (br. s., 2H), 4.31 (br. s., 2H), 4.03 (s, 10H), 3.44 (s, 6H), 2.36 (s, 6H), 1.41 (s, 18H), 1.33 (s, 6H). ¹³C NMR (101 MHz, CDCl₃): δ 161.0, 144.2, 134.3, 132.2, 124.9, 123.7, 123.2, 119.9, 82.1, 81.4, 71.8, 69.4, 69.3, 68.7, 67.5, 63.0, 35.7, 30.5, 18.6, 2.4.

### Example 8: Preparation of rac-Dimethylsilanediyl-bis(η⁵-4-ferrocenyl-2,6,6-trimethyl-1,5,6,7-tetrahydro-s-indacen-1-yl)zirconium dichloride (Complex 8)

### 4-Bromo-2,6,6-trimethyl-3,5,6,7-tetrahydro-s-indacen-1(2H)-one

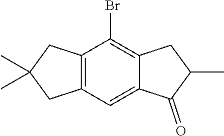

To a suspension of AlCl₃ (21.8 g, 164 mmol) in 200 ml of dichloromethane, a solution of 2,6,6-trimethyl-3,5,6,7-tetrahydro-s-indacen-1(2H)-one (14.0 g, 65.5 mmol) in 50 ml of dichloromethane was added dropwise at 0° C. Next, a solution of bromine (3.3 ml, 10.5 g, 65.5 mmol) in 20 ml of dichloromethane was added dropwise for 1 hour at 0° C. The resulting mixture was poured into a cooled to 0° C. solution of HCl (1 M, 500 ml), and the crude product was extracted with dichloromethane (3×100 ml). The combined organic extract was dried over Na₂SO₄ and evaporated to dryness. The residue was recrystallized from hexane at −20° C. to yield 13.4 g (69%) of the title product as a yellowish solid. HRMS (ESI): [M+Na]⁺ Calcd. for C₁₅H₁₇BrNaO⁺: 315.0355; Found: 315.0352. ¹H NMR (400 MHz, CDCl₃): δ 7.43 (s, 1H), 3.25 (dd, J=7.8 Hz, 17.4 Hz, 1H), 2.82 (s, 2H), 2.78 (s, 2H), 2.76-2.66 (m, 1H), 2.56 (dd, J=3.3 Hz, 17.4 Hz, 1H), 1.29 (d, J=7.6 Hz, 3H), 1.15 (s, 6H). ¹³C NMR (101 MHz, CDCl₃): δ 208.2, 151.9, 151.8, 145.1, 137.1, 119.1, 118.4, 48.8, 47.9, 42.3, 39.9, 35.6, 28.5, 16.3.

### 4-Bromo-2,2,6-trimethyl-1,2,3,5-tetrahydro-s-indacene

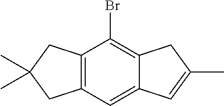

To a solution of 4-bromo-2,6,6-trimethyl-3,5,6,7-tetrahydro-s-indacen-1(2H)-one (10.6 g, 36.0 mmol) in 100 ml of THF, NaBH₄ (2.00 g, 54.0 mmol) was added at 5° C. To the resulting suspension 50 ml of methanol was added dropwise at 5° C. The reaction mixture was stirred overnight at room temperature, then evaporated to dryness, and the residue was diluted with 1 L of water. The substituted alcohol was extracted with dichloromethane (2×100 ml). The organic extract was evaporated to dryness. The residue was dissolved in 500 ml of toluene, 0.05 g of TsOH was added. Thus obtained mixture was refluxed with Dean-Stark head for 1 hour, then cooled to room temperature, and washed by 10% Na₂CO₃. The organic layer was separated, dried over K₂CO₃, passed through short column with silica gel 60 (40-63 um), and the obtained elute was evaporated to dryness. The residue was distilled at 110° C./1 mbar using a Kugelrohr apparatus. Yield: 8.1 g (81%) of a yellowish solid. HRMS (ESI): [M+Na]⁺ Calcd. for C₁₅H₁₇BrNa⁺: 299.0406; Found: 299.0401. ¹H NMR (400 MHz, CDCl₃): δ 6.98 (s, 1H), 6.50-6.41 (m, 1H), 3.26-3.21 (m, 2H), 2.82 (s, 2H), 2.78 (s, 2H), 2.15 (s, 3H), 1.18 (s, 6H). ¹³C NMR (101 MHz, CDCl₃): δ 145.7, 145.5, 143.3, 141.2, 138.7, 127.1, 116.3, 115.2, 48.7, 48.3, 43.8, 39.6, 28.9, 16.7.

### 4-Ferrocenyl-2,2,6-trimethyl-1,2,3,5-tetrahydro-s-indacene

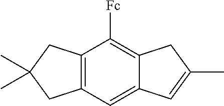

To a mixture of ferrocene (10.0 g, 53.8 mmol) and potassium tert-butoxide (0.72 g, 6.45 mmol) in 500 ml of THF, ^{t}BuLi (1.9 M in pentane, 56.6 ml, 108 mmol) was added dropwise for 20 minutes at −78° C. The resulting suspension was warmed to −20° C. and stirred at this temperature for 1 hour. Further on, ZnCl₂ (8.06 g, 59.1 mmol) was added at −78° C., and the formed mixture was warmed to ambient temperature. To the obtained organozine compound, 4-bromo-2,2,6-trimethyl-1,2,3,5-tetrahydro-s-indacene (13.6 g, 48.9 mmol), Pd₂dba₃ (0.90 g, 0.98 mmol) and tri(tert-butyl)phosphine (0.79 g, 3.91 mmol) were subsequently added. The reaction mixture was refluxed overnight, cooled to ambient temperature, poured into water (1000 ml), and the crude product was extracted with dichloromethane (3×200 ml). The combined organic extract was passed through thin layer of silica gel 60 (40-63 um), the elute was dried over Na₂SO₄ and then evaporated to dryness. The residue was purified by flash chromatography on silica gel 60 (40-63 um, eluent: hexane-dichloromethane=10:1, vol.). Yield: 15.2 g (81%) as a red solid. HRMS (APPI): [M+H]⁺ Calcd. for C₂₅H₂₇Fe⁺: 383.1457; Found: 383.1452. ¹H NMR (400 MHz, CDCl₃): δ 7.07 (s, 1H), 6.59-6.43 (m, 1H), 4.75 (t, J=1.8 Hz, 2H), 4.46-4.32 (m, 2H), 4.17 (s, 5H), 3.53 (s, 2H), 3.14 (s, 2H), 2.82 (s, 2H), 2.23 (s, 3H), 1.27 (s, 6H). ¹³C NMR (101 MHz, CDCl₃): δ 145.1, 144.6, 142.8, 138.8, 137.0, 130.4, 126.9, 114.8, 85.2, 69.1, 69.0, 67.7, 49.1, 47.5, 44.4, 40.0, 28.9, 16.7.

### Bis(4-ferrocenyl-2,6,6-trimethyl-1,5,6,7-tetrahydro-s-indacen-1-yl)dimethylsilane

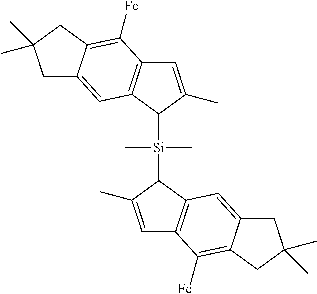

To a solution of 4-ferrocenyl-2,2,6-trimethyl-1,2,3,5-tetrahydro-s-indacene (10.0 g, 26.2 mmol) in 300 ml of diethyl ether, ⁿBuLi (2.5 M in hexanes, 10.5 ml, 26.2 mmol) was slowly added at −30° C. The resulting suspension was stirred overnight at ambient temperature, then cooled to −78° C., and 50 ml of N-methylimidazole was added. The obtained mixture was stirred for 5 minutes at −78° C., then dichlorodimethylsilane (1.69 g, 13.1 mmol) was added in one portion. Further on, this mixture was stirred overnight at ambient temperature and then filtered through a short pad of silica gel 60 (40-63 um) which was additionally washed by dichloromethane (2×30 ml). The combined filtrate was evaporated to dryness, and the residue was purified by flash chromatography on silica gel 60 (40-63 um, eluent: hexane-dichloromethane=10:1, vol.). Yield: 4.63 g (43%) of the title product as a red solid. According to NMR spectra, the product is a ca. 1.1 to 1 mixture of two diastereomers in favor of rac-compound. HRMS (ESI): [M]⁺ Calcd. for C₅₂H₅₆Fe₂Si⁺: 820.2845; Found: 820.2847. ¹H NMR (400 MHz, CDCl₃): δ 7.51 (br. s., 4H in rac and meso), 7.24 (s, 2H in rac), 7.17 (s, 2H in meso), 4.71-4.63 (m, 8H in rac or meso), 4.39 (br. s., 8H in meso or rac), 4.20 (s, 10H, in rac or meso), 4.20 (s, 10H, in meso or rac), 3.77 (s, 2H in meso), 3.75 (s, 2H in rac), 3.06-2.69 (m, 16H in rac and meso), 2.37 (s, 6H in meso), 2.33 (s, 6H in rac), 1.26 (s, 6H in rac), 1.24 (s, 6H in meso), 1.14 (s, 6H in rac), 1.13 (s, 6H in meso), −0.09 (s, 3H in meso), −0.13 (s, 6H in rac), −0.14 (s, 3H in meso). ¹³C NMR (101 MHz, CDCl₃) for rac and meso: δ 144.8, 144.6, 144.1, 141.5, 141.5, 139.0, 138.9, 138.7, 127.8, 127.7, 126.5, 118.3, 118.3, 85.8, 85.8, 70.2, 70.1, 69.5, 69.4, 69.2, 67.6, 67.6, 67.4, 67.3, 48.8, 48.7, 47.9, 47.8, 46.6, 46.5, 40.1, 40.1, 29.0, 28.9, 28.9, 28.8, 18.3, −5.4, −5.4, −5.4.

### rac-Dimethylsilanediyl-bis(η⁵-4-ferrocenyl-2,6,6-trimethyl-1,5,6,7-tetrahydro-s-indacen-1-yl)zirconium dichloride (Complex 8)

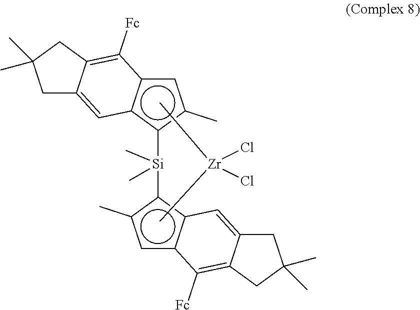

To a cooled to −40° C. solution of bis(4-ferrocenyl-2,6,6-trimethyl-1,5,6,7-tetrahydro-s-indacen-1-yl)dimethylsilane (3.00 g, 3.66 mmol) in 250 ml of diethyl ether, ⁿBuLi (2.5 M in hexanes, 2.92 ml, 7.31 mmol) was added in one portion. This mixture was stirred overnight at ambient temperature. The resulting orange solution was cooled to −78° C., and ZrCl₄(THF)₂ (1.38 g, 3.66 mmol) was added. The obtained mixture was warmed to ambient temperature, stirred for 24 hours at this temperature, and evaporated to dryness. The residue was heated with 50 ml of toluene, and the formed hot suspension was filtered through a short pad of Celite. The filtrate was evaporated to dryness giving a ca. 1:1 mixture of rac- and meso-complexes. This crude product was recrystallized from toluene yielding pure rac-complex (0.35 g, 10%) (Cat ID 8A) and one more crop of pure meso-complex (0.09 g, 3%) (Cat ID 8B), both as dark-red crystalline solids. Rac-complex. Anal. calc. for C₅₂H₅₄Cl₂Fe₂SiZr: C, 63.67; H, 5.55. Found: C, 63.82; H, 5.68. ¹H NMR (400 MHz, CDCl₃): δ 7.46 (s, 2H), 7.36 (s, 2H), 4.77 (br. s., 4H), 4.36 (br. s., 2H), 4.30 (br. s., 2H), 4.14 (s, 10H), 3.18-3.03 (m, 2H), 3.02-2.90 (m, 2H), 2.91-2.80 (m, 2H), 2.56 (m, 2H), 2.29 (s, 6H), 1.32 (br. s., 12H), 1.10 (s, 6H). ¹³C NMR (101 MHz, CDCl₃): δ 144.3, 141.6, 133.3, 132.0, 130.6, 127.8, 124.0, 117.3, 84.1, 81.8, 77.3, 76.7, 71.5, 69.3, 68.7, 68.0, 67.8, 48.0, 47.7, 40.3, 28.8, 28.3, 18.5, 2.8. Meso-complex. Anal. calc. for C₅₂H₅₄Cl₂Fe₂SiZr: C, 63.67; H, 5.55. Found: C, 63.85; H, 5.62. ¹H NMR (400 MHz, CDCl₃) for meso-: 37.29 (s, 2H), 7.22 (s, 2H), 4.67 (br. s., 2H), 4.59 (br. s., 2H), 4.34 (br. s., 2H), 4.29 (br. s., 2H), 4.13 (s, 10H), 2.97-2.81 (m, 4H), 2.73-2.43 (m, 4H), 2.46 (s, 6H), 1.42 (s, 3H), 1.21 (s, 3H), 1.16 (s, 6H), 0.98 (s, 6H).

### Example 9: Preparation of rac-Dimethylsilanediyl-bis(rf-4-ferrocenyl-2,6,6-trimethyl-1,5,6,7-tetrahydro-s-indacen-1-yl)hafnium dichloride (Complex 9)

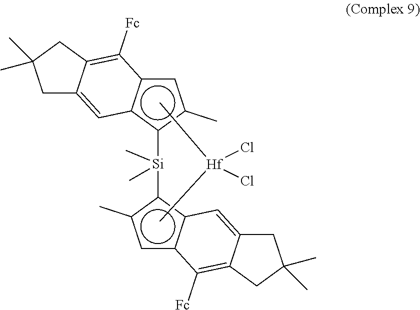

To a cooled to −40° C. solution of bis(6-tert-butyl-4-ferrocenyl-5-methoxy-2-methyl-1H-inden-1-yl)dimethylsilane (3.42 g, 4.17 mmol) in 200 ml of diethyl ether, ⁿBuLi (2.5 M in hexanes, 3.33 ml, 8.33 mmol) was added in one portion. This mixture was stirred overnight at ambient temperature. The resulting orange solution was cooled to −78° C., and HfCl₄ (1.34 g, 4.17 mmol) was added. The reaction mixture was stirred for 24 hours at ambient temperature, then evaporated to dryness. The residue was heated with 50 ml of toluene, and the formed hot suspension was filtered through a short pad of Celite. The filtrate was evaporated to dryness giving a ca. 2:1 mixture of rac- and meso-complexes. This crude product was recrystallized from toluene yielding pure rac-complex (0.59 g, 13%) as a pale-orange crystalline solid. Anal. calc. for C₅₂H₅₄Cl₂Fe₂HfSi: C, 58.47; H, 5.10. Found: C, 58.63; H, 5.26. ¹H NMR (400 MHz, CDCl₃): δ 7.39 (s, 2H), 7.35 (s, 2H), 4.74 (br. s., 4H), 4.35 (br. s., 2H), 4.28 (br. s., 2H), 4.12 (s, 10H), 3.15-2.94 (m, 4H), 2.93-2.54 (m, 4H), 2.37 (s, 6H), 1.32 (s, 6H), 1.31 (s, 6H), 1.08 (s, 6H). ¹³C NMR (101 MHz, CDCl₃): δ 144.0, 141.5, 131.4, 130.6, 130.1, 126.1, 122.1, 117.3, 84.2, 82.9, 71.4, 69.3, 68.7, 68.0, 67.7, 48.0, 47.6, 40.4, 28.7, 28.3, 18.4, 2.8.

### Example 10: Preparation of (Dimethylsilanediyl)(η⁵-2-butyl-4-ferrocenylinden-1-yl)(1′-tert-butylamido)dimethyltitanium (Complex 10)

### (2-Butyl-4-ferrocenyl-1H-inden-1-yl)chlorodimethylsilane

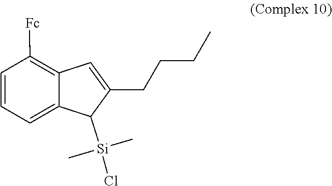

To a solution of 2-butyl-7-ferrocenyl-1H-indene (3.41 g, 9.57 mmol) in 70 ml of THF, ⁿBuLi (2.5 M in hexanes, 3.83 ml, 9.57 mmol) was added at −78° C. The resulting mixture was warmed to ambient temperature and stirred for 1 hour at this temperature. Next, this mixture was cooled to −78° C., and dichlorodimethylsilane (6.17 g, 47.9 mmol) was added in one portion. The obtained solution was stirred overnight at room temperature, then evaporated to dryness, the residue was dissolved in hot toluene, and the obtained mixture was filtered through a short pad of Celite. The filtrate was evaporated to dryness to yield 3.90 g (91%) of the title product as a dark-brown viscous oil which was further used without additional purification.

¹H NMR (400 MHz, CDCl₃): δ 7.41 (d, J=7.6 Hz, 1H), 7.37 (d, J=7.5 Hz, 1H), 7.26 (s, 1H), 7.09 (t, J=7.6 Hz, 1H), 4.68 (br. s., 2H), 4.37 (s, 2H), 4.14 (s, 5H), 3.73 (s, 1H), 2.81-2.60 (m, 2H), 1.85-1.59 (m, 2H), 1.53-1.36 (m, 2H), 1.00 (t, J=7.3 Hz, 3H), 0.45 (s, 3H), 0.18 (s, 3H). ¹³C NMR (101 MHz, CDCl₃): δ 150.7, 142.8, 142.3, 130.8, 125.8, 125.8, 122.9, 121.6, 86.5, 77.3, 76.7, 69.4, 68.5, 68.4, 68.4, 68.3, 48.5, 31.5, 31.3, 22.6, 14.0, 1.2, −0.6.

### (N-tert-Butylamide)(2-butyl-4-ferrocenyl-1H-inden-1-yl)dimethylsilane (A) and (N-tert-butylamide)(2-butyl-7-ferrocenyl-1H-inden-3-yl)dimethylsilane (B)

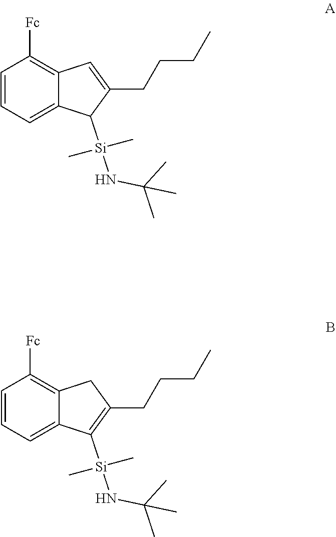

To a solution of tert-butylamine (0.16 g, 2.23 mmol) in 15 ml of diethyl ether, ⁿBuLi (2.5 M in hexanes, 0.89 ml, 2.23 mmol) was slowly added at −30° C. and stirred for 2 hours at this temperature. Then, a solution of (2-butyl-4-ferrocenyl-1H-inden-1-yl)chlorodimethylsilane (1.00 g, 2.23 mmol) in 10 ml of diethyl ether was added dropwise at −30° C. The resulting mixture was stirred for 12 hours, then evaporated to dryness. The residue was dissolved in hot toluene, and the obtained suspension was filtered through a short pad of Celite. The filtrate was evaporated to dryness to give 0.95 g (88%) of the target material as a ca. 3:1 mixture of isomers A and B as a dark-red viscous oil which was further used without additional purification. HRMS (ESI): [M+H]⁺ Calcd. for C₂₉H₄₀FeNSi⁺: 486.2274; Found: 486.2271. ¹H NMR (400 MHz, CDCl₃): δ 7.64 (dd, J=0.9, 7.6 Hz, 1H in B), 7.44 (dd, J=0.9, 7.7 Hz, 1H in B), 7.39 (t, J=6.8 Hz, 1H in A), 7.32-7.26 (m, 1H in B), 7.22 (s, 1H in A), 7.08 (t, J=7.6 Hz, 1H in A), 4.77-4.69 (m, 4H in A or B), 4.40-4.35 (m, 4H in A or B), 4.17 (s, 5H in A), 4.15 (s, 5H in B), 3.57 (s, 2H in B), 3.56 (s, 2H in A), 2.85-2.55 (m, 4H in A and B), 1.85-1.61 (m, 4H and B), 1.57-1.41 (m, 4H in A and B), 1.24 (s, 9H in A), 1.24 (s, 9H in B), 1.04 (t, J=7.4 Hz, 3H in A), 1.03 (t, J=7.3 Hz, 3H in B), 0.86 (br. s, 1H in B), 0.65 (br. s, 1H in A), 0.56 (s, 6H in B), 0.20 (s, 3H in A), 0.04 (s, 3H in A). ¹³C NMR (101 MHz, CDCl₃) for A and B: δ 160.8, 153.0, 150.4, 145.5, 142.2, 140.0, 136.1, 133.5, 130.0, 126.1, 124.6, 123.7, 123.2, 122.0, 121.3, 120.4, 86.9, 86.0, 69.4, 69.3, 68.4, 68.2, 68.1, 68.1, 49.8, 49.5, 44.3, 33.7, 33.6, 33.2, 31.7, 31.6, 23.1, 22.7, 14.1, 14.1, 4.1, 0.9, −0.4.

### (Dimethylsilanediyl)(η⁵-2-butyl-4-ferrocenylinden-1-yl)(κ¹-tert-butylamido)dimethyltitanium (Complex 10)

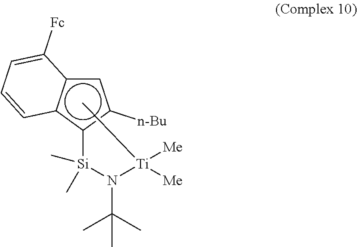

To a solution of the above mixture of (N-tert-butylamide)(2-butyl-4-ferrocenyl-1H-inden-1-yl)dimethylsilane and (N-tert-butylamide)(2-butyl-7-ferrocenyl-1H-inden-3-yl)dimethylsilane (0.81 g, 1.67 mmol) in 20 ml of diethyl ether, MeLi (1.6 M in diethyl ether, 5.20 ml, 8.34 mmol) was added dropwise at 0° C. The resulting mixture was stirred for 2 hours at ambient temperature. Then, a solution of TiCl₄ (0.18 ml, 0.32 g, 1.67 mmol) in 2 ml of hexane was added in one portion. The obtained mixture was stirred overnight and then evaporated to dryness. To the residue MeMgBr (2.9 M in diethyl ether, 1.72 ml, 5.00 mmol) and 100 ml of hexane were added. Thus obtained mixture was stirred overnight at ambient temperature, then filtered through a short pad of Celite, and the obtained filtrate was evaporated to dryness. The crude product was recrystallized from pentane at −30° C. Yield: 0.45 g (48%) of a dark-brown solid. Anal. calc. for C₃₁H₄₃FeNSiTi: C, 66.31; H, 7.72; N, 2.49. Found: C, 66,18; H, 7.73; N, 2.63. ¹H NMR (400 MHz, CDCl₃): δ 7.59 (s, 1H), 7.42 (d, J=7.5 Hz, 2H), 7.08-7.00 (m, 1H), 4.82-4.77 (m, 1H), 4.76-4.71 (m, 1H), 4.45-4.38 (m, 2H), 4.20 (s, 5H), 2.59-2.50 (m, 1H), 2.43 (dd, J=7.1, 15.3 Hz, 1H), 1.75-1.63 (m, 3H), 1.57-1.50 (m, 9H), 1.47-1.37 (m, 3H), 0.94 (t, J=7.3 Hz, 4H), 0.72 (s, 3H), 0.64 (s, 3H), 0.63 (s, 3H), −0.44 (s, 3H). ¹³C NMR (101 MHz, CDCl₃): δ 146.9, 136.2, 135.1, 129.5, 125.0, 124.8, 123.9, 115.0, 88.2, 85.7, 69.6, 69.5, 69.5, 69.5, 69.4, 69.4, 69.4, 68.9, 68.4, 66.6, 58.1, 56.6, 50.9, 34.2, 34.0, 32.3, 22.6, 14.0, 6.3, 5.6.

### Example 11: Preparation of (Dimethylsilanediyl)(rf-6-tert-butyl-4-ferrocenyl-5-methoxy-2-methyl-1H-inden-1-yl)-(κ¹-tert-butylamido)dimethyltitanium (Complex 11)

### (6-tert-Butyl-4-ferrocenyl-5-methoxy-2-methyl-1H-inden-1-yl)chlorodimethylsilane

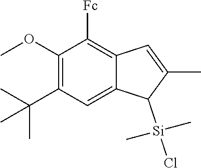

To a solution of 5-(tert-butyl)-7-(ferrocen-1-yl)-6-methoxy-2-methyl-1H-indene (2.50 g, 6.24 mmol) in 70 ml of THF, ⁿBuLi (2.5 M in hexanes, 2.50 ml, 6.24 mmol) was added at −78° C. The resulting mixture was warmed to ambient temperature, stirred for 1 hour at this temperature, then cooled to −78° C., then dichlorodimethylsilane (4.03 g, 31.2 mmol) was added in one portion. The obtained solution was stirred overnight at room temperature, then evaporated to dryness. The residue was dissolved in 50 ml of hot toluene, and thus obtained suspension was filtered through a short pad of Celite. The filtrate was evaporated to dryness to give 2.64 g (86%) of a dark-brown viscous oil which was further used without additional purification. ¹H NMR (400 MHz, CDCl₃): δ 7.62 (s, 1H), 7.46 (s, 1H), 4.94 (br. s., 1H), 4.87 (br. s., 1H), 4.60-4.45 (m, 2H), 4.30 (s, 5H), 3.64 (s, 1H), 3.40 (s, 3H), 2.49 (s., 3H), 1.60 (s, 9H), 0.62 (s, 3H), 0.37 (s, 3H). ¹³C NMR (101 MHz, CDCl₃): δ 157.1, 144.3, 143.0, 137.4, 136.9, 128.3, 123.0, 120.2, 83.7, 70.8, 70.6, 69.5, 67.7, 67.6, 60.3, 49.1, 34.9, 31.1, 17.8, 1.3, −0.5.

### N-tert-Butyl-1-(6/5-tert-butyl-4/7-ferrocenyl-5/6-methoxy-2-methyl-1H-inden-1/3-yl)-dimethylsilanamine (A/B)

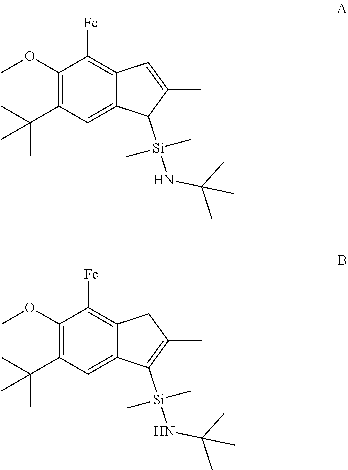

To a solution of tert-butylamine (0.35 g, 4.79 mmol) in 30 ml of diethyl ether, ⁿBuLi (2.5 M in hexanes, 1.92 ml, 4.79 mmol) was slowly added at −30° C., and the obtained mixture was stirred for 2 hours at this temperature. A solution of (6-tert-butyl-4-ferrocenyl-5-methoxy-2-methyl-1H-inden-1-yl)chlorodimethylsilane (2.36 g, 4.79 mmol) in 20 ml of diethyl ether was added dropwise at −30° C. The resulting mixture was stirred for 12 hours at ambient temperature, then evaporated to dryness. The residue was dissolved in 50 ml of hot toluene, and the obtained suspension was filtered through a short pad of Celite. The filtrate was evaporated to dryness to give 2.60 g (99%) of the title material (a ca. 2.3 to 1 mixture of isomers A and B) as a dark-red viscous oil which was further used without additional purification. HRMS (ESI): [M+H]⁺ Calcd. for C₃₁H₄₄FeNOSi⁺: 530.2536; Found: 530.2531. ¹H NMR (400 MHz, CDCl₃): δ 7.58 (s, 1H in B), 7.47 (s, 1H in A), 7.31 (s, 1H in A), 4.78-4.66 (m, 4H in A or B), 4.41-4.29 (m, 4H in A or B), 4.15 (s, 5H in A), 4.14 (s, 5H in B), 4.09 (s, 2H in B), 3.33 (s, 1H in A), 3.23 (s, 3H in B), 3.21 (s, 3H in A), 2.36 (s, 3H in B), 2.34 (s, 3H in A), 1.44 (s, 9H in A), 1.44 (s, 9H in B), 1.22 (s, 9H in A), 1.22 (s, 9H in B), 0.64 (br. s., 1H in A), 0.50 (s, 3H in B), 0.25 (s, 3H in B), 0.18 (s, 3H in A), 0.03 (s, 3H in A). ¹³C NMR (101 MHz, CDCl₃): δ 157.3, 156.5, 147.0, 144.6, 144.3, 143.2, 142.9, 140.0, 137.7, 137.2, 136.6, 128.4, 126.6, 123.1, 122.3, 120.4, 120.0, 84.0, 70.8, 70.7, 70.6, 69.3, 69.3, 69.2, 69.1, 67.5, 67.4, 67.3, 67.2, 60.5, 50.3, 49.6, 49.3, 35.1, 33.8, 31.4, 31.3, 18.4, 17.9, 1.4, 1.2, −0.3, −0.3.

### (Dimethylsilanediyl)(η⁵-6-tert-butyl-4-ferrocenyl-5-methoxy-2-methyl-1H-inden-1-yl)-(κ¹-tert-butylamido)dimethyltitanium (Complex 11)

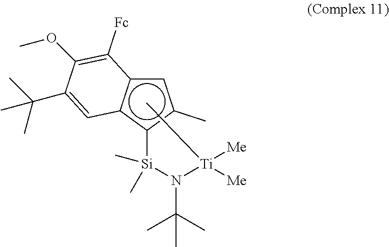

To a solution of the above-obtained N-tert-butyl-1-(6/5-tert-butyl-4/7-ferrocenyl-5/6-methoxy-2-methyl-1H-inden-1/3-yl)dimethylsilanamine (2.43 g, 4.59 mmol) in 50 ml of diethyl ether, MeLi (1.6 M in diethyl ether, 14.3 ml, 22.9 mmol) was added dropwise at 0° C. The resulting mixture was stirred for 2 hours at ambient temperature. Then, a solution of TiCl₄ (0.50 ml, 0.87 g, 4.59 mmol) in 5 ml of hexane was added in one portion. The obtained mixture was stirred overnight at ambient temperature and then evaporated to dryness. To the residue, MeMgBr (2.9 M in diethyl ether, 4.75 ml, 13.8 mmol) and 100 ml of hexane were added. Thus obtained mixture was stirred overnight at ambient temperature, then filtered through a short pad of Celite, and the filtrate was evaporated to dryness. The crude product was recrystallized from pentane at −30° C. Yield: 0.25 g (9%) of a dark-brown solid. Anal. calc. for C₃₃H₄₇FeNOSiTi: C, 65.46; H, 7.82; N, 2.31. Found: C, 65.69; H, 8.00; N, 2.13. ¹H NMR (400 MHz, CD₂Cl₂). 37.82 (s, 1H), 7.34 (s, 1H), 4.95 (td, J=1.3, 2.5 Hz, 1H), 4.65 (td, J=1.2, 2.4 Hz, 1H), 4.47 (dt, J=1.3, 2.4 Hz, 1H), 4.41 (dt, J=1.2, 2.4 Hz, 1H), 4.22-4.16 (m, 5H), 3.22 (s, 3H), 2.22 (s, 3H), 1.51 (s, 9H), 1.35 (s, 9H), 0.68 (s, 3H), 0.61 (s, 3H), 0.60 (s, 3H), −0.55 (s, 3H). ¹³C NMR (101 MHz, CD₂Cl₂): δ 159.3, 144.0, 141.7, 131.7, 131.3, 125.0, 123.1, 117.4, 89.3, 83.4, 71.1, 70.5, 70.0, 68.8, 68.3, 61.8, 36.0, 34.6, 32.2, 31.2, 23.2, 19.1, 14.5, 6.3, 6.0.

### Example 12: Preparation of (Dimethylsilanediyl)(rf-4-ferrocenyl-2,6,6-trimethyl-1,5,6,7-tetrahydro-s-indacen-1-yl)(κ¹-tert-butylamido)dimethyltitanium (Complex 12)

### Chloro(4-(ferrocen-1-yl)-2,6,6-trimethyl-1,5,6,7-tetrahydro-s-indacen-1-yl)dimethylsilane

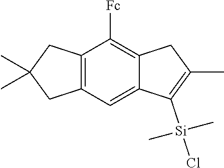

To a solution of 4-(ferrocen-1-yl)-2,2,6-trimethyl-1,2,3,5-tetrahydro-s-indacene (3.00 g, 7.85 mmol) in THE (70 ml), ⁿBuLi (2.5 M in hexanes, 3.14 ml, 7.85 mmol) was added at −78° C. The resulting mixture was warmed to the ambient temperature, stirred for 1 hour and then cooled to −78° C. Further on, dichlorodimethylsilane (5.06 g, 39.2 mmol) were added in one portion. The obtained solution was stirred overnight at room temperature. The resulting mixture was evaporated, the residue was dissolved in hot toluene and the obtained mixture was filtered through a short pad of Celite. The filtrate was evaporated. Yield: 3.10 g (84%) as a dark-brown viscous oil which was used further without additional purification. ¹H NMR (400 MHz, CDCl₃): δ 7.49 (s, 1H), 7.21 (s, 1H), 4.68-4.57 (m, 2H), 4.37 (s, 2H), 4.17 (s, 5H), 3.57 (s, 1H), 3.04-2.69 (m, 4H), 2.37 (s, 3H), 1.23 (s, 3H), 1.12 (s, 3H), 0.49 (s, 3H), 0.24 (s, 3H). ¹³C NMR (101 MHz, CDCl₃): δ 143.3, 141.6, 141.5, 139.4, 139.3, 128.4, 126.7, 118.4, 85.5, 70.1, 69.5, 69.3, 67.7, 67.4, 49.3, 48.7, 47.8, 40.1, 28.9, 28.8, 17.9, 1.3, −0.5.

### N-tert-Butyl-1-(4-ferrocenyl-2,6,6-trimethyl-1/3,5,6,7-tetrahydro-s-indacen-1-yl)-1,1-dimethylsilanamine (A/B)

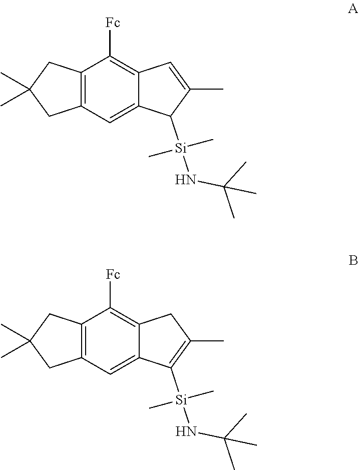

To a solution of tert-butylamine (0.46 g, 6.32 mmol) in 30 ml of diethyl ether, ⁿBuLi (2.5 M in hexanes, 2.52 ml, 6.32 mmol) was slowly added at −30° C., and the obtained mixture was stirred for 2 hours at this temperature. The above-obtained solution, chloro(4-ferrocenyl-2,6,6-trimethyl-1,5,6,7-tetrahydro-s-indacen-1-yl)dimethylsilane (3.00 g, 6.32 mmol) in 20 ml of diethyl ether was added dropwise at −30° C. The resulting mixture was stirred for 12 hours at this temperature, then evaporated to dryness. The residue was dissolved in 30 ml of hot toluene, and the obtained suspension was filtered through a short pad of Celite. The filtrate was evaporated to dryness to give 2.54 g (91%) of the title product as a dark-red viscous oil. This product was found to be a ca. 3.5 to 1 mixture of two isomers A and B, and it was further used without additional purification. HRMS (ESI): [M+H]⁺ Calcd. for C₃₁H₄₂FeNSi⁺: 512.2430; Found: 512.2435. ¹H NMR (400 MHz, CDCl₃) for A: 37.48 (s, 1H in B), 7.43 (s, 1H in A), 7.22 (s, 1H in A), 4.80-4.73 (m, 1H in B), 4.73-4.62 (m, 3H in A or B), 4.42-4.35 (m, 4H in A or in B), 4.21 (s, 5H in A), 4.19 (s, 5H in B), 3.64-2.74 (m, 13H in A and B), 3.42 (s, 1H in A), 2.40 (s, 3H in A), 1.34-1.20 (m, 27H in A), 1.17 (s, 3H in A), 0.68 (s, 1H in A), 0.53 (s, 6H in B), 0.27 (s, 3H in A), 0.07 (s, 3H in A). ¹³C NMR (101 MHz, CDCl₃): δ 155.0, 145.7, 144.6, 144.4, 141.3, 138.8, 138.3, 138.0, 126.5, 125.9, 118.3, 117.1, 114.9, 86.1, 85.8, 70.0, 69.5, 69.2, 69.2, 69.1, 69.1, 69.1, 67.7, 67.5, 67.4, 67.2, 50.4, 49.6, 49.5, 49.0, 48.7, 48.0, 47.8, 47.7, 40.0, 40.0, 33.8, 33.6, 29.0, 28.9, 28.9, 28.8, 18.4, 17.6, 4.0, 1.3, −0.6, −3.5.

### (Dimethylsilanediyl)(η⁵-4-ferrocenyl-2,6,6-trimethyl-1,5,6,7-tetrahydro-s-indacen-1-yl)(κ¹-tert-butylamido)dimethyltitanium (Complex 12) PGP-73 C₁

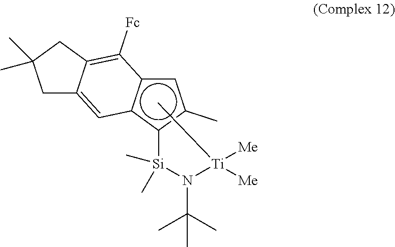

To a solution of the above-obtained N-tert-butyl-1-(4-ferrocenyl-2,6,6-trimethyl-1/3,5,6,7-tetrahydro-s-indacen-1-yl)-1,1-dimethylsilanamine (2.94 g, 5.75 mmol) in 50 ml of diethyl ether, MeLi (1.6 M in diethyl ether, 18.0 ml, 28.7 mmol) was added dropwise at 0° C. The resulting mixture was stirred for 2 hours at ambient temperature. Next, a solution of TiCl₄ (0.63 ml, 1.09 g, 5.75 mmol) in 5 ml of hexane was added in one portion. The obtained mixture was stirred overnight and then evaporated to dryness. To the residue, MeMgBr (2.9 M in diethyl ether, 5.94 ml, 17.2 mmol) and 100 ml of hexane were added. The formed mixture was stirred overnight at ambient temperature, then filtered through a short pad of Celite, and the filtrate was evaporated to dryness. The crude product was recrystallized from pentane at −30° C. Yield: 0.30 g (9%) of a dark-brown solid. Anal. calc. for C₃₃H₄₅FeNSiTi: C, 67.46; H, 7.72; N, 2.38. Found: C, 67.63; H, 7.90; N, 2.21. ¹H NMR (400 MHz, CD₂Cl₂): 37.65 (s, 1H), 7.18 (s, 1H), 4.81-4.75 (m, 1H), 4.72-4.67 (m, 1H), 4.46-4.41 (m, 1H), 4.41-4.38 (m, 1H), 4.17 (s, 5H), 3.07-2.91 (m, 2H), 2.87-2.53 (m, 2H), 2.17 (s, 3H), 1.53 (s, 9H), 1.28 (s, 3H), 0.99 (s, 3H), 0.68 (s, 3H), 0.62 (s, 3H), 0.59 (s, 3H), −0.43 (s, 3H). ¹³C NMR (101 MHz, CD₂Cl₂): δ 144.2, 140.8, 140.8, 135.8, 130.5, 130.4, 120.1, 117.5, 89.0, 85.4, 71.1, 69.8, 69.0, 68.7, 68.4, 49.5, 48.7, 47.8, 40.3, 34.6, 29.1, 28.7, 22.9, 19.1, 14.4, 6.5, 6.1.

### Example 13: Synthesis of dimethylsilanediyl(4-ferrocenyl-2-methyl-1,5,6,7-tetrahydro-s-indacenyl) (2,3,4,5-tetramethylcyclopentadienyl) zirconium dichloride (Complex 13)

### Synthesis of 8-ferrocenyl-6-methyl-1,2,3,5-tetrahydro-s-indacene (A)

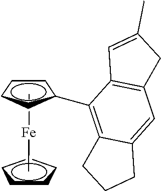

A stirring mixture of 8-bromo-6-methyl-1,2,3,5-tetrahydro-s-indacene (0.511 g, 2.05 mmol), ferrocenylboronic acid (0.471 g, 2.05 mmol, 1 equiv.), potassium carbonate (0.624 g, 4.51 mmol, 2.2 equiv.), 1,3,5,7-tetramethyl-8-phenyl-2,4,6-trioxa-8-phosphatricyclo[3.3.1.13,7]decane (0.018 g, 62 μmol, 0.03 equiv.), and bis(dibenzylideneacetone)palladium (0.012 g, 21 μmol, 0.01 equiv.) in tetrahydrofuran (10 mL), nitrogen-sparged water (4 mL) was added. The reaction vessel was sealed, and the reaction was heated to 80° C. overnight. The reaction was concentrate in vacuo. The residue was partitioned between dichloromethane and water. The dichloromethane layer was collected and concentrated in vacuo. The residue was purified by silica gel column chromatography to afford the product (164 mg, 22% yield). ¹H NMR (400 MHz, C₆D₆): δ 7.12 (s, 1H), 6.46 (s, 1H), 4.62 (s, 2H), 4.19 (s, 2H), 3.97 (s, 5H), 3.37 (s, 2H), 3.15 (t, 2H, J=7.2 Hz), 2.86 (t, 2H, J=7.4 Hz), 2.02-1.87 (m, 5H).

### Dimethyl(4-ferrocenyl-2-methyl-1,5,6,7-tetrahydro-s-indacenyl)(2,3,4,5-tetramethylcyclopentadienyl)silane (B)

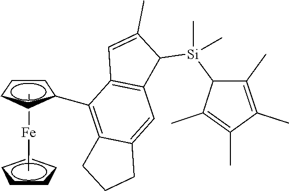

To a precooled, stirring solution of 8-ferrocenyl-6-methyl-1,2,3,5-tetrahydro-s-indacene (A) (0.164 g, 463 μmol) in diethyl ether (10 mL), n-butyllithium (0.29 mL, 1.64M in hexane, 1 equiv.) was added. The reaction was stirred at room temperature for 1 hour. The reaction was filtered over a plastic, fritted funnel. The filtered solid was collected and concentrated under high vacuum to afford a solid (0.084 g, 23.3 μmol). The solid was suspended in diethyl ether (5 mL). To this stirring suspension, a solution of [dimethyl-(2,3,4,5-tetramethylcyclopentadien-1-yl)silyl]trifluoromethanesulfonate (0.082 g, 250 μmol, 1.1 equiv.) was added. The reaction was stirred at room temperature for 1 hour. The reaction was concentrated under a stream of nitrogen and then under high vacuum. The residue was extracted with pentane (50 mL) and filtered over Celite. The filtrate was concentrated under a stream of nitrogen and then under high vacuum to afford the product as an orange foam (70 mg, 28% yield, 2 steps). ¹H NMR (400 MHz, C₆D₆): δ 7.63. (s, 1H), 7.36 (s, 1H), 4.68 (s, 1H), 4.63 (s, 1H), 4.22 (s, 2H), 4.14 (s, 5H), 3.66 (s, 1H), 3.30 (s, 1H), 3.12-2.81 (m, 4H), 2.19 (s, 3H), 2.00 (s, 3H), 1.93 (s, 3H), 1.91-1.82 (m, 8H), −0.15 (s, 3H), −0.18 (s, 3H).

### Dimethylsilanediyl(4-ferrocenyl-2-methyl-1,5,6,7-tetrahydro-s-indacenyl)(2,3,4,5-tetramethylcyclopentadienyl) zirconium dichloride (Complex 13)

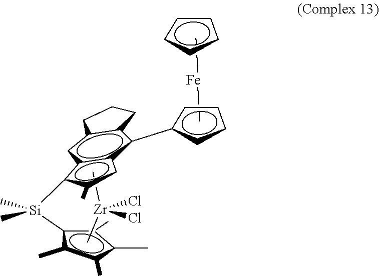

To a precooled, stirring solution of dimethyl(4-ferrocenyl-2-methyl-1,5,6,7-tetrahydro-s-indacenyl)(2,3,4,5-tetramethylcyclopentadienyl)silane (B) (70 mg, 0.13 mmol) in diethyl ether (5 mL), n-butyllithium (0.16 mL, 1.64M in hexane, 0.26 mmol, 2.0 equiv) was added. The reaction was stirred at room temperature for 45 minutes. Then, zirconium chloride (31 mg, 0.13 mmol, 1.0 equiv) and toluene (2 mL) were added. The reaction was stirred at room temperature for 17 hours. The reaction was concentrated under a stream of nitrogen and then under high vacuum. The residue was extracted with dichloromethane (2×5 mL) and filtered over Celite. The combined dichloromethane extracts were concentrated under a stream of nitrogen and then under high vacuum. The residue was stirred in pentane (2 mL) until the mixture formed an orange suspension. The mixture was the concentrated under a stream of nitrogen and then under high vacuum to afford the product as a red-orange solid (82 mg, 90% yield). ¹H NMR (400 MHz, CD₂Cl₂): δ 7.50 (s, 1H), 7.31 (s, 1H), 4.76 (s, 1H), 4.71 (s, 1H), 4.41 (s, 1H), 4.36 (s, 1H), 4.14 (s, 5H), 3.21-2.99 (m, 2H), 2.95-2.82 (m, 1H), 2.80-2.68 (m, 1H), 2.31 (s, 3H), 2.17-1.99 (m, 5H), 1.96 (s, 3H), 1.92-1.74 (m, 8H), 1.19 (s, 3H), 1.09 (s, 3H).

### Example 14: Synthesis of dimethylsilanediyl(4-ferrocenyl-2-methylindenyl)(2,3,4,5-tetramethylcyclopentadienyl) zirconium dichloride (Complex 14) 4-ferrocenyl-2-methylindene (C)

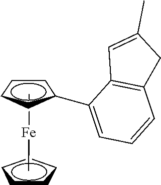

To a stirring solution of ferrocene (1.78 g, 9.57 mmol) in tetrahydrofuran (50 mL) cooled to −78° C., tert-butyllithium (11.1 mL, 1.72M in pentane, 19.1 mmol, 2.0 equiv.) was added dropwise over the course of 10 minutes. The reaction was then allowed to warm to −20° C. and stirred for 1 hour. The reaction was then cooled to −78° C. Then, zinc (II) chloride (1.43 g, 10.5 mmol, 1.10 equiv.) was added. The reaction was then allowed to warm to room temperature. Then, bis(tri-tert-butylphosphine)palladium(0) (0.491 g, 0.957 mmol, 0.10 equiv.) and 4-bromo-2-methylindene (2.00 g, 9.57 mmol, 1 equiv.) was added. The reaction was stirred and heated to reflux overnight. The reaction was allowed to cool to room temperature. The reaction was then poured over ice water (100 mL) and extracted with dichloromethane (3×50 mL). The combined dichloromethane extracts were dried over anhydrous sodium sulfate and filtered through a pad of silica. The filtrate was concentrated in vacuo. The resulting crude was purified by silica gel column chromatography (4% ethyl acetate in isohexanes) to afford the product as a red-orange solid (1.86 g, 62% yield, mixture of isomers). Major isomer ¹H NMR (400 MHz, C₆D₆): δ 7.36 (dd, 1H, J=7.7, 1.1 Hz), 7.20 (t, 1H, J=7.6 Hz), 7.13 (dd, 1H, J=7.4, 1.1 Hz), 6.52-6.48 (m, 1H), 4.71 (t, 2H, J=1.9 Hz), 4.32 (t, 2H, J=1.9 Hz), 4.07 (s, 5H), 3.43 (s, 2H), 2.19 (s, 3H).

### Synthesis of dimethyl(4-ferrocenyl-2-methylindenyl)(2,3,4,5-tetramethylcyclopentadienyl)silane (D)

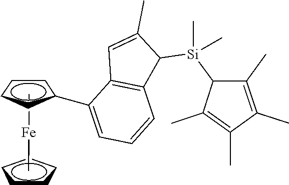

To a precooled, stirring solution of 4-ferrocenyl-2-methylindene (C) (0.985 g, 3.13 mmol) in diethyl ether (30 mL), n-butyllithium (2.0 mL, 1.64M in hexane, 3.3 mmol, 1 equiv.) was added. The reaction was stirred at room temperature for 1 hour. The reaction was filtered over a plastic, fritted funnel. The filtered solid was collected and concentrated under high vacuum. In a separate flask, to a stirring solution of [dimethyl-(2,3,4,5-tetramethylcyclopentadien-1-yl)silyl]trifluoromethanesulfonate (0.760 g, 2.31 mmol, 1 equiv.) in diethyl ether (10 mL), a suspension of the isolated solid in diethyl ether (20 mL, washing with additional 10 mL) was added. The reaction was stirred at room temperature for 1 hour. The reaction was concentrated under a stream of nitrogen and then under high vacuum. The residue was extracted with pentane (2×5 mL) and filtered over Celite. The combined pentane extracts were concentrated under a stream of nitrogen and then under high vacuum to afford the product as an orange-red foam (0.963 g, 62% yield). ¹H NMR (400 MHz, C₆D₆): δ 7.53 (d, 1H, J=7.8 Hz), 7.37 (d, 1H, J=7.5 Hz), 7.29 (s, 1H), 7.12 (t, 1H, J=7.6 Hz), 4.67 (s, 1H), 4.65 (s, 1H), 4.19 (s, 2H), 4.05 (s, 5H), 3.61 (s, 1H), 3.20 (s, 1H), 2.12 (s, 3H), 1.95 (s, 3H), 1.89 (s, 3H), 1.83 (s, 6H), −0.21 (s, 3H), −0.22 (s, 3H).

### Dimethylsilanediyl(4-ferrocenyl-2-methylindenyl)(2,3,4,5-tetramethylcyclopentadienyl) zirconium dichloride (Complex 14)

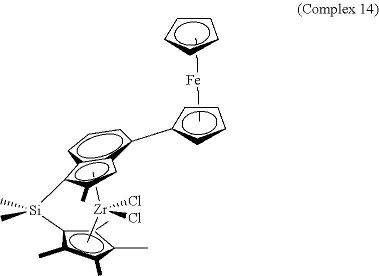

To a precooled, stirring solution of dimethyl(4-ferrocenyl-2-methylindenyl)(2,3,4,5-tetramethylcyclopentadienyl)silane (D) (0.963 g, 1.96 mmol) in diethyl ether (50 mL), n-butyllithium (2.4 mL, 1.64M in hexane, 3.9 mmol, 2 equiv.) was added. The reaction was stirred at room temperature for 45 minutes. Then, zirconium chloride (0.456 g, 1.96 mmol, 1 equiv.) was added, washing residual zirconium chloride into the reaction with toluene (3 mL). The reaction was stirred at room temperature for an additional 16 hours. The reaction was concentrated under a stream of nitrogen and then under high vacuum. The residue was extracted with dichloromethane (2×20 mL) and filtered over Celite. The combined dichloromethane extracts were concentrated under a stream of nitrogen and then under high vacuum. The residue was stirred in pentane (20 mL). The resulting suspension was concentrated under a stream of nitrogen and then under high vacuum to afford the product as a red-orange solid (1.199 g, 94% yield). ¹H NMR (400 MHz, CD₂Cl₂): δ 7.49 (d, 1H, J=8.6 Hz), 7.38 (d, 1H, J=7.0 Hz), 7.33 (s, 1H), 6.91 (ddd, 1H, J=8.7, 7.1, 1.7 Hz), 4.73 (s, 1H), 4.69 (s, 1H), 4.36 (s, 2H), 4.13 (s, 4H), 4.11-3.88 (br s, 1H), 2.32 (s, 3H), 2.07 (s, 3H), 1.96 (s, 3H), 1.86 (s, 3H), 1.85 (s, 3H), 1.19 (s, 3H), 1.10 (s, 3H).

### Example 15: Synthesis of dimethylsilanedi(4-ferrocenyl-2-isopropylindenyl)(2,3,4,5-tetramethylcyclopentadienyl) zirconium dichloride (Complex 15)

### 4-Ferrocenyl-2-isopropylindene (E)

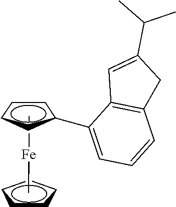

To a stirring solution of ferrocene (1.57 g, 8.43 mmol) and potassium tert-butoxide (0.115 g, 1.02 mmol, 0.122 equiv.) in tetrahydrofuran (30 mL) cooled to −78° C., tert-butyllithium (11.2 mL, 1.5M in pentane, 16.8 mmol, 1.99 equiv.) was added dropwise over the course of 10 minutes. The reaction was then allowed to warm to −20° C. and stir for 1 hour. The reaction was then recooled to −78° C., and zinc(II) chloride (1.26 g, 9.24 mmol, 1.1 equiv.) was added. The reaction was allowed to warm to room temperature. Then, bis(tri-tert-butylphosphine)palladium(0) (0.433 g, 843 μmol, 0.1 equiv.) and 4-bromo-2-isopropylindene (2.00 g, 8.43 mmol, 1 equiv.) were added along with additional tetrahydrofuran (10 mL). The reaction was stirred and heated to reflux for 14 hours. The reaction was allowed to cool to room temperature. The reaction was poured over water (100 mL). The mixture was partially concentrated in vacuo to remove tetrahydrofuran. The resulting mixture was poured into a separatory funnel, washing the residual contents of the flask into the separatory funnel with pentane (100 mL). The contents of the separatory funnel were shaken, and the organic layer was collected. The aqueous layer was extracted further with pentane (2×100 mL). The combined pentane extracts were dried over anhydrous sodium sulfate. The mixture was filtered over a pad of silica, extracting further with additional pentane (~50 mL). The combined pentane filtrate was concentrated in vacuo to give a red oil. The red oil was purified by silica gel column chromatography (4% ethyl acetate in isohexans) to afford the product as a viscous red oil (1.800 g, 62% yield, mixture of isomers). Major isomer ¹H NMR (400 MHz, C₆D₆): δ 7.48 (d, 1H, J=7.6 Hz), 7.29 (t, 1H, J=7.6 Hz), 7.22 (d, 1H, J=7.4 Hz), 6.46 (s, 1H), 4.61 (s, 2H), 4.1 (s, 2H), 4.01 (s, 1H), 3.95 (s, 4H), 3.37 (s, 2H), 2.56 (hept, 1H, J=6.8 Hz), 1.10 (d, 6H, J=6.9 Hz).

### Lithium 4-ferrocenyl-2-isopropylindenide (F)

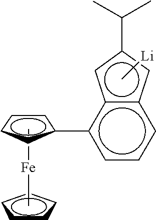

To a precooled, stirring solution of 4-ferrocenyl-2-isopropylindene (E) (1.800 g, 5.26 mmol) in diethyl ether (50 mL), n-butyllithium (3.2 mL, 1.64M in hexane, 5.3 mmol, 1 equiv.) was added. The reaction was stirred at room temperature for 45 minutes. The reaction was filtered over a plastic, fritted funnel. The filtered solid was collected and concentrated under high vacuum to afford the product as an orange solid (1.494 g, 82% yield). ¹H NMR (400 MHz, C₄D₈O): δ 7.16 (d, 1H, J=7.9 Hz), 6.76 (d, 1H, J=6.9 Hz), 6.42 (t, 1H, J=7.4 Hz), 6.30 (s, 1H), 5.86 (s, 1H), 4.80 (s, 2H), 4.16 (s, 2H), 4.02 (s, 5H), 3.09 (hept, 1H, J=7.0 Hz), 1.34 (d, 6H, J=7.2 Hz).

### Dimethyl(4-ferrocenyl-2-isopropylindenyl)(2,3,4,5-tetramethylcyclopentadienyl)silane (G)

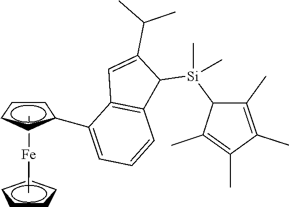

To a precooled, stirring suspension of lithium 4-ferrocenyl-2-isopropylindenide (F) (0.917 g, 2.63 mmol, 1.02 equiv.) in diethyl ether (50 mL), [dimethyl-(2,3,4,5-tetramethylcyclopentadien-1-yl)silyl]trifluoromethanesulfonate (0.844 g, 2.57 mmol) was added with additional diethyl ether (5 mL). The reaction was stirred at room temperature for 1.5 hours. The reaction was concentrated under a stream of nitrogen and then under high vacuum. The residue was extracted with pentane (50 mL, then 20 mL) and filtered over Celite. The combined pentane extracts were concentrated under a stream of nitrogen and then under high vacuum to afford the product as an orange foam (1.301 g, 97% yield). ¹H NMR (400 MHz, C₆D₆): δ 7.52 (d, 1H, J=7.6 Hz), 7.45 (s, 1H), 7.39 (d, 1H, J=7.5 Hz), 7.12 (t, 1H, J=7.6 Hz), 4.70 (s, 2H), 1.49 (s, 2H), 4.07 (s, 5H), 3.87 (s, 1H), 3.21 (s, 1H), 2.79 (hept, 1H, J=6.8 Hz), 2.01 (s, 3H), 1.89 (s, 3H), 1.84 (s, 3H), 1.82 (s, 3H), 1.35 (d, 3H, J=6.6 Hz), 1.11 (d, 3H, J=6.9 Hz).

### Dimethylsilanediyl (4-ferrocenyl-2-isopropylindenyl)(2,3,4,5-tetramethylcyclopentadienyl) zirconium dichloride (Complex 15)

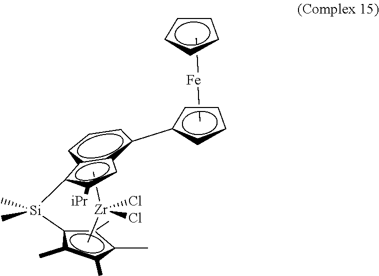

To a precooled, stirring solution of dimethyl(4-ferrocenyl-4-isopropylindenyl)(2,3,4,5-tetramethylcyclopentadienyl)silane (G) (1.301 g, 2.50 mmol) in diethyl ether (50 mL), n-butyllithium (3.0 mL, 1.64M in hexane, 4.9 mmol, 2 equiv.) was added. The reaction was stirred at room temperature for 30 minutes. Then, zirconium chloride (0.582 g, 2.50 mmol, 1 equiv.) was added with toluene (5 mL). The reaction was stirred at room temperature for 2.5 days. The reaction was concentrated under a stream of nitrogen and then under high vacuum. The residue was extracted with dichloromethane and filtered over Celite. The filtrate was concentrated under a stream of nitrogen and then under high vacuum. The residue was stirred in pentane (20 mL). The resulting suspension was concentrated under a stream of nitrogen and then under high vacuum to afford the product (1.617 g, 95% yield).

¹H NMR (400 MHz, CD₂Cl₂): δ 7.55 (s, 1H), 7.51 (d, 1H, J=8.6 Hz), 7.36 (d, 1H, J=7.0 Hz), 6.91 (t, 1H, J=7.9 Hz), 4.82 (s, 1H), 4.70 (s, 1H), 4.38 (s, 2H), 4.15 (s, 4H), 4.12-4.03 (m, 1H), 3.13 (hept, 1H, J=6.9 Hz), 2.02 (s, 3H), 1.97 (s, 3H), 1.87 (s, 6H), 1.44 (d, 3H, J=6.6 Hz), 1.21 (s, 3H), 1.18 (d, 3H, J=6.3 Hz), 1.13 (s, 3H).

### Preparation of Complex 1-BF4

0.125 g of complex 1 was placed in the small vial equipped with the stir bar and dissolved in methylene chloride (ca 5 mL). While stirring, 0.038 g of nitrosonium tetrafluoroborate (2 equiv) was added and the mixture was stirred for 1 hour. After 1 hour the resulting dark red mixture was filtered over celite. Solvent removal afforded dark red/brown powder, which was further washed with pentane (2×5 mL) and dried in vacuo. The catalyst was used in the polymerization without further purification.

### Preparation of Complex 14-BF4

0.150 g of complex 14 was placed in the small vial equipped with the stir bar and dissolved in methylene chloride (ca 5 mL). While stirring, 0.027 g of nitrosonium tetrafluoroborate (1 equiv) was added and the mixture was stirred for 1 hour. After 1 hour the resulting dark red mixture was filtered over celite. Solvent removal afforded dark red/brown powder, which was further washed with pentane (2×5 mL) and dried in vacuo. The catalyst was used in the polymerization without further purification.

### Preparation of Silica Supported MAO (SMAO)

In a celstir, 10.0 g of 200° C. calcined silica (DM-L403, Asahi Glass) was suspended in ca 100 mL of dry toluene and cooled in the freezer to −20° C. After ca 30 minutes of cooling, a 30 wt. % solution of MAO (15.8 g in toluene) was slowly added to the stirring silica mixture (over 10 minutes). The mixture was allowed to warm up (exothermically) to room temperature with stirring for 1.5 hours. After 1.5 hours, the temperature was raised to 100° C. and the reactions were allowed to stir for additional 2.5 hours. The temperature was then decreased down to 55° C. and the mixture was then filtered over glass frit. The SMAO was then washed with toluene 2×50 mL and pentane 2×50 mL and was dried in vacuo for 1 hour. Yield: 14.1 g.

### Preparation of Supported Catalysts for Lab Reactor Polymerizations

Supported Complex 1: 0.55 g of DM-L403 SMAO was suspended in toluene (6 mL) and placed on a shaker. TIBAL (0.28 mL of 1M solution) was then added and the mixture was shaken for 15 minutes. Complex 1 (10.2 mg in ca 2 mL of toluene) was then added dropwise. The slurries were allowed to shake for 2.5 hours. After 2.5 hours, the solid was filtered and washed with toluene (2×5 mL) and pentane (2×5 mL) and dried in vacuo to afford supported catalyst. 0.2 g of solid catalyst was slurried in mineral oil to make 5% slurry by weight prior to reactor polymerization testing.

Supported Complex 13: 0.55 g of DM-L403 SMAO was suspended in toluene (6 mL) and placed on a shaker. TIBAL (0.28 mL of 1M solution) was then added and the mixture was shaken for 15 minutes. Complex 13 (8.3 mg in ca 2 mL of toluene) was then added dropwise. The slurries were allowed to shake for 2.5 hours. After 2.5 hours, the solid was filtered and washed with toluene (2×5 mL) and pentane (2×5 mL) and dried in vacuo to afford supported catalyst. 0.2 g of solid catalyst was slurried in mineral oil to make 5% slurry by weight prior to reactor polymerization testing.

Supported Complex 14: 0.55 g of DM-L403 SMAO was suspended in toluene (6 mL) and placed on a shaker. TIBAL (0.28 mL of 1M solution) was then added and the mixture was shaken for 15 minutes. Complex 14 (7.9 mg in ca 2 mL of toluene) was then added dropwise. The slurries were allowed to shake for 2.5 hours. After 2.5 hours, the solid was filtered and washed with toluene (2×5 mL) and pentane (2×5 mL) and dried in vacuo to afford supported catalyst. 0.2 g of solid catalyst was slurried in mineral oil to make 5% slurry by weight prior to reactor polymerization testing.

Supported Complex 15: 0.55 g of DM-L403 SMAO was suspended in toluene (6 mL) and placed on a shaker. TIBAL (0.28 mL of 1M solution) was then added and the mixture was shaken for 15 minutes. Complex 15 (8.2 mg in ca 2 mL of toluene) was then added dropwise. The slurries were allowed to shake for 2.5 hours. After 2.5 hours, the solid was filtered and washed with toluene (2×5 mL) and pentane (2×5 mL) and dried in vacuo to afford supported catalyst. 0.2 g of solid catalyst was slurried in mineral oil to make 5% slurry by weight prior to reactor polymerization testing.

### Small Scale Polymerization Examples

Solutions of the pre-catalysts were made using toluene (ExxonMobil Chemical anhydrous, stored under N₂) (98%). Pre-catalyst solutions were typically 0.5 mmol/L.

Solvents, polymerization grade toluene and/or isohexanes were supplied by ExxonMobil Chemical Co. and were purified by passing through a series of columns: two 500 cc Oxyclear cylinders in series from Labclear (Oakland, Calif), followed by two 500 cc columns in series packed with dried 3 Å mole sieves (8-12 mesh; Aldrich Chemical Company), and two 500 cc columns in series packed with dried 5 Å mole sieves (8-12 mesh; Aldrich Chemical Company).

1-octene (C₈; 98%, Aldrich Chemical Company) was dried by stirring over NaK overnight followed by filtration through basic alumina (Aldrich Chemical Company, Brockman Basic 1).

Polymerization grade ethylene (C₂) was used and further purified by passing it through a series of columns: 500 cc Oxyclear cylinder from Labclear (Oakland, Calif.) followed by a 500 cc column packed with dried 3 Å mole sieves (8-12 mesh; Aldrich Chemical Company), and a 500 cc column packed with dried 5 Å mole sieves (8-12 mesh; Aldrich Chemical Company).

Polymerization grade propylene (C₃) was used and further purified by passing it through a series of columns: 2250 cc Oxiclear cylinder from Labclear followed by a 2250 cc column packed with 3 Amole sieves (8-12 mesh; Aldrich Chemical Company), then two 500 cc columns in series packed with 5 Amole sieves (8-12 mesh; Aldrich Chemical Company), then a 500 cc column packed with Selexsorb CD (BASF), and finally a 500 cc column packed with Selexsorb COS (BASF).

Activation of the pre-catalysts was either by methylalumoxane (MAO, 10 wt % in toluene, Albemarle Corp.; Act ID=A1), or dimethylanilinium tetrakisperfluorophenylborate (Boulder Scientific or Albemarle Corp; Act ID=A2). MAO was used as a 0.5 wt % or 1.0 wt % in toluene solution. Micromoles of MAO reported in the experimental section are based on the micromoles of aluminum in MAO. The formula weight of MAO is 58.0 grams/mole. Dimethylanilinium tetrakisperfluorophenylborate was typically used as a 0.5 mmol/L solution in toluene.

For polymerization runs using dimethylanilinium tetrakisperfluorophenylborate, tri-n-octylaluminum (TnOAl, Neat, AkzoNobel) was also used as a scavenger prior to introduction of the activator and pre-catalyst into the reactor. TnOAl was typically used as a 5 mmol/L solution in toluene.

### Small Scale Reactor Description and Preparation

Polymerizations were conducted in an inert atmosphere (N₂) drybox using autoclaves equipped with an external heater for temperature control, glass inserts (internal volume of reactor=23.5 mL for C₂ and C₂/C₈; 22.5 mL for C₃ and C₂/C₃ runs), septum inlets, regulated supply of nitrogen, ethylene and propylene, and equipped with disposable PEEK mechanical stirrers (800 RPM). The autoclaves were prepared by purging with dry nitrogen at 110° C. or 115° C. for 5 hours and then at 25° C. for 5 hours.

### Small Scale Ethylene Polymerization (PE) or Ethylene/1-Octene Copolymerization (EO):

The reactor was prepared as described above, and then purged with ethylene. For MAO (Act ID=A1) activated runs, toluene or isohexane, 1-octene (100 μL when used), and activator (MAO) were added via syringe at room temperature and atmospheric pressure. The reactor was then brought to process temperature (80° C.) and charged with ethylene to process pressure (75 psig=618.5 kPa or 200 psig=1480.3 kPa) while stirring at 800 RPM. The pre-catalyst solution was then added via syringe to the reactor at process conditions. For dimethylanilinium tetrakisperfluorophenylborate (Act ID=A2) activated runs, toluene or isohexane, 1-octene (100 μL when used) and scavenger (TnOAl, 0.5 μmol) were added via syringe at room temperature and atmospheric pressure. The reactor was then brought to process temperature (80° C.) and charged with ethylene to process pressure (75 psig=618.5 kPa or 200 psig=1480.3 kPa) while stirring at 800 RPM. The activator solution, followed by the pre-catalyst solution, was injected via syringe to the reactor at process conditions. Ethylene was allowed to enter (through the use of computer controlled solenoid valves) the autoclaves during polymerization to maintain reactor gauge pressure (+/−2 psig). Reactor temperature was monitored and typically maintained within +/−1° C. Polymerizations were halted by addition of approximately 50 psi compressed dry air gas mixture to the autoclave for approximately 30 seconds. The polymerizations were quenched after a predetermined cumulative amount of ethylene had been added (maximum quench value in psid) or for a maximum of 30 minutes polymerization time. Afterwards, the reactors were cooled and vented. Polymers were isolated after the solvent was removed in-vacuo. Yields reported include total weight of polymer and residual catalyst. Catalyst activity is reported as grams of polymer per mmol transition metal compound per hour of reaction time (g/mmol·hr). Ethylene homopolymerization runs are summarized in Table 1, and ethylene/1-octene copolymerization runs are summarized in Table 2.

### Small Scale Propylene Polymerization (PP):

The reactor was prepared as described above, then heated to 40° C., and then purged with propylene gas at atmospheric pressure. For MAO activated runs, toluene or isohexane, MAO, and liquid propylene (1.0 mL) were added via syringe. The reactor was then heated to process temperature (70° C. or 100° C.) while stirring at 800 RPM. The pre-catalyst solution was added via syringe with the reactor at process conditions. For dimethylanilinium tetrakisperfluorophenylborate or dimethylanilinium tetrakisperfluoronaphthylborate activated runs, toluene or isohexanes, liquid propylene (1.0 mL) and scavenger (TnOAl, 0.5 μmol) were added via syringe. The reactor was then brought to process temperature (70° C. or 100° C.) while stirring at 800 RPM. The activator solution, followed by the pre-catalyst solution, were injected via syringe to the reactor at process conditions. Reactor temperature was monitored and typically maintained within +/−1° C. Polymerizations were halted by addition of approximately 50 psi compressed dry air gas mixture to the autoclaves for approximately 30 seconds. The polymerizations were quenched based on a predetermined pressure loss (maximum quench value) or for a maximum of 30 minutes. The reactors were cooled and vented. The polymers were isolated after the solvent was removed in-vacuo. The actual quench time (s) is reported as quench time (s). Yields reported include total weight of polymer and residual catalyst. Catalyst activity is reported as grams of polymer per mmol transition metal compound per hour of reaction time (g/mmol·hr). Propylene homopolymerization examples are reported in Table 3 with additional characterization in Table 4.

### Lab Reactor Scale Polymerization Procedure (Propylene Bulk Slurry)

A 1 L autoclave reactor equipped with a mechanical stirrer was used for polymer preparation. Prior to the run, the reactor was placed under nitrogen purge while maintaining 90° C. temperature for 30 minutes. Upon cooling back to ambient temperature, propylene feed (500 mL), scavenger (0.2 mL of 1M TIBAL, triisobutylaluminum) and optionally hydrogen (charged from a 50 mL bomb at a desired pressure) were introduced to the reactor and were allowed to mix for 5 minutes. Supported catalyst (typically 12.5-25.0 mg) was then introduced to the reactor by flushing the pre-determined amount of catalyst slurry (5 wt % in mineral oil) from a catalyst tube with 100 mL of liquid propylene. The reactor was kept for 5 minutes at room temperature (pre-poly stage), before raising the temperature to 70° C. The reaction was allowed to proceed at that temperature for a time period (typically 30 minutes). After the given time, the temperature was reduced to 25° C., the excess propylene was vented off and the polymer granules were collected, and dried overnight.

### Small Scale Polymer Characterization

For analytical testing, polymer sample solutions were prepared by dissolving polymer in 1,2,4-trichlorobenzene (TCB, 99+% purity from Sigma-Aldrich) containing 2,6-di-tert-butyl-4-methylphenol (BHT, 99% from Aldrich) at 165° C. in a shaker oven for approximately 3 hours. The typical concentration of polymer in solution was between 0.1 to 0.9 mg/mL with a BHT concentration of 1.25 mg BHT/mL of TCB. Samples were cooled to 135° C. for testing.

High temperature size exclusion chromatography was performed using an automated “Rapid GPC” system as described in U.S. Pat. Nos. 6,491,816; 6,491,823; 6,475,391; 6,461,515; 6,436,292; 6,406,632; 6,175,409; 6,454,947; 6,260,407; and 6,294,388; each of which is incorporated herein by reference. Molecular weights (weight average molecular weight (Mw) and number average molecular weight (Mn)) and molecular weight distribution (MWD=Mw/Mn), which is also sometimes referred to as the polydispersity (PDI) of the polymer, were measured by Gel Permeation Chromatography using a Symyx Technology GPC equipped with evaporative light scattering detector (ELSD) and calibrated using polystyrene standards (Polymer Laboratories: Polystyrene Calibration Kit S-M-10: Mp (peak Mw) between 5,000 and 3,390,000). Alternatively, samples were measured by Gel Permeation Chromatography using a Symyx Technology GPC equipped with dual wavelength infrared detector and calibrated using polystyrene standards (Polymer Laboratories: Polystyrene Calibration Kit S-M-10: Mp (peak Mw) between 580 and 3,039,000). Samples (250 μL of a polymer solution in TCB were injected into the system) were run at an eluent flow rate of 2.0 mL/minute (135° C. sample temperatures, 165° C. oven/columns) using three Polymer Laboratories: PLgel 10 μm Mixed-B 300×7.5 mm columns in series. No column spreading corrections were employed. Numerical analyses were performed using Epoch® software available from Symyx Technologies or Automation Studio software available from Freeslate. The molecular weights obtained are relative to linear polystyrene standards. Molecular weight data is reported in Tables 1, 2, 3 and 5 under the headings Mn, Mw and PDI as defined above.

Differential Scanning Calorimetry (DSC) measurements were performed on a TA-Q100 instrument to determine the melting point of the polymers. Samples were pre-annealed at 220° C. for 15 minutes and then allowed to cool to room temperature overnight. The samples were then heated to 220° C. at a rate of 100° C./minute and then cooled at a rate of 50° C./minute. Melting points were collected during the heating period. The results are reported in the Tables 1, 2, and 3 under the heading, Tm (° C.).

Samples for infrared analysis were prepared by depositing the stabilized polymer solution onto a silanized wafer (Part number S10860, Symyx). By this method, approximately between 0.12 and 0.24 mg of polymer is deposited on the wafer cell. The samples were subsequently analyzed on a Brucker Equinox 55 FTIR spectrometer equipped with Pikes' MappIR specular reflectance sample accessory. Spectra, covering a spectral range of 5000 cm⁻¹ to 500 cm⁻¹, were collected at a 2 cm⁻¹ resolution with 32 scans.

For ethylene-1-octene copolymers, the wt % octene in the copolymer was determined via measurement of the methyl deformation band at ~1375 cm⁻¹. The peak height of this band was normalized by the combination and overtone band at ~4321 cm⁻¹, which corrects for path length differences. The normalized peak height was correlated to individual calibration curves from ¹H NMR data to predict the wt % octene content within a concentration range of ~2 to 35 wt % for octene. Typically, R² correlations of 0.98 or greater are achieved. These numbers are reported in Table 2 under the heading C₈ wt %).

¹³C NMR spectroscopy was used to characterize some polypropylene polymer samples produced in experiments collected in Table 3 and Table 5. This data is collected in Table 4 and Table 6. Unless otherwise indicated the polymer samples for ¹³C NMR spectroscopy were dissolved in d₂-1,1,2,2-tetrachloroethane and the samples were recorded at 125° C. using a NMR spectrometer with a ¹³C NMR frequency of 150 MHz. Polymer resonance peaks are referenced to mmmm=21.8 ppm. Calculations involved in the characterization of polymers by NMR follow the work of F. A. Bovey in “Polymer Conformation and Configuration” Academic Press, New York 1969 and J. Randall in “Polymer Sequence Determination, Carbon-13 NMR Method”, Academic Press, New York, 1977.

The stereodefects measured as “stereo defects/10,000 monomer units” are calculated from the sum of the intensities of mmrr, mmrm+rrmr, and rmrm resonance peaks times 5,000. The intensities used in the calculations are normalized to the total number of monomers in the sample. Methods for measuring 2,1 regio defects/10,000 monomers and 1,3 regio defects/10,000 monomers follow standard methods. Additional references include Grassi, A. et. al. Macromolecules, 1988, v.21, pp. 617-622 and Busico et. al. Macromolecules, 1994, v.27, pp. 7538-7543. The average meso run length=10000/[(stereo defects/10000 C)+(2,1-regio defects/10000 C)+(1,3-regio-defects/10000 C)].

¹H NMR data was collected at either room temperature or 120° C. (for purposes of the claims, 120° C. shall be used) in a 5 mm probe using a Varian spectrometer with a ¹H frequency of 250 MHz, 400 MHz, or 500 MHz (for the purpose of the claims, a proton frequency of 500 MHz is used and the polymer sample is dissolved in 1,1,2,2-tetrachloroethane-d₂ (TCE-d₂) and transferred into a 5 mm glass NMR tube). Data were recorded using a maximum pulse width of 45° C., 5 seconds between pulses and signal averaging 120 transients. The chemical shift regions for the olefin types are defined to be between the following spectral regions. The values reported in Table 6 are % vinylene, % trisubstituted (% trisub), % vinyl and % vinylidene where the percentage is relative to the total olefinic unsaturation per 1000 carbon atoms.

| | | Number of hydrogens |
|---|---|---|
| Unsaturation Type | Region (ppm) | per structure |
| Vinyl | 4.98-5.13 | 2 |
| Vinylidene | 4.69-4.88 | 2 |
| Vinylene | 5.31-5.55 | 2 |
| Trisubstituted | 5.11-5.30 | 1 |

Polymerization results are collected in Tables 1, 2, 3, and 4 below. “Ex#” stands for example number. Under the Ex# column heading, the following abbreviations are defined: PE=polyethylene, EO=ethylene-1-octene copolymer, PP=polypropylene, CPE=comparative polyethylene, CEO=comparative ethylene-1-octene copolymer, CPP=comparative polypropylene. Examples starting with a “C” as in CPP and CPE are comparative examples. “Cat ID” identifies the pre-catalyst used in the experiment. Corresponding numbers identifying the pre-catalyst (also referred to as pre-catalyst, complex or compound) are located in the synthetic experimental section or below for comparative pre-catalysts. “Cat (mol)” is the amount of pre-catalyst added to the reactor. For all experiments using dimethylanilinium tetrakisperfluorophenylborate (Act ID=A2), the molar ratio of activator/pre-catalyst was 1.1. For all experiments using MAO (Act ID=A1) as the activator, a 500 Al/M molar ratio was used unless noted otherwise. T(° C.) is the polymerization temperature which was typically maintained within +/−1° C. “Yield” is polymer yield, and is not corrected for catalyst residue. “Quench time (s)” is the actual duration of the polymerization run in seconds. “Quench Value (psid)” for ethylene based polymerization runs is the set maximum amount of ethylene uptake (conversion) for the experiment. If a polymerization quench time is less than the maximum time set, then the polymerization ran until the set maximum value of ethylene uptake was reached. For propylene homopolymerization runs, quench value indicates the maximum set pressure loss (conversion) of propylene (for PP runs) during the polymerization. Activity is reported in units of grams polymer per mmol of catalyst per hour.

### Comparative Catalysts are as Follows:

C-1 is rac-dimethylsilylene-bis(2-methylindenyl)zirconium dichloride
C-2 is rac-dimethylsilylene-bis(2-methylindenyl)zirconium dimethyl
C-3 is rac-dimethylsilylene-bis(2-methylindenyl)hafnium dimethyl
C-4 is dimethylsilylene(2,6,6-trimethyl-1,5,6,7-tetrahydro-s-indacen-1-yl)(tert-butylamido)titanium dimethyl

### Table 1. Small Scale Ethylene Homopolymerizations Examples

General reaction conditions: Total solvent volume including catalyst and activator diluents was 5.0 ml toluene; 0.025 or 0.040 μmol pre-catalyst and 500 equiv. Act ID A1 or 1.1 equiv. Act ID A2; 80° C. polymerization temperature; 75 psi of ethylene with uptake; Quench Value was set at 20 psid ethylene uptake or for a maximum time of 30 minutes. \hat{ }Indicates that 20 equiv. triisobutylaluminum was used to alkylate the pre-catalyst prior to being injected into the reactor.

TABLE 1

| | | | | | | | | | Activity | | | | | |
|---|---|---|---|---|---|---|---|---|---|---|---|---|---|---|
| | | | | Iso- | | C2 | quench | | (g | | | | | |
| | Cat | Act | Cat | hexane | Toluene | Pressure | time | yield | P/mmol | | | | | Tm |
| EX# | ID | ID | (μmol) | (μL) | (μL) | (psig) | (s) | (g) | cat · hr) | Mn | Mw | Mz | PDI | (° C.) |
| PE-1 | 1 | A1 | 0.025 | 0 | 4999 | 75 | 88 | 0.0976 | 159,347 | 457,095 | 686,134 | | 1.50 | 134.1 |
| PE-2 | 1 | A1 | 0.025 | 0 | 4999 | 75 | 98 | 0.0979 | 143,853 | 557,801 | 864,475 | | 1.55 | 133.8 |
| PE-3\hat{ } | 1 | A2 | 0.040 | 4832 | 168 | 75 | 50 | 0.0918 | 165,240 | 626,986 | 1,163,864 | | 1.86 | 132.8 |
| PE-4\hat{ } | 1 | A2 | 0.040 | 4832 | 168 | 75 | 40 | 0.0807 | 183,873 | 631,166 | 1,195,887 | | 1.89 | 132.9 |
| PE-5\hat{ } | 1 | A2 | 0.040 | 4832 | 168 | 75 | 38 | 0.0804 | 191,936 | 569,342 | 1,153,086 | | 2.03 | 133.1 |
| PE-6 | 4 | A1 | 0.025 | 0 | 4999 | 75 | 100 | 0.1040 | 149,760 | 496,445 | 1,059,866 | 4,085,122 | 2.13 | 133.0 |
| PE-7 | 4 | A1 | 0.025 | 0 | 4999 | 75 | 89 | 0.1064 | 172,153 | 519,187 | 984,812 | 2,765,209 | 1.90 | 134.9 |
| PE-8 | 4 | A1 | 0.025 | 0 | 4999 | 75 | 105 | 0.1045 | 143,314 | 505,998 | 948,027 | 2,593,170 | 1.87 | 134.9 |
| PE-9 | 6 | A1 | 0.025 | 0 | 4999 | 75 | 32 | 0.0856 | 385,200 | 109,249 | 183,078 | 372,980 | 1.68 | 136.0 |
| PE-10 | 6 | A1 | 0.025 | 0 | 4999 | 75 | 75 | 0.0726 | 139,392 | 111,056 | 185,584 | 387,894 | 1.67 | 136.7 |
| PE-11 | 6 | A1 | 0.025 | 0 | 4999 | 75 | 37 | 0.0870 | 338,595 | 106,968 | 185,441 | 405,928 | 1.73 | 136.0 |
| PE-12 | 7 | A1 | 0.025 | 0 | 4999 | 75 | 182 | 0.0546 | 43,200 | 108,723 | 180,233 | 377,439 | 1.66 | 136.7 |
| PE-13 | 7 | A1 | 0.025 | 0 | 4999 | 75 | 141 | 0.0446 | 45,549 | 114,871 | 184,758 | 367,592 | 1.61 | 136.8 |
| PE-14 | 7 | A1 | 0.025 | 0 | 4999 | 75 | 160 | 0.0526 | 47,340 | 117,689 | 184,195 | 351,781 | 1.57 | 136.2 |
| PE-15 | 9 | A1 | 0.025 | 0 | 4999 | 75 | 130 | 0.0840 | 93,046 | 710,711 | 1,394,280 | 3,454,950 | 1.96 | 134.0 |
| PE-16 | 9 | A1 | 0.025 | 0 | 4999 | 75 | 131 | 0.0840 | 92,336 | 832,774 | 1,514,002 | 3,748,639 | 1.82 | 134.5 |
| PE-17 | 9 | A1 | 0.025 | 0 | 4999 | 75 | 84 | 0.0877 | 150,343 | 709,734 | 1,437,185 | 3,801,006 | 2.02 | 134.0 |
| PE-18 | 10 | A1 | 0.025 | 0 | 4999 | 75 | 305 | 0.0404 | 19,074 | 353,652 | 821,765 | 2,428,243 | 2.32 | 133.1 |
| PE-19 | 10 | A1 | 0.025 | 0 | 4999 | 75 | 303 | 0.0396 | 18,820 | 444,277 | 998,301 | 2,595,102 | 2.25 | 133.1 |
| PE-20 | 10 | A1 | 0.025 | 0 | 4999 | 75 | 466 | 0.0525 | 16,223 | 343,309 | 862,845 | 2,238,956 | 2.51 | 132.1 |
| PE-21 | 10 | A2 | 0.025 | 0 | 5000 | 75 | 34 | 0.0851 | 360,424 | 1,136,018 | 2,394,852 | 4,693,889 | 2.11 | 129.4 |
| PE-22 | 10 | A2 | 0.025 | 0 | 5000 | 75 | 39 | 0.0884 | 326,400 | 1,057,198 | 2,484,540 | 5,012,914 | 2.35 | 126.2 |
| PE-23 | 10 | A2 | 0.025 | 0 | 5000 | 75 | 24 | 0.0845 | 507,000 | 1,306,688 | 2,624,383 | 5,121,620 | 2.01 | 132.0 |
| PE-24 | 11 | A1 | 0.025 | 0 | 4999 | 75 | 243 | 0.0467 | 27,674 | 221,341 | 488,210 | 1,441,797 | 2.21 | 134.1 |
| PE-25 | 11 | A1 | 0.025 | 0 | 4999 | 75 | 284 | 0.0461 | 23,375 | 241,707 | 591,320 | 1,903,140 | 2.45 | 133.1 |
| PE-26 | 11 | A1 | 0.025 | 0 | 4999 | 75 | 318 | 0.0536 | 24,272 | 288,752 | 752,424 | 2,607,943 | 2.61 | 133.3 |
| PE-27 | 12 | A1 | 0.025 | 0 | 4999 | 75 | 254 | 0.0723 | 40,989 | 480,460 | 973,718 | 2,250,813 | 2.03 | 133.8 |
| PE-28 | 12 | A1 | 0.025 | 0 | 4999 | 75 | 250 | 0.0735 | 42,336 | 546,524 | 1,020,780 | 2,187,439 | 1.87 | 133.7 |
| PE-29 | 12 | A1 | 0.025 | 0 | 4999 | 75 | 294 | 0.0702 | 34,384 | 760,532 | 1,268,127 | 2,539,211 | 1.67 | 133.8 |
| PE-30 | 12 | A2 | 0.025 | 0 | 5000 | 75 | 21 | 0.0929 | 637,029 | 1,235,278 | 2,638,202 | 5,150,077 | 2.14 | 126.5 |
| PE-31 | 12 | A2 | 0.025 | 0 | 5000 | 75 | 20 | 0.0944 | 679,680 | 1,660,791 | 2,983,571 | 5,156,682 | 1.80 | 130.6 |
| PE-32 | 12 | A2 | 0.025 | 0 | 5000 | 75 | 7 | 0.1000 | 2,057,143 | 1,516,266 | 2,694,754 | 4,926,507 | 1.78 | 130.5 |
| PE-33 | 3A | A1 | 0.025 | 0 | 4999 | 75 | 179 | 0.0861 | 69,265 | 677,276 | 1,453,168 | 3,735,060 | 2.15 | 134.5 |
| PE-34 | 3A | A1 | 0.025 | 0 | 4999 | 75 | 223 | 0.0903 | 58,310 | 771,706 | 1,510,397 | 3,564,857 | 1.96 | 134.1 |
| PE-35 | 3A | A1 | 0.025 | 0 | 4999 | 75 | 191 | 0.0839 | 63,254 | 552,024 | 1,268,472 | 3,075,439 | 2.30 | 135.3 |
| PE-36 | 3B | A1 | 0.025 | 0 | 4999 | 75 | 299 | 0.0531 | 25,573 | 826,998 | 1,612,261 | 3,806,982 | 1.95 | 134.1 |
| PE-37 | 3B | A1 | 0.025 | 0 | 4999 | 75 | 268 | 0.0550 | 29,552 | 858,318 | 1,616,925 | 3,522,049 | 1.88 | 134.3 |
| PE-38 | 3B | A1 | 0.025 | 0 | 4999 | 75 | 391 | 0.0719 | 26,480 | 821,587 | 1,733,555 | 4,316,661 | 2.11 | 134.4 |
| PE-39 | 5A | A1 | 0.025 | 0 | 4999 | 75 | 225 | 0.0839 | 53,696 | 541,828 | 1,016,781 | 1,993,503 | 1.88 | 134.4 |
| PE-40 | 5A | A1 | 0.025 | 0 | 4999 | 75 | 231 | 0.0872 | 54,358 | 575,878 | 1,049,504 | 2,008,443 | 1.82 | 134.4 |
| PE-41 | 5A | A1 | 0.025 | 0 | 4999 | 75 | 304 | 0.0839 | 39,742 | 550,634 | 1,025,084 | 1,998,745 | 1.86 | 134.2 |
| PE-42 | 5B | A1 | 0.025 | 0 | 4999 | 75 | 275 | 0.0799 | 41,839 | 512,364 | 948,750 | 1,932,840 | 1.85 | 134.5 |
| PE-43 | 5B | A1 | 0.025 | 0 | 4999 | 75 | 247 | 0.0847 | 49,380 | 486,100 | 961,035 | 1,959,344 | 1.98 | 134.4 |
| PE-44 | 5B | A1 | 0.025 | 0 | 4999 | 75 | 243 | 0.0816 | 48,356 | 484,931 | 861,383 | 1,662,402 | 1.78 | 134.9 |
| CPE-1 | C-1 | A1 | 0.025 | 0 | 4999 | 75 | 37 | 0.0810 | 316,957 | 220073 | 319338 | | 1.45 | 136.8 |
| CPE-1 | C-1 | A1 | 0.025 | 0 | 4999 | 75 | 46 | 0.0900 | 282,353 | 224241 | 327657 | | 1.46 | 137.1 |
| CPE-2 | C-1 | A1 | 0.025 | 0 | 4999 | 75 | 60 | 0.1023 | 245,520 | 276877 | 421845 | | 1.52 | 137.1 |
| CPE-3 | C-1 | A1 | 0.025 | 0 | 4999 | 75 | 46 | 0.0906 | 281,780 | 227226 | 329637 | | 1.45 | 137.6 |
| CPE-4 | C-1 | A1 | 0.025 | 0 | 4999 | 75 | 182 | 0.0785 | 62,144 | 454879 | 802084 | | 1.76 | |
| CPE-5 | C-1 | A1 | 0.025 | 0 | 4999 | 75 | 177 | 0.0697 | 56,737 | 440421 | 776942 | | 1.76 | 133.1 |
| CPE-6 | C-1 | A1 | 0.025 | 0 | 4999 | 75 | 255 | 0.0719 | 40,634 | 473609 | 853764 | | 1.80 | |
| CPE-7 | C-4 | A2 | 0.025 | 0 | 5000 | 75 | 13 | 0.0942 | 1,051,535 | 1424148 | 2634981 | | 1.85 | 132.7 |
| CPE-8 | C-4 | A2 | 0.025 | 0 | 5000 | 75 | 12 | 0.0964 | 1,119,484 | 1875890 | 3026295 | | 1.61 | 131.9 |
| CPE-9 | C-4 | A2 | 0.025 | 0 | 5000 | 75 | 15 | 0.0824 | 796,349 | 2110086 | 3191050 | | 1.51 | 133.4 |

### Table 2: Small Scale Ethylene-1-Octene Copolymerization Examples

General reaction conditions: Total solvent volume including catalyst and activator diluents was 4.9 ml; 0.1 ml 1-octene; 0.025 or 0.040 μmol pre-catalyst and 500 equiv. Act ID A1 or 1.1 equiv. Act ID A2; 80° C. polymerization temperature; 75 or 200 psi of ethylene with uptake; Quench Value was set at 20 psid ethylene uptake when 75 psi of ethylene was used and for 15 psid ethylene uptake when 200 psi of ethylene was used, or for a maximum time of 30 minutes. \hat{ }Indicates that 20 equiv. triisobutylaluminum was used to alkylate the pre-catalyst prior to being injected into the reactor. *Indicates that the octene wt % reported was outside the calibration range of the instrument.

TABLE 2

| | | | | Iso- | | | | | Activity | | | | | | |
|---|---|---|---|---|---|---|---|---|---|---|---|---|---|---|---|
| | | | | hex- | Tol- | C2 | quench | | (g | | | | | | |
| | Cat | Act | Cat | ane | uene | Pressure | time | yield | P/mmol | | | | | C8 | Tm |
| EX# | ID | ID | (μmol) | (μL) | (μL) | (psig) | (s) | (g) | cat · hr) | Mn | Mw | Mz | PDI | (wt %) | (° C.) |
| EO-1 | 1 | A1 | 0.025 | 0 | 4899 | 75 | 45 | 0.1190 | 383,356 | 158,339 | 260,474 | | 1.65 | 27.1 | 98.7 |
| EO-2 | 1 | A1 | 0.025 | 0 | 4899 | 75 | 40 | 0.1198 | 436,739 | 144,525 | 241,685 | | 1.67 | 30.0 | 97.2 |
| EO-3 | 1 | A1 | 0.025 | 0 | 4899 | 200 | 42 | 0.2062 | 712,058 | 190,541 | 373,236 | | 1.96 | 13.3 | 115.8 |
| EO-4 | 1 | A1 | 0.025 | 0 | 4899 | 200 | 44 | 0.2069 | 671,027 | 172,844 | 350,802 | | 2.03 | 14.5 | 115.2 |
| EO-5 | 1 | A1 | 0.025 | 0 | 4899 | 200 | 37 | 0.2055 | 804,130 | 188,989 | 390,900 | | 2.07 | 13.7 | 115.9 |
| EO-6\hat{ } | 1 | A2 | 0.040 | 4732 | 168 | 75 | 30 | 0.1154 | 349,697 | 145,902 | 290,810 | | 1.99 | 31.9 | 59.1 |
| EO-7\hat{ } | 1 | A2 | 0.040 | 4732 | 168 | 75 | 32 | 0.1257 | 354,639 | 153,910 | 293,152 | | 1.90 | 31.1 | 83.3 |
| EO-8\hat{ } | 1 | A2 | 0.040 | 4732 | 168 | 75 | 30 | 0.1132 | 339,600 | 153,457 | 294,686 | | 1.92 | 33.2 | 58.8 |
| EO-9\hat{ } | 1 | A2 | 0.040 | 4732 | 168 | 200 | 28 | 0.1948 | 637,527 | 162,385 | 349,030 | | 2.15 | 15.6 | 106.4 |
| EO-10\hat{ } | 1 | A2 | 0.040 | 4732 | 168 | 200 | 15 | 0.1777 | 1,080,608 | 170,378 | 340,579 | | 2.00 | 14.8 | 107.7 |
| EO-11\hat{ } | 1 | A2 | 0.040 | 4732 | 168 | 200 | 17 | 0.1825 | 966,176 | 162,690 | 342,994 | | 2.11 | 16.1 | 106.6 |
| EO-12 | 4 | A1 | 0.025 | 0 | 4899 | 75 | 139 | 0.1417 | 146,797 | 91,968 | 378,261 | 1,082,417 | 4.11 | 27.0 | 110.0 |
| EO-13 | 4 | A1 | 0.025 | 0 | 4899 | 75 | 46 | 0.1048 | 328,070 | 107,976 | 351,889 | 990,482 | 3.26 | 24.7 | 98.9 |
| EO-14 | 4 | A1 | 0.025 | 0 | 4899 | 75 | 46 | 0.1072 | 335,583 | 165,386 | 361,149 | 896,394 | 2.18 | 26.8 | 96.8 |
| EO-15 | 4 | A1 | 0.025 | 0 | 4899 | 200 | 36 | 0.2031 | 812,400 | 170,706 | 477,922 | 1,299,293 | 2.80 | 16.2 | 113.9 |
| EO-16 | 4 | A1 | 0.025 | 0 | 4899 | 200 | 51 | 0.2064 | 582,776 | 155,236 | 549,190 | 1,932,737 | 3.54 | 18.2 | 115.8 |
| EO-17 | 4 | A1 | 0.025 | 0 | 4899 | 200 | 47 | 0.2026 | 620,732 | 175,008 | 464,937 | 1,127,710 | 2.66 | 16.5 | 113.5 |
| EO-18 | 6 | A1 | 0.025 | 0 | 4899 | 75 | 47 | 0.0867 | 265,634 | 96,063 | 164,756 | 340,199 | 1.72 | 4.6 | 124.4 |
| EO-19 | 6 | A1 | 0.025 | 0 | 4899 | 75 | 47 | 0.0871 | 266,860 | 96,816 | 163,829 | 345,686 | 1.69 | 5.0 | 123.9 |
| EO-20 | 6 | A1 | 0.025 | 0 | 4899 | 75 | 46 | 0.0865 | 270,783 | 93,601 | 165,135 | 406,220 | 1.76 | 4.3 | 124.1 |
| EO-21 | 6 | A1 | 0.025 | 0 | 4899 | 200 | 23 | 0.1773 | 1,110,052 | 94,400 | 158,528 | 342,898 | 1.68 | 3.0* | 129.0 |
| EO-22 | 6 | A1 | 0.025 | 0 | 4899 | 200 | 22 | 0.1652 | 1,081,309 | 96,613 | 163,996 | 375,744 | 1.70 | 0.8* | 128.7 |
| EO-23 | 6 | A1 | 0.025 | 0 | 4899 | 200 | 22 | 0.1724 | 1,128,436 | 99,362 | 163,651 | 342,942 | 1.65 | 2.3* | 129.0 |
| EO-24 | 7 | A1 | 0.025 | 0 | 4899 | 75 | 575 | 0.0329 | 8,239 | 139,132 | 228,016 | 475,629 | 1.64 | 2.9* | 126.5 |
| EO-25 | 7 | A1 | 0.025 | 0 | 4899 | 75 | 445 | 0.0291 | 9,417 | 141,018 | 234,673 | 524,596 | 1.66 | 2.7* | 127.1 |
| EO-26 | 7 | A1 | 0.025 | 0 | 4899 | 75 | 477 | 0.0271 | 8,181 | 136,715 | 232,010 | 504,692 | 1.70 | 2.4* | 127.0 |
| EO-27 | 7 | A1 | 0.025 | 0 | 4899 | 200 | 133 | 0.0499 | 54,027 | 117,021 | 191,370 | 391,463 | 1.64 | 1.2* | 132.5 |
| EO-28 | 7 | A1 | 0.025 | 0 | 4899 | 200 | 108 | 0.0561 | 74,800 | 119,850 | 194,380 | 388,868 | 1.62 | 1.4* | 132.3 |
| EO-29 | 7 | A1 | 0.025 | 0 | 4899 | 200 | 143 | 0.0612 | 61,628 | 110,333 | 195,279 | 433,365 | 1.77 | 1.3* | 131.9 |
| EO-30 | 9 | A1 | 0.025 | 0 | 4899 | 75 | 167 | 0.1054 | 90,884 | 286,039 | 538,118 | 1,210,456 | 1.88 | 28.7 | |
| EO-31 | 9 | A1 | 0.025 | 0 | 4899 | 75 | 133 | 0.0957 | 103,615 | 346,224 | 628,915 | 1,445,241 | 1.82 | 28.9 | |
| EO-32 | 9 | A1 | 0.025 | 0 | 4899 | 75 | 136 | 0.0962 | 101,859 | 258,156 | 540,972 | 1,261,684 | 2.10 | 29.3 | |
| EO-33 | 9 | A1 | 0.025 | 0 | 4899 | 200 | 108 | 0.2181 | 290,800 | 169,644 | 670,426 | 1,821,246 | 3.95 | 16.3 | 91.5 |
| EO-34 | 9 | A1 | 0.025 | 0 | 4899 | 200 | 114 | 0.2195 | 277,263 | 233,053 | 779,465 | 1,972,105 | 3.34 | 21.6 | 90.5 |
| EO-35 | 9 | A1 | 0.025 | 0 | 4899 | 200 | 108 | 0.2197 | 292,933 | 240,040 | 719,079 | 1,774,782 | 3.00 | 16.4 | 90.5 |
| EO-36 | 10 | A1 | 0.025 | 0 | 4899 | 75 | 376 | 0.0413 | 15,817 | 132,950 | 309,072 | 691,653 | 2.32 | 22.9 | 83.6 |
| EO-37 | 10 | A1 | 0.025 | 0 | 4899 | 75 | 447 | 0.0381 | 12,274 | 196,504 | 327,948 | 623,961 | 1.67 | 21.8 | 85.4 |
| EO-38 | 10 | A1 | 0.025 | 0 | 4899 | 75 | 408 | 0.0457 | 16,129 | 193,420 | 358,394 | 749,977 | 1.85 | 18.7 | 83.4 |
| EO-39 | 10 | A1 | 0.025 | 0 | 4899 | 200 | 242 | 0.1029 | 61,230 | 398,888 | 731,548 | 1,488,546 | 1.83 | 10.3 | 104.7 |
| EO-40 | 10 | A1 | 0.025 | 0 | 4899 | 200 | 290 | 0.1341 | 66,588 | 519,002 | 1,020,984 | 2,386,284 | 1.97 | 8.7 | 119.0 |
| EO-41 | 10 | A1 | 0.025 | 0 | 4899 | 200 | 228 | 0.0920 | 58,105 | 349,307 | 652,876 | 1,313,564 | 1.87 | 10.6 | 105.4 |
| EO-42 | 10 | A2 | 0.025 | 0 | 4900 | 75 | 277 | 0.1206 | 62,695 | 170,324 | 660,662 | 2,522,798 | 3.88 | 42.2* | 84.4 |
| EO-43 | 10 | A2 | 0.025 | 0 | 4900 | 75 | 339 | 0.1252 | 53,182 | 179,147 | 657,471 | 2,397,215 | 3.67 | 35.8* | 82.9 |
| EO-44 | 10 | A2 | 0.025 | 0 | 4900 | 75 | 256 | 0.1268 | 71,325 | 143,949 | 551,326 | 1,863,214 | 3.83 | 33.9 | 78.8 |
| EO-45 | 10 | A2 | 0.025 | 0 | 4900 | 200 | 33 | 0.1844 | 804,655 | 358,230 | 1,173,073 | 3,270,280 | 3.27 | 17.3 | 98.8 |
| EO-46 | 10 | A2 | 0.025 | 0 | 4900 | 200 | 32 | 0.1641 | 738,450 | 461,893 | 1,220,974 | 3,095,095 | 2.64 | 16.6 | 99.4 |
| EO-47 | 10 | A2 | 0.025 | 0 | 4900 | 200 | 52 | 0.1900 | 526,154 | 293,069 | 1,140,494 | 3,501,074 | 3.89 | 15.4 | 100.2 |
| EO-48 | 11 | A1 | 0.025 | 0 | 4899 | 75 | 343 | 0.0588 | 24,686 | 209,811 | 344,046 | 684,454 | 1.64 | 11.0 | 101.8 |
| EO-49 | 11 | A1 | 0.025 | 0 | 4899 | 75 | 340 | 0.0582 | 24,649 | 190,364 | 353,335 | 751,681 | 1.86 | 10.7 | 103.1 |
| EO-50 | 11 | A1 | 0.025 | 0 | 4899 | 75 | 274 | 0.0479 | 25,174 | 181,007 | 320,161 | 671,346 | 1.77 | 11.3 | 102.3 |
| EO-51 | 11 | A1 | 0.025 | 0 | 4899 | 200 | 130 | 0.0722 | 79,975 | 231,250 | 512,883 | 1,162,149 | 2.22 | 5.1 | 116.0 |
| EO-52 | 11 | A1 | 0.025 | 0 | 4899 | 200 | 155 | 0.0581 | 53,977 | 185,990 | 400,804 | 938,058 | 2.15 | 5.4 | 116.3 |
| EO-53 | 11 | A1 | 0.025 | 0 | 4899 | 200 | 151 | 0.0647 | 61,701 | 207,520 | 479,519 | 1,191,968 | 2.31 | 5.3 | 116.3 |
| EO-54 | 12 | A1 | 0.025 | 0 | 4899 | 75 | 358 | 0.1022 | 41,108 | 284,926 | 623,421 | 1,370,586 | 2.19 | 29.7 | 76.6 |
| EO-55 | 12 | A1 | 0.025 | 0 | 4899 | 75 | 403 | 0.1079 | 38,555 | 388,842 | 738,882 | 1,610,825 | 1.90 | 28.1 | 78.4 |
| EO-56 | 12 | A1 | 0.025 | 0 | 4899 | 75 | 287 | 0.0962 | 48,268 | 432,640 | 739,814 | 1,463,392 | 1.71 | 26.2 | 77.6 |
| EO-57 | 12 | A1 | 0.025 | 0 | 4899 | 200 | 101 | 0.1601 | 228,261 | 635,450 | 1,082,629 | 2,168,509 | 1.70 | 13.6 | 101.4 |
| EO-58 | 12 | A1 | 0.025 | 0 | 4899 | 200 | 104 | 0.1794 | 248,400 | 605,785 | 1,095,047 | 2,198,785 | 1.81 | 10.8 | 103.2 |
| EO-59 | 12 | A1 | 0.025 | 0 | 4899 | 200 | 125 | 0.1765 | 203,328 | 451,303 | 937,994 | 1,897,978 | 2.08 | 13.0 | 101.6 |
| EO-60 | 12 | A2 | 0.025 | 0 | 4900 | 75 | 265 | 0.1292 | 70,207 | 241,501 | 1,365,184 | 4,181,225 | 5.65 | 28.4 | 100.1 |
| EO-61 | 12 | A2 | 0.025 | 0 | 4900 | 75 | 203 | 0.1253 | 88,883 | 233,707 | 1,402,386 | 4,630,985 | 6.00 | 29.5 | 102.8 |
| EO-62 | 12 | A2 | 0.025 | 0 | 4900 | 75 | 162 | 0.1244 | 110,578 | 149,133 | 799,640 | 2,778,919 | 5.36 | 43.0* | 84.6 |
| EO-63 | 12 | A2 | 0.025 | 0 | 4900 | 200 | 11 | 0.1747 | 2,286,982 | 133,422 | 928,695 | 2,612,225 | 6.96 | 20.2 | 103.3 |
| EO-64 | 12 | A2 | 0.025 | 0 | 4900 | 200 | 30 | 0.1968 | 944,640 | | | | | 13.2 | 124.9 |
| EO-65 | 12 | A2 | 0.025 | 0 | 4900 | 200 | 10 | 0.1874 | 2,698,560 | 306,607 | 1,270,846 | 3,741,031 | 4.14 | 14.1 | 102.2 |
| EO-66 | 3A | A1 | 0.025 | 0 | 4899 | 75 | 181 | 0.0671 | 53,383 | 273,996 | 518,771 | 1,095,091 | 1.89 | 24.3 | 103.5 |
| EO-67 | 3A | A1 | 0.025 | 0 | 4899 | 75 | 164 | 0.0798 | 70,068 | 311,978 | 534,165 | 1,105,346 | 1.71 | 24.0 | 104.3 |
| EO-68 | 3A | A1 | 0.025 | 0 | 4899 | 75 | 147 | 0.0678 | 66,416 | 322,929 | 555,907 | 1,093,001 | 1.72 | 18.1 | 103.0 |
| EO-69 | 3A | A1 | 0.025 | 0 | 4899 | 200 | 149 | 0.1774 | 171,447 | 290,945 | 621,063 | 1,601,492 | 2.13 | 12.2 | 112.2 |
| EO-70 | 3A | A1 | 0.025 | 0 | 4899 | 200 | 140 | 0.1816 | 186,789 | 276,529 | 616,550 | 1,699,359 | 2.23 | 12.6 | 113.4 |
| EO-71 | 3A | A1 | 0.025 | 0 | 4899 | 200 | 158 | 0.1870 | 170,430 | 294,724 | 639,004 | 1,595,681 | 2.17 | 13.7 | 112.6 |
| EO-72\hat{ } | 3B | A1 | 0.025 | 0 | 4899 | 75 | 693 | 0.0418 | 8,686 | 509,103 | 979,650 | 2,066,357 | 1.92 | 10.1 | 112.1 |
| EO-73\hat{ } | 3B | A1 | 0.025 | 0 | 4899 | 75 | 454 | 0.0491 | 15,574 | 866,192 | 1,370,260 | 2,529,219 | 1.58 | 9.9 | 111.6 |
| EO-74\hat{ } | 3B | A1 | 0.025 | 0 | 4899 | 75 | 404 | 0.0431 | 15,362 | 497,273 | 1,000,594 | 2,087,020 | 2.01 | 10.7 | 111.3 |
| EO-75\hat{ } | 3B | A1 | 0.025 | 0 | 4899 | 200 | 324 | 0.0375 | 16,667 | 470,526 | 1,075,337 | 2,764,232 | 2.29 | 6.1 | 118.7 |
| EO-76\hat{ } | 3B | A1 | 0.025 | 0 | 4899 | 200 | 359 | 0.1203 | 48,254 | 586,366 | 1,281,937 | 3,009,849 | 2.19 | 6.0 | 119.5 |
| EO-77\hat{ } | 3B | A1 | 0.025 | 0 | 4899 | 200 | 409 | 0.1207 | 42,496 | 606,966 | 1,258,399 | 3,024,659 | 2.07 | 7.2 | 115.8 |
| EO-78 | 5A | A1 | 0.025 | 0 | 4899 | 75 | 162 | 0.0721 | 64,089 | 282,158 | 485,448 | 950,680 | 1.72 | 25.0 | 98.8 |
| EO-79 | 5A | A1 | 0.025 | 0 | 4899 | 75 | 143 | 0.0796 | 80,157 | 243,058 | 469,617 | 986,319 | 1.93 | 21.0 | 98.3 |
| EO-80 | 5A | A1 | 0.025 | 0 | 4899 | 75 | 124 | 0.0627 | 72,813 | 300,718 | 475,620 | 872,074 | 1.58 | 22.4 | 98.6 |
| EO-81 | 5A | A1 | 0.025 | 0 | 4899 | 200 | 130 | 0.1868 | 206,917 | 277,444 | 585,931 | 1,317,312 | 2.11 | 13.5 | 109.7 |
| EO-82 | 5A | A1 | 0.025 | 0 | 4899 | 200 | 142 | 0.0595 | 60,338 | 266,645 | 588,044 | 1,326,399 | 2.21 | 15.0 | 110.0 |
| EO-83 | 5A | A1 | 0.025 | 0 | 4899 | 200 | 161 | 0.1936 | 173,158 | 293,407 | 589,553 | 1,267,282 | 2.01 | 15.6 | 109.8 |
| EO-84 | 5B | A1 | 0.025 | 0 | 4899 | 75 | 222 | 0.0533 | 34,573 | 327,280 | 641,325 | 1,313,443 | 1.96 | 20.1 | 108.4 |
| EO-85 | 5B | A1 | 0.025 | 0 | 4899 | 75 | 217 | 0.0588 | 39,019 | 407,598 | 699,482 | 1,418,224 | 1.72 | 13.5 | 108.8 |
| EO-86 | 5B | A1 | 0.025 | 0 | 4899 | 75 | 253 | 0.0599 | 34,093 | 382,859 | 673,644 | 1,360,300 | 1.76 | 14.0 | 108.9 |
| EO-87 | 5B | A1 | 0.025 | 0 | 4899 | 200 | 160 | 0.1466 | 131,940 | 413,432 | 758,201 | 1,625,473 | 1.83 | 7.1 | 113.6 |
| EO-88 | 5B | A1 | 0.025 | 0 | 4899 | 200 | 176 | 0.1488 | 121,745 | 433,438 | 760,726 | 1,541,435 | 1.76 | 10.0 | 113.9 |
| EO-89 | 5B | A1 | 0.025 | 0 | 4899 | 200 | 185 | 0.1559 | 121,349 | 426,237 | 763,964 | 1,553,090 | 1.79 | 9.6 | 113.5 |
| CEO-1 | C-1 | A1 | 0.025 | 0 | 4899 | 75 | 44 | 0.0965 | 319,448 | 180,414 | 263,437 | | 1.46 | 10.5 | 116.7 |
| CEO-1 | C-1 | A1 | 0.025 | 0 | 4899 | 75 | 43 | 0.0894 | 298,000 | 180,620 | 262,889 | | 1.46 | 9.6 | 116.1 |
| CEO-2 | C-1 | A1 | 0.025 | 0 | 4899 | 75 | 39 | 0.0959 | 352,286 | 183,459 | 267,910 | | 1.46 | 10.4 | 116.5 |
| CEO-3 | C-1 | A1 | 0.025 | 0 | 4899 | 75 | 39 | 0.0908 | 334,404 | 184,195 | 268,312 | | 1.46 | 9.3 | 116.3 |
| CEO-4 | C-1 | A1 | 0.025 | 0 | 4899 | 200 | 102 | 0.1692 | 239,811 | 170,222 | 259,602 | | 1.53 | 7.7 | 124.4 |
| CEO-5 | C-1 | A1 | 0.025 | 0 | 4899 | 200 | 51 | 0.1792 | 505,976 | 175,058 | 262,129 | | 1.50 | 5.7 | 125.1 |
| CEO-6 | C-1 | A1 | 0.025 | 0 | 4899 | 200 | 65 | 0.1740 | 386,667 | 174,887 | 260,479 | | 1.49 | 5.5 | 125.6 |
| CEO-7 | C-1 | A1 | 0.025 | 0 | 4899 | 200 | 66 | 0.1746 | 380,945 | 179,272 | 268,303 | | 1.50 | 6.7 | 125.0 |
| CEO-8 | C-3 | A2 | 0.025 | 0 | 4900 | 75 | 290 | 0.1119 | 55,507 | 94,081 | 993,327 | | 10.56 | 27.1 | 109.0 |
| CEO-9 | C-3 | A2 | 0.025 | 0 | 4900 | 75 | 222 | 0.1108 | 71,870 | 91,553 | 1,158,050 | | 12.65 | 24.7 | 109.0 |
| CEO-10 | C-3 | A2 | 0.025 | 0 | 4900 | 75 | 238 | 0.1091 | 66,010 | 75,269 | 970,376 | | 12.89 | 29.1 | 107.0 |
| CEO-11 | C-3 | A2 | 0.025 | 0 | 4900 | 200 | 41 | 0.1960 | 683,390 | 105,547 | 1,033,046 | | 9.79 | 21.2 | 111.3 |
| CEO-12 | C-3 | A2 | 0.025 | 0 | 4900 | 200 | 42 | 0.2012 | 693,129 | 77,057 | 957,772 | | 12.43 | 19.7 | 111.9 |
| CEO-13 | C-3 | A2 | 0.025 | 0 | 4900 | 200 | 27 | 0.1742 | 946,596 | 199,734 | 1,021,222 | | 5.11 | 16.3 | 111.1 |
| CEO-14 | C-3 | A1 | 0.025 | 0 | 4899 | 75 | 405 | 0.1152 | 40,960 | 484,970 | 877,132 | | 1.81 | 26.5 | 109.7 |
| CEO-15 | C-3 | A1 | 0.025 | 0 | 4899 | 75 | 319 | 0.1028 | 46,361 | 527,032 | 868,067 | | 1.65 | 25.5 | 106.8 |
| CEO-16 | C-3 | A1 | 0.025 | 0 | 4899 | 75 | 334 | 0.1048 | 45,129 | 526,731 | 878,525 | | 1.67 | 28.0 | 105.3 |
| CEO-17 | C-3 | A1 | 0.025 | 0 | 4899 | 200 | 100 | 0.1644 | 237,210 | 715,575 | 1,095,564 | | 1.53 | 11.8 | 110.6 |
| CEO-18 | C-3 | A1 | 0.025 | 0 | 4899 | 200 | 130 | 0.1866 | 206,219 | 652,323 | 1,025,896 | | 1.57 | 13.9 | 113.0 |
| CEO-19 | C-3 | A1 | 0.025 | 0 | 4899 | 200 | 131 | 0.0359 | 39,580 | 553,162 | 858,322 | | 1.55 | 6.3 | 118.7 |
| CEO-20 | C-4 | A1 | 0.025 | 0 | 4899 | 75 | 186 | 0.0988 | 76,614 | 386,088 | 607,744 | | 1.57 | 22.5 | 84.7 |
| CEO-21 | C-4 | A1 | 0.025 | 0 | 4899 | 75 | 207 | 0.1009 | 70,259 | 387,057 | 605,447 | | 1.56 | 24.3 | 80.9 |
| CEO-22 | C-4 | A1 | 0.025 | 0 | 4899 | 75 | 123 | 0.0800 | 93,811 | 403,826 | 608,596 | | 1.51 | 23.3 | 83.1 |
| CEO-23 | C-4 | A1 | 0.025 | 0 | 4899 | 200 | 106 | 0.1717 | 233,473 | 534,420 | 915,670 | | 1.71 | 14.7 | 103.7 |
| CEO-24 | C-4 | A1 | 0.025 | 0 | 4899 | 200 | 84 | 0.1720 | 296,623 | 614,719 | 1,064,491 | | 1.73 | 14.2 | 103.2 |
| CEO-25 | C-4 | A1 | 0.025 | 0 | 4899 | 200 | 91 | 0.1715 | 271,982 | 610,858 | 1,060,918 | | 1.74 | 13.3 | 103.8 |
| CEO-26 | C-4 | A2 | 0.025 | 0 | 4900 | 75 | 206 | 0.1177 | 82,316 | 262,435 | 1,393,623 | | 5.31 | 29.4 | 98.6 |
| CEO-27 | C-4 | A2 | 0.025 | 0 | 4900 | 75 | 166 | 0.1203 | 104,294 | 239,910 | 1,196,953 | | 4.99 | 32.2 | 86.2 |
| CEO-28 | C-4 | A2 | 0.025 | 0 | 4900 | 75 | 167 | 0.1199 | 103,325 | 238,475 | 1,454,229 | | 6.10 | 33.8 | 83.9 |
| CEO-29 | C-4 | A2 | 0.025 | 0 | 4900 | 200 | 17 | 0.1835 | 1,536,279 | 622,224 | 1,560,758 | | 2.51 | 16.4 | 104.1 |
| CEO-30 | C-4 | A2 | 0.025 | 0 | 4900 | 200 | 12 | 0.1870 | 2,189,268 | 622,207 | 1,579,191 | | 2.54 | 15.3 | 105.6 |
| CEO-31 | C-4 | A2 | 0.025 | 0 | 4900 | 200 | 32 | 0.1937 | 871,650 | 720,000 | 1,762,310 | | 2.45 | 17.6 | 103.5 |

### Table 3: Small Scale Propylene Polymerization Examples

General reaction conditions: Total solvent volume including catalyst and activator diluents was 4.1 ml solvent; 1.0 ml propylene; pre-catalyst amount and activator amount is listed in the Table; TnOAl (0.5 μmol) was used when Act ID A2 was used; polymerization was conducted at 70° C. or 100° C. as indicated.; Quench was set for the psi loss of 8 psid or for a maximum time of 30 minutes. \hat{ }Indicates that 20 equiv. triisobutylaluminum was used to alkylate the pre-catalyst prior to being injected into the reactor.

TABLE 3

| | | | | | | | | | | Activity | | | | | |
|---|---|---|---|---|---|---|---|---|---|---|---|---|---|---|---|
| | | | | | Iso- | | | quench | | (g | | | | | |
| | Cat | Act | Cat | Act | hexane | Toluene | T | time | yield | P/mmol | | | | | Tm |
| EX# | ID | ID | (μmol) | (μmol) | (μL) | (μL) | (C.) | (s) | (g) | cat · hr) | Mn | Mw | Mz | PDI | (° C.) |
| PP-1 | 1 | A1 | 0.025 | 6.3 | 3966 | 134 | 70 | 152 | 0.1911 | 181,042 | 111,204 | 197,343 | 505,705 | 1.77 | 150.4 |
| PP-2 | 1 | A1 | 0.025 | 6.3 | 3966 | 134 | 70 | 156 | 0.2028 | 187,200 | 78,425 | 165,768 | 425,946 | 2.11 | 150.0 |
| PP-3 | 1 | A1 | 0.025 | 6.3 | 3966 | 134 | 100 | 301 | 0.0917 | 43,870 | 23,098 | 41,605 | 92,379 | 1.80 | 143.2 |
| PP-4 | 1 | A1 | 0.025 | 6.3 | 3966 | 134 | 100 | 304 | 0.0955 | 45,237 | 27,489 | 42,647 | 80,616 | 1.55 | 142.9 |
| PP-5 | 1 | A1 | 0.025 | 6.3 | 3966 | 134 | 115 | 542 | 0.0900 | 23,911 | 13,804 | 23,503 | 49,455 | 1.70 | 136.3 |
| PP-6 | 1 | A1 | 0.025 | 6.3 | 3966 | 134 | 115 | 510 | 0.0835 | 23,576 | 10,032 | 19,027 | 44,719 | 1.90 | 134.8 |
| PP-7 | 1 | A1 | 0.025 | 12.5 | 0 | 4099 | 70 | 67 | 0.2032 | 439,351 | 62,099 | 102,092 | | 1.64 | 149.2 |
| PP-8 | 1 | A1 | 0.025 | 12.5 | 0 | 4099 | 70 | 74 | 0.2205 | 429,081 | 59,528 | 99,217 | | 1.67 | 149.6 |
| PP-9 | 1 | A1 | 0.025 | 12.5 | 0 | 4099 | 70 | 71 | 0.1952 | 397,017 | 68,429 | 110,715 | | 1.62 | 148.4 |
| PP-10 | 1 | A1 | 0.025 | 12.5 | 0 | 4099 | 100 | 69 | 0.1555 | 326,414 | 18,102 | 27,530 | | 1.52 | 142.0 |
| PP-11 | 1 | A1 | 0.025 | 12.5 | 0 | 4099 | 100 | 58 | 0.1339 | 335,332 | 17,489 | 26,680 | | 1.53 | 140.8 |
| PP-12 | 1 | A1 | 0.025 | 12.5 | 0 | 4099 | 100 | 62 | 0.1569 | 362,077 | 16,867 | 26,076 | | 1.55 | 141.1 |
| PP-13 | 1 | A1 | 0.025 | 12.5 | 3882 | 217 | 70 | 92 | 0.1971 | 308,504 | 72,820 | 149,211 | 393,373 | 2.05 | 150.5 |
| PP-14 | 1 | A1 | 0.025 | 12.5 | 3882 | 217 | 70 | 108 | 0.2521 | 336,133 | 61,843 | 128,097 | 355,481 | 2.07 | 149.7 |
| PP-15 | 1 | A1 | 0.025 | 12.5 | 3882 | 217 | 100 | 286 | 0.0720 | 36,252 | 24,501 | 44,062 | 101,716 | 1.80 | 142.6 |
| PP-16 | 1 | A1 | 0.025 | 12.5 | 3882 | 217 | 100 | 235 | 0.0949 | 58,151 | 24,088 | 40,374 | 77,533 | 1.68 | 142.9 |
| PP-17 | 1 | A1 | 0.025 | 12.5 | 3882 | 217 | 115 | 367 | 0.0839 | 32,920 | 11,885 | 21,779 | 47,554 | 1.83 | 136.4 |
| PP-18 | 1 | A1 | 0.025 | 12.5 | 3882 | 217 | 115 | 350 | 0.0864 | 35,547 | 9,238 | 17,964 | 38,668 | 1.94 | 134.3 |
| PP-19 | 1 | A1 | 0.040 | 20.0 | 0 | 4099 | 70 | 44 | 0.2598 | 536,284 | 49,277 | 80,127 | | 1.63 | 146.8 |
| PP-20 | 1 | A1 | 0.040 | 20.0 | 0 | 4099 | 70 | 46 | 0.2524 | 493,826 | 51,409 | 86,960 | | 1.69 | 147.0 |
| PP-21 | 1 | A1 | 0.040 | 20.0 | 0 | 4099 | 70 | 49 | 0.2547 | 472,639 | 47,453 | 81,467 | | 1.72 | 146.7 |
| PP-22 | 1 | A1 | 0.040 | 20.0 | 0 | 4099 | 100 | 40 | 0.2269 | 509,252 | 14,800 | 24,768 | | 1.67 | 139.1 |
| PP-23 | 1 | A1 | 0.040 | 20.0 | 0 | 4099 | 100 | 38 | 0.2131 | 511,440 | 15,331 | 24,617 | | 1.61 | 139.4 |
| PP-24 | 1 | A1 | 0.040 | 20.0 | 0 | 4099 | 100 | 37 | 0.2293 | 553,271 | 14,884 | 24,955 | | 1.68 | 139.1 |
| PP-25\hat{ } | 1 | A2 | 0.025 | 0.028 | 3895 | 205 | 70 | 58 | 0.2484 | 616,717 | 40,008 | 102,678 | 344,198 | 2.57 | 149.4 |
| PP-26\hat{ } | 1 | A2 | 0.025 | 0.028 | 3895 | 205 | 70 | 65 | 0.2853 | 632,049 | 37,553 | 99,587 | 312,650 | 2.65 | 149.2 |
| PP-27\hat{ } | 1 | A2 | 0.025 | 0.028 | 3895 | 205 | 70 | 60 | 0.2884 | 692,160 | 30,138 | 97,314 | 359,034 | 3.23 | 149.2 |
| PP-28\hat{ } | 1 | A2 | 0.025 | 0.028 | 3895 | 205 | 70 | 59 | 0.2882 | 703,403 | 40,622 | 100,552 | 317,574 | 2.48 | 149.2 |
| PP-29\hat{ } | 1 | A2 | 0.025 | 0.028 | 3895 | 205 | 100 | 60 | 0.1576 | 378,240 | 10,862 | 29,155 | 93,555 | 2.68 | 141.9 |
| PP-30\hat{ } | 1 | A2 | 0.025 | 0.028 | 3895 | 205 | 100 | 69 | 0.1839 | 383,791 | 15,984 | 34,278 | 101,935 | 2.14 | 141.9 |
| PP-31\hat{ } | 1 | A2 | 0.025 | 0.028 | 3895 | 205 | 100 | 60 | 0.1814 | 435,360 | 10,388 | 25,485 | 65,399 | 2.45 | 140.6 |
| PP-32\hat{ } | 1 | A2 | 0.025 | 0.028 | 3895 | 205 | 100 | 67 | 0.1917 | 412,012 | 12,392 | 27,291 | 71,587 | 2.20 | 141.2 |
| PP-33\hat{ } | 1 | A2 | 0.025 | 0.028 | 3895 | 205 | 115 | 83 | 0.1276 | 221,378 | 7,229 | 14,382 | 31,841 | 1.99 | 132.5 |
| PP-34\hat{ } | 1 | A2 | 0.025 | 0.028 | 3895 | 205 | 115 | 82 | 0.1677 | 294,498 | 7,383 | 12,967 | 27,008 | 1.76 | 131.0 |
| PP-35\hat{ } | 1 | A2 | 0.025 | 0.028 | 3895 | 205 | 115 | 85 | 0.1649 | 279,360 | 6,630 | 13,586 | 30,791 | 2.05 | 132.0 |
| PP-36\hat{ } | 1 | A2 | 0.040 | 0.044 | 3832 | 268 | 70 | 48 | 0.2829 | 536,021 | 33,703 | 67,834 | | 2.01 | 145.5 |
| PP-37\hat{ } | 1 | A2 | 0.040 | 0.044 | 3832 | 268 | 70 | 46 | 0.2796 | 544,675 | 36,789 | 75,683 | | 2.06 | 147.8 |
| PP-38\hat{ } | 1 | A2 | 0.040 | 0.044 | 3832 | 268 | 70 | 50 | 0.2781 | 505,636 | 39,099 | 76,511 | | 1.96 | 147.6 |
| PP-39\hat{ } | 1 | A2 | 0.040 | 0.044 | 3832 | 268 | 100 | 50 | 0.1909 | 342,934 | 13,384 | 23,792 | | 1.78 | 139.8 |
| PP-40\hat{ } | 1 | A2 | 0.040 | 0.044 | 3832 | 268 | 100 | 49 | 0.1900 | 352,577 | 12,469 | 23,421 | | 1.88 | 139.5 |
| PP-41\hat{ } | 1 | A2 | 0.040 | 0.044 | 3832 | 268 | 100 | 55 | 0.1550 | 254,562 | 13,970 | 25,557 | | 1.83 | 140.0 |
| PP-42 | 2 | A1 | 0.025 | 6.3 | 3966 | 134 | 70 | 159 | 0.1711 | 154,958 | 87,572 | 170,317 | 449,935 | 1.94 | 150.7 |
| PP-43 | 2 | A1 | 0.025 | 6.3 | 3966 | 134 | 70 | 157 | 0.1895 | 173,809 | 109,567 | 212,113 | 540,114 | 1.94 | 150.5 |
| PP-44 | 2 | A1 | 0.025 | 6.3 | 3966 | 134 | 100 | 258 | 0.0959 | 53,526 | 26,646 | 45,981 | 102,044 | 1.73 | 144.0 |
| PP-45 | 2 | A1 | 0.025 | 6.3 | 3966 | 134 | 100 | 264 | 0.1066 | 58,145 | 24,352 | 42,866 | 85,773 | 1.76 | 144.0 |
| PP-46 | 2 | A1 | 0.025 | 6.3 | 3966 | 134 | 115 | 422 | 0.0758 | 25,865 | 12,112 | 20,831 | 42,531 | 1.72 | 136.9 |
| PP-47 | 2 | A1 | 0.025 | 6.3 | 3966 | 134 | 115 | 380 | 0.0881 | 33,385 | 9,684 | 19,266 | 39,783 | 1.99 | 137.6 |
| PP-48 | 2 | A1 | 0.025 | 12.5 | 3882 | 217 | 70 | 95 | 0.2010 | 304,674 | 67,893 | 145,914 | 454,582 | 2.15 | 150.1 |
| PP-49 | 2 | A1 | 0.025 | 12.5 | 3882 | 217 | 70 | 108 | 0.2516 | 335,467 | 69,183 | 144,963 | 380,738 | 2.10 | 149.9 |
| PP-50 | 2 | A1 | 0.025 | 12.5 | 3882 | 217 | 100 | 155 | 0.1224 | 113,714 | 23,563 | 40,787 | 85,618 | 1.73 | 143.4 |
| PP-51 | 2 | A1 | 0.025 | 12.5 | 3882 | 217 | 100 | 178 | 0.1246 | 100,800 | 17,267 | 35,070 | 74,155 | 2.03 | 142.0 |
| PP-52 | 2 | A1 | 0.025 | 12.5 | 3882 | 217 | 115 | 239 | 0.1130 | 68,084 | 9,722 | 20,466 | 48,941 | 2.11 | 137.1 |
| PP-53 | 2 | A1 | 0.025 | 12.5 | 3882 | 217 | 115 | 222 | 0.1108 | 71,870 | 11,664 | 20,501 | 42,519 | 1.76 | 137.3 |
| PP-54 | 2 | A2 | 0.025 | 0.028 | 3895 | 205 | 70 | 43 | 0.2999 | 1,004,316 | 31,730 | 101,939 | 409,205 | 3.21 | 148.5 |
| PP-55 | 2 | A2 | 0.025 | 0.028 | 3895 | 205 | 70 | 42 | 0.2827 | 969,257 | 34,279 | 98,101 | 341,492 | 2.86 | 148.5 |
| PP-56 | 2 | A2 | 0.025 | 0.028 | 3895 | 205 | 70 | 44 | 0.2892 | 946,473 | 20,956 | 86,767 | 342,840 | 4.14 | 147.7 |
| PP-57 | 2 | A2 | 0.025 | 0.028 | 3895 | 205 | 70 | 44 | 0.2938 | 961,527 | 34,938 | 90,382 | 278,276 | 2.59 | 148.2 |
| PP-58 | 2 | A2 | 0.025 | 0.028 | 3895 | 205 | 100 | 52 | 0.2071 | 573,508 | 9,907 | 25,542 | 69,194 | 2.58 | 140.3 |
| PP-59 | 2 | A2 | 0.025 | 0.028 | 3895 | 205 | 100 | 48 | 0.2015 | 604,500 | 9,076 | 25,320 | 68,732 | 2.79 | 139.9 |
| PP-60 | 2 | A2 | 0.025 | 0.028 | 3895 | 205 | 100 | 52 | 0.2116 | 585,969 | 13,403 | 27,474 | 67,817 | 2.05 | 139.6 |
| PP-61 | 2 | A2 | 0.025 | 0.028 | 3895 | 205 | 100 | 50 | 0.2073 | 597,024 | 10,174 | 27,033 | 74,038 | 2.66 | 139.9 |
| PP-62 | 2 | A2 | 0.025 | 0.028 | 3895 | 205 | 115 | 69 | 0.1234 | 257,530 | 5,593 | 13,888 | 34,333 | 2.48 | 132.0 |
| PP-63 | 2 | A2 | 0.025 | 0.028 | 3895 | 205 | 115 | 76 | 0.1614 | 305,811 | 6,106 | 14,072 | 38,441 | 2.30 | 132.2 |
| PP-64 | 2 | A2 | 0.025 | 0.028 | 3895 | 205 | 115 | 86 | 0.1523 | 255,014 | 6,300 | 11,834 | 25,798 | 1.88 | 131.5 |
| PP-65 | 2 | A2 | 0.025 | 0.028 | 3895 | 205 | 115 | 84 | 0.1728 | 296,229 | 5,363 | 12,421 | 29,892 | 2.32 | 130.7 |
| PP-66 | 3A | A1 | 0.040 | 20.0 | 0 | 4099 | 70 | 245 | 0.1174 | 43,127 | 57,722 | 98,230 | 205,283 | 1.70 | 147.1 |
| PP-67 | 3A | A1 | 0.040 | 20.0 | 0 | 4099 | 70 | 248 | 0.1209 | 43,875 | 56,453 | 104,606 | 229,033 | 1.85 | 147.3 |
| PP-68 | 3A | A1 | 0.040 | 20.0 | 0 | 4099 | 70 | 251 | 0.1071 | 38,402 | 56,677 | 108,587 | 245,091 | 1.92 | 147.3 |
| PP-69 | 3A | A1 | 0.040 | 20.0 | 0 | 4099 | 100 | 173 | 0.1056 | 54,936 | 10,731 | 20,193 | 44,788 | 1.88 | 135.2 |
| PP-70 | 3A | A1 | 0.040 | 20.0 | 0 | 4099 | 100 | 163 | 0.1069 | 59,025 | 11,547 | 21,042 | 45,502 | 1.82 | 135.9 |
| PP-71 | 3A | A1 | 0.040 | 20.0 | 0 | 4099 | 100 | 162 | 0.1012 | 56,222 | 10,479 | 19,300 | 39,145 | 1.84 | 135.7 |
| PP-72\hat{ } | 3A | A2 | 0.025 | 0.028 | 3895 | 205 | 70 | 179 | 0.1164 | 93,640 | 49,683 | 102,567 | 251,501 | 2.06 | 148.7 |
| PP-73\hat{ } | 3A | A2 | 0.025 | 0.028 | 3895 | 205 | 70 | 144 | 0.1709 | 170,900 | 41,116 | 92,549 | 237,525 | 2.25 | 146.9 |
| PP-74\hat{ } | 3A | A2 | 0.025 | 0.028 | 3895 | 205 | 70 | 149 | 0.1492 | 144,193 | 48,558 | 100,063 | 256,818 | 2.06 | 147.5 |
| PP-75\hat{ } | 3A | A2 | 0.025 | 0.028 | 3895 | 205 | 100 | 810 | 0.0782 | 13,902 | 10,920 | 22,643 | 51,782 | 2.07 | 134.9 |
| PP-76\hat{ } | 3A | A2 | 0.025 | 0.028 | 3895 | 205 | 100 | 119 | 0.0924 | 111,812 | 9,535 | 18,432 | 39,669 | 1.93 | 133.2 |
| PP-77\hat{ } | 3A | A2 | 0.025 | 0.028 | 3895 | 205 | 100 | 553 | 0.0664 | 17,290 | 8,916 | 21,831 | 57,091 | 2.45 | 134.7 |
| PP-78 | 3B | A1 | 0.040 | 20.0 | 0 | 4099 | 70 | 1801 | 0.0554 | 2,768 | 61,190 | 114,545 | 235,446 | 1.87 | 145.9 |
| PP-79 | 3B | A1 | 0.040 | 20.0 | 0 | 4099 | 70 | 1800 | 0.0465 | 2,325 | 66,223 | 123,116 | 287,941 | 1.86 | 146.6 |
| PP-80 | 3B | A1 | 0.040 | 20.0 | 0 | 4099 | 70 | 1801 | 0.0346 | 1,729 | 64,765 | 117,068 | 251,106 | 1.81 | 147.0 |
| PP-81 | 3B | A1 | 0.040 | 20.0 | 0 | 4099 | 100 | 1783 | 0.0560 | 2,827 | 12,876 | 25,017 | 55,705 | 1.94 | 135.7 |
| PP-82 | 3B | A1 | 0.040 | 20.0 | 0 | 4099 | 100 | 1711 | 0.0602 | 3,167 | 11,123 | 22,869 | 49,963 | 2.06 | 135.9 |
| PP-83 | 3B | A1 | 0.040 | 20.0 | 0 | 4099 | 100 | 1678 | 0.0545 | 2,923 | 12,207 | 23,573 | 53,380 | 1.93 | 136.5 |
| PP-84 | 4 | A1 | 0.040 | 20.0 | 0 | 4099 | 70 | 58 | 0.2734 | 424,241 | 24,785 | 57,033 | 156,481 | 2.30 | 145.2 |
| PP-85 | 4 | A1 | 0.040 | 20.0 | 0 | 4099 | 70 | 63 | 0.2944 | 420,571 | 26,827 | 67,396 | 208,805 | 2.51 | 145.3 |
| PP-86 | 4 | A1 | 0.040 | 20.0 | 0 | 4099 | 70 | 66 | 0.3001 | 409,227 | 23,764 | 63,265 | 207,005 | 2.66 | 145.3 |
| PP-87 | 4 | A1 | 0.040 | 20.0 | 0 | 4099 | 100 | 58 | 0.1897 | 294,362 | 8,101 | 21,356 | 64,145 | 2.64 | 136.2 |
| PP-88 | 4 | A1 | 0.040 | 20.0 | 0 | 4099 | 100 | 50 | 0.1827 | 328,860 | 8,993 | 21,010 | 54,745 | 2.34 | 135.8 |
| PP-89 | 4 | A1 | 0.040 | 20.0 | 0 | 4099 | 100 | 52 | 0.1891 | 327,288 | 8,781 | 19,808 | 53,196 | 2.26 | 137.2 |
| PP-90 | 5A | A1 | 0.040 | 20.0 | 0 | 4099 | 70 | 489 | 0.0860 | 15,828 | 38,652 | 73,819 | 166,945 | 1.91 | 145.0 |
| PP-91 | 5A | A1 | 0.040 | 20.0 | 0 | 4099 | 70 | 557 | 0.0834 | 13,476 | 39,007 | 80,318 | 197,424 | 2.06 | 145.1 |
| PP-92 | 5A | A1 | 0.040 | 20.0 | 0 | 4099 | 70 | 554 | 0.0789 | 12,818 | 32,459 | 69,118 | 166,165 | 2.13 | 144.0 |
| PP-93 | 5A | A1 | 0.040 | 20.0 | 0 | 4099 | 100 | 250 | 0.0837 | 30,132 | 8,788 | 16,217 | 34,084 | 1.85 | 130.5 |
| PP-94 | 5A | A1 | 0.040 | 20.0 | 0 | 4099 | 100 | 230 | 0.0886 | 34,670 | 9,160 | 17,161 | 40,331 | 1.87 | 130.4 |
| PP-95 | 5A | A1 | 0.040 | 20.0 | 0 | 4099 | 100 | 220 | 0.0879 | 35,959 | 8,365 | 16,578 | 38,574 | 1.98 | 131.1 |
| PP-96 | 5B | A1 | 0.040 | 20.0 | 0 | 4099 | 70 | 1801 | 0.0695 | 3,473 | 32,586 | 70,138 | 171,378 | 2.15 | 143.5 |
| PP-97 | 5B | A1 | 0.040 | 20.0 | 0 | 4099 | 70 | 1802 | 0.0654 | 3,266 | 35,907 | 78,685 | 214,011 | 2.19 | 144.3 |
| PP-98 | 5B | A1 | 0.040 | 20.0 | 0 | 4099 | 70 | 1801 | 0.0628 | 3,138 | 37,862 | 81,985 | 211,545 | 2.17 | 144.4 |
| PP-99 | 5B | A1 | 0.040 | 20.0 | 0 | 4099 | 100 | 575 | 0.0617 | 9,657 | 7,461 | 15,144 | 34,412 | 2.03 | 129.6 |
| PP-100 | 5B | A1 | 0.040 | 20.0 | 0 | 4099 | 100 | 524 | 0.0653 | 11,216 | 8,197 | 15,777 | 38,109 | 1.92 | 129.7 |
| PP-101 | 5B | A1 | 0.040 | 20.0 | 0 | 4099 | 100 | 683 | 0.0590 | 7,775 | 7,573 | 15,309 | 37,978 | 2.02 | 130.3 |
| PP-102 | 6 | A1 | 0.040 | 20.0 | 0 | 4099 | 70 | 1800 | 0.0246 | 1,230 | 14,997 | 24,237 | 45,568 | 1.62 | |
| PP-103 | 6 | A1 | 0.040 | 20.0 | 0 | 4099 | 70 | 1804 | 0.0219 | 1,093 | 16,700 | 26,555 | 50,442 | 1.59 | |
| PP-104 | 6 | A1 | 0.040 | 20.0 | 0 | 4099 | 70 | 1800 | 0.0237 | 1,185 | 15,697 | 24,988 | 46,766 | 1.59 | |
| PP-105 | 6 | A1 | 0.040 | 20.0 | 0 | 4099 | 100 | 1758 | 0.0497 | 2,544 | 8,306 | 13,667 | 27,522 | 1.65 | |
| PP-106 | 6 | A1 | 0.040 | 20.0 | 0 | 4099 | 100 | 1714 | 0.0498 | 2,615 | 8,043 | 13,727 | 28,344 | 1.71 | |
| PP-107 | 6 | A1 | 0.040 | 20.0 | 0 | 4099 | 100 | 1754 | 0.0510 | 2,617 | 8,767 | 14,001 | 26,605 | 1.60 | |
| PP-108 | 7 | A1 | 0.040 | 20.0 | 0 | 4099 | 70 | 1801 | 0.0013 | 65 | | | | | |
| PP-109 | 7 | A1 | 0.040 | 20.0 | 0 | 4099 | 70 | 1800 | 0.0012 | 60 | | | | | |
| PP-110 | 7 | A1 | 0.040 | 20.0 | 0 | 4099 | 70 | 1801 | 0.0010 | 50 | | | | | |
| PP-111 | 7 | A1 | 0.040 | 20.0 | 0 | 4099 | 100 | 1800 | 0.0079 | 395 | | | | | |
| PP-112 | 7 | A1 | 0.040 | 20.0 | 0 | 4099 | 100 | 1801 | 0.0098 | 490 | | | | | |
| PP-113 | 7 | A1 | 0.040 | 20.0 | 0 | 4099 | 100 | 1801 | 0.0116 | 580 | 7,904 | 13,577 | 33,079 | 1.72 | |
| PP-114 | 8A | A1 | 0.040 | 20.0 | 0 | 4099 | 70 | 316 | 0.0950 | 27,057 | 105,386 | 193,074 | 416,443 | 1.83 | 145.5 |
| PP-115 | 8A | A1 | 0.040 | 20.0 | 0 | 4099 | 70 | 329 | 0.1077 | 29,462 | 96,254 | 195,966 | 447,940 | 2.04 | 145.5 |
| PP-116 | 8A | A1 | 0.040 | 20.0 | 0 | 4099 | 70 | 354 | 0.1036 | 26,339 | 119,008 | 221,502 | 506,007 | 1.86 | 145.3 |
| PP-117 | 8A | A1 | 0.040 | 20.0 | 0 | 4099 | 100 | 196 | 0.0970 | 44,541 | 19,828 | 44,258 | 101,837 | 2.23 | 141.8 |
| PP-118 | 8A | A1 | 0.040 | 20.0 | 0 | 4099 | 100 | 181 | 0.0905 | 45,000 | 20,995 | 49,716 | 132,487 | 2.37 | 142.2 |
| PP-119 | 8A | A1 | 0.040 | 20.0 | 0 | 4099 | 100 | 186 | 0.1006 | 48,677 | 18,215 | 46,804 | 148,166 | 2.57 | 141.8 |
| PP-120 | 8B | A1 | 0.040 | 20.0 | 0 | 4099 | 70 | 92 | 0.3173 | 310,402 | 24,569 | 58,146 | 169,220 | 2.37 | |
| PP-121 | 8B | A1 | 0.040 | 20.0 | 0 | 4099 | 70 | 91 | 0.2814 | 278,308 | 21,197 | 54,911 | 161,480 | 2.59 | |
| PP-122 | 8B | A1 | 0.040 | 20.0 | 0 | 4099 | 70 | 97 | 0.2600 | 241,237 | 26,210 | 62,823 | 182,863 | 2.40 | |
| PP-123 | 8B | A1 | 0.040 | 20.0 | 0 | 4099 | 100 | 60 | 0.1620 | 243,000 | 6,250 | 14,605 | 38,951 | 2.34 | |
| PP-124 | 8B | A1 | 0.040 | 20.0 | 0 | 4099 | 100 | 54 | 0.1641 | 273,500 | 7,064 | 14,228 | 36,201 | 2.01 | |
| PP-125 | 8B | A1 | 0.040 | 20.0 | 0 | 4099 | 100 | 57 | 0.1588 | 250,737 | 6,857 | 14,248 | 35,305 | 2.08 | |
| PP-126 | 9 | A1 | 0.040 | 20.0 | 0 | 4099 | 70 | 147 | 0.2262 | 138,490 | 29,027 | 67,960 | 164,985 | 2.34 | 145.3 |
| PP-127 | 9 | A1 | 0.040 | 20.0 | 0 | 4099 | 70 | 155 | 0.2072 | 120,310 | 36,145 | 79,185 | 192,248 | 2.19 | 145.0 |
| PP-128 | 9 | A1 | 0.040 | 20.0 | 0 | 4099 | 70 | 153 | 0.2153 | 126,647 | 36,754 | 74,004 | 186,610 | 2.01 | 145.8 |
| PP-129 | 9 | A1 | 0.040 | 20.0 | 0 | 4099 | 100 | 73 | 0.1794 | 221,178 | 13,229 | 23,333 | 51,809 | 1.76 | 139.0 |
| PP-130 | 9 | A1 | 0.040 | 20.0 | 0 | 4099 | 100 | 71 | 0.1809 | 229,310 | 12,897 | 22,665 | 46,572 | 1.76 | 138.8 |
| PP-131 | 9 | A1 | 0.040 | 20.0 | 0 | 4099 | 100 | 73 | 0.1842 | 227,096 | 11,445 | 21,964 | 48,152 | 1.92 | 138.7 |
| PP-132 | 10 | A1 | 0.040 | 20.0 | 0 | 4099 | 70 | 976 | 0.0705 | 6,501 | 179,918 | 344,263 | 726,180 | 1.91 | |
| PP-133 | 10 | A1 | 0.040 | 20.0 | 0 | 4099 | 70 | 998 | 0.0779 | 7,025 | 231,181 | 416,536 | 862,726 | 1.80 | |
| PP-134 | 10 | A1 | 0.040 | 20.0 | 0 | 4099 | 70 | 1055 | 0.0682 | 5,818 | 194,257 | 380,417 | 789,714 | 1.96 | |
| PP-135 | 10 | A1 | 0.040 | 20.0 | 0 | 4099 | 100 | 1800 | 0.0263 | 1,315 | 66,888 | 122,296 | 276,283 | 1.83 | |
| PP-136 | 10 | A1 | 0.040 | 20.0 | 0 | 4099 | 100 | 1800 | 0.0468 | 2,340 | 79,731 | 146,283 | 318,989 | 1.83 | |
| PP-137 | 10 | A1 | 0.040 | 20.0 | 0 | 4099 | 100 | 1801 | 0.0427 | 2,134 | 67,560 | 128,907 | 265,058 | 1.91 | |
| PP-138 | 10 | A2 | 0.025 | 0.028 | 3840 | 260 | 70 | 113 | 0.1256 | 160,057 | 130,530 | 240,267 | 591,216 | 1.84 | |
| PP-139 | 10 | A2 | 0.025 | 0.028 | 3840 | 260 | 70 | 102 | 0.1292 | 182,400 | 149,527 | 235,779 | 444,953 | 1.58 | |
| PP-140 | 10 | A2 | 0.025 | 0.028 | 3840 | 260 | 70 | 115 | 0.1286 | 161,030 | 127,865 | 218,514 | 424,359 | 1.71 | |
| PP-141 | 10 | A2 | 0.025 | 0.028 | 3840 | 260 | 100 | 711 | 0.0764 | 15,473 | 49,156 | 80,406 | 182,219 | 1.64 | |
| PP-142 | 10 | A2 | 0.025 | 0.028 | 3840 | 260 | 100 | 787 | 0.0769 | 14,071 | 39,722 | 75,250 | 177,899 | 1.89 | |
| PP-143 | 10 | A2 | 0.025 | 0.028 | 3840 | 260 | 100 | 1702 | 0.0709 | 5,999 | 49,554 | 80,944 | 190,917 | 1.63 | |
| PP-144 | 11 | A1 | 0.040 | 20.0 | 0 | 4099 | 70 | 1568 | 0.0731 | 4,196 | 176,898 | 273,232 | 520,381 | 1.54 | |
| PP-145 | 11 | A1 | 0.040 | 20.0 | 0 | 4099 | 70 | 1480 | 0.0770 | 4,682 | 164,141 | 292,666 | 646,334 | 1.78 | |
| PP-146 | 11 | A1 | 0.040 | 20.0 | 0 | 4099 | 70 | 1455 | 0.0735 | 4,546 | 159,778 | 266,147 | 572,353 | 1.67 | |
| PP-147 | 11 | A1 | 0.040 | 20.0 | 0 | 4099 | 100 | 1801 | 0.0352 | 1,759 | 61,891 | 110,882 | 226,997 | 1.79 | |
| PP-148 | 11 | A1 | 0.040 | 20.0 | 0 | 4099 | 100 | 1801 | 0.0370 | 1,849 | 70,467 | 110,673 | 218,322 | 1.57 | |
| PP-149 | 11 | A1 | 0.040 | 20.0 | 0 | 4099 | 100 | 1800 | 0.0379 | 1,895 | 64,187 | 108,777 | 212,755 | 1.69 | |
| PP-150 | 11 | A2 | 0.040 | 0.044 | 3664 | 436 | 70 | 63 | 0.1831 | 261,571 | 103,450 | 210,435 | 523,513 | 2.03 | |
| PP-151 | 11 | A2 | 0.040 | 0.044 | 3664 | 436 | 70 | 75 | 0.1922 | 230,640 | 115,561 | 214,595 | 497,006 | 1.86 | |
| PP-152 | 11 | A2 | 0.040 | 0.044 | 3664 | 436 | 70 | 70 | 0.1948 | 250,457 | 111,993 | 197,394 | 431,961 | 1.76 | |
| PP-153 | 11 | A2 | 0.040 | 0.044 | 3664 | 436 | 100 | 155 | 0.1151 | 66,832 | 44,110 | 81,304 | 175,936 | 1.84 | |
| PP-154 | 11 | A2 | 0.040 | 0.044 | 3664 | 436 | 100 | 109 | 0.1303 | 107,587 | 44,588 | 74,870 | 148,058 | 1.68 | |
| PP-155 | 11 | A2 | 0.040 | 0.044 | 3664 | 436 | 100 | 1801 | 0.0613 | 3,063 | 58,334 | 95,750 | 193,527 | 1.64 | |
| PP-156 | 12 | A1 | 0.04 | 20.0 | 0 | 4099 | 70 | 413 | 0.1006 | 21,923 | 272,742 | 514,199 | 1,066,554 | 1.89 | |
| PP-157 | 12 | A1 | 0.04 | 20.0 | 0 | 4099 | 70 | 437 | 0.0917 | 18,886 | 314,483 | 526,360 | 1,047,961 | 1.67 | |
| PP-158 | 12 | A1 | 0.04 | 20.0 | 0 | 4099 | 70 | 454 | 0.0832 | 16,493 | 300,705 | 514,613 | 1,015,631 | 1.71 | |
| PP-159 | 12 | A1 | 0.04 | 20.0 | 0 | 4099 | 100 | 1800 | 0.0420 | 2,100 | 79,443 | 154,366 | 344,554 | 1.94 | |
| PP-160 | 12 | A1 | 0.04 | 20.0 | 0 | 4099 | 100 | 1649 | 0.0493 | 2,691 | 79,222 | 148,102 | 315,225 | 1.87 | |
| PP-161 | 12 | A1 | 0.04 | 20.0 | 0 | 4099 | 100 | 1619 | 0.0519 | 2,885 | 80,104 | 153,638 | 321,559 | 1.92 | |
| PP-162 | 12 | A2 | 0.025 | 0.028 | 3840 | 260 | 70 | 144 | 0.1271 | 127,100 | 146,274 | 261,373 | 606,532 | 1.79 | |
| PP-163 | 12 | A2 | 0.025 | 0.028 | 3840 | 260 | 70 | 132 | 0.1238 | 135,055 | 180,734 | 281,069 | 543,122 | 1.56 | |
| PP-164 | 12 | A2 | 0.025 | 0.028 | 3840 | 260 | 70 | 137 | 0.1254 | 131,807 | 149,649 | 244,498 | 469,730 | 1.63 | |
| PP-165 | 12 | A2 | 0.025 | 0.028 | 3840 | 260 | 100 | 712 | 0.0756 | 15,290 | 57,677 | 85,558 | 164,451 | 1.48 | |
| PP-166 | 12 | A2 | 0.025 | 0.028 | 3840 | 260 | 100 | 700 | 0.0820 | 16,869 | 48,751 | 75,075 | 143,885 | 1.54 | |
| PP-167 | 12 | A2 | 0.025 | 0.028 | 3840 | 260 | 100 | 599 | 0.0830 | 19,953 | 49,727 | 83,195 | 169,523 | 1.67 | |
| CPP-1 | C-1 | A1 | 0.040 | 20.0 | 3855 | 244 | 70 | 222 | 0.1960 | 79,388 | 45,283 | 69,769 | | 1.54 | 138.9 |
| CPP-1 | C-1 | A1 | 0.040 | 20.0 | 3855 | 244 | 70 | 218 | 0.2065 | 85,174 | 45,268 | 76,417 | | 1.69 | 139.6 |
| CPP-2 | C-1 | A1 | 0.040 | 20.0 | 3855 | 244 | 70 | 221 | 0.2139 | 87,148 | 43,514 | 82,148 | | 1.89 | 139.4 |
| CPP-3 | C-1 | A1 | 0.040 | 20.0 | 3855 | 244 | 70 | 254 | 0.2094 | 74,285 | 51,959 | 83,269 | | 1.60 | 139.0 |
| CPP-4 | C-1 | A1 | 0.040 | 20.0 | 3855 | 244 | 70 | 261 | 0.2027 | 69,843 | 54,266 | 89,156 | | 1.64 | 139.9 |
| CPP-5 | C-1 | A1 | 0.040 | 20.0 | 3855 | 244 | 70 | 273 | 0.2141 | 70,660 | 50,773 | 85,255 | | 1.68 | 140.1 |
| CPP-6 | C-1 | A1 | 0.040 | 20.0 | 3855 | 244 | 100 | 160 | 0.1668 | 94,119 | 12,023 | 19,678 | | 1.64 | 122.4 |
| CPP-7 | C-1 | A1 | 0.040 | 20.0 | 3855 | 244 | 100 | 157 | 0.1661 | 95,338 | 11,190 | 19,341 | | 1.73 | 122.8 |
| CPP-8 | C-1 | A1 | 0.040 | 20.0 | 3855 | 244 | 100 | 157 | 0.1574 | 90,518 | 11,918 | 18,759 | | 1.57 | 121.1 |
| CPP-9 | C-1 | A1 | 0.040 | 20.0 | 3855 | 244 | 100 | 200 | 0.1713 | 77,085 | 15,270 | 24,829 | | 1.63 | 122.7 |
| CPP-10 | C-1 | A1 | 0.040 | 20.0 | 3855 | 244 | 100 | 205 | 0.1758 | 77,180 | 14,066 | 23,972 | | 1.70 | 122.6 |
| CPP-11 | C-1 | A1 | 0.040 | 20.0 | 3855 | 244 | 100 | 191 | 0.1679 | 79,323 | 14,333 | 24,032 | | 1.68 | 121.2 |
| CPP-12 | C-2 | A2 | 0.020 | 0.022 | 3862 | 238 | 70 | 30 | 0.2001 | 1,200,600 | 24,089 | 53,046 | 150,998 | 2.20 | 135.1 |
| CPP-13 | C-2 | A2 | 0.020 | 0.022 | 3862 | 238 | 70 | 25 | 0.1165 | 838,800 | 18,708 | 44,446 | 135,961 | 2.38 | 135.1 |
| CPP-14 | C-2 | A2 | 0.020 | 0.022 | 3862 | 238 | 70 | 34 | 0.2208 | 1,168,941 | 23,678 | 45,798 | 119,631 | 1.93 | 134.2 |
| CPP-15 | C-2 | A2 | 0.020 | 0.022 | 3862 | 238 | 100 | 47 | 0.1455 | 557,234 | 9,105 | 15,665 | 32,931 | 1.72 | 116.7 |
| CPP-16 | C-2 | A2 | 0.020 | 0.022 | 3862 | 238 | 100 | 43 | 0.1340 | 560,930 | 9,907 | 16,663 | 33,136 | 1.68 | 121.1 |
| CPP-17 | C-2 | A2 | 0.020 | 0.022 | 3862 | 238 | 100 | 52 | 0.1902 | 658,385 | 7,980 | 13,996 | 31,381 | 1.75 | 115 |
| CPP-18 | C-3 | A2 | 0.020 | 0.022 | 3895 | 205 | 70 | 29 | 0.2584 | 1,626,294 | 37702 | 104549 | | 2.77 | 136.2 |
| CPP-19 | C-3 | A2 | 0.020 | 0.022 | 3895 | 205 | 70 | 30 | 0.2677 | 1,600,864 | 38391 | 101847 | | 2.65 | 135.7 |
| CPP-20 | C-3 | A2 | 0.020 | 0.022 | 3895 | 205 | 70 | 28 | 0.2667 | 1,733,069 | 32292 | 88904 | | 2.75 | 135.5 |
| CPP-21 | C-3 | A2 | 0.020 | 0.022 | 3895 | 205 | 100 | 20 | 0.1782 | 1,611,859 | 11319 | 24760 | | 2.19 | 125.6 |
| CPP-22 | C-3 | A2 | 0.020 | 0.022 | 3895 | 205 | 100 | 18 | 0.1779 | 1,809,153 | 10423 | 22751 | | 2.18 | 120.9 |
| CPP-23 | C-3 | A2 | 0.020 | 0.022 | 3895 | 205 | 100 | 23 | 0.1952 | 1,554,690 | 9541 | 19708 | | 2.07 | 120.2 |
| CPP-24 | C-4 | A2 | 0.040 | 0.044 | 3810 | 290 | 70 | 48 | 0.2438 | 453,347 | 83624 | 137954 | | 1.65 | |
| CPP-25 | C-4 | A2 | 0.040 | 0.044 | 3810 | 290 | 70 | 56 | 0.2753 | 444,032 | 85151 | 144988 | | 1.70 | |
| CPP-26 | C-4 | A2 | 0.040 | 0.044 | 3810 | 290 | 70 | 50 | 0.2538 | 455,020 | 86254 | 143125 | | 1.66 | |
| CPP-27 | C-4 | A2 | 0.040 | 0.044 | 3810 | 290 | 100 | 69 | 0.1548 | 202,795 | 38487 | 60404 | | 1.57 | |
| CPP-28 | C-4 | A2 | 0.040 | 0.044 | 3810 | 290 | 100 | 71 | 0.1497 | 190,566 | 37002 | 57855 | | 1.56 | |
| CPP-29 | C-4 | A2 | 0.040 | 0.044 | 3810 | 290 | 100 | 71 | 0.1483 | 186,933 | 35653 | 55936 | | 1.57 | |
| CPP-30 | C-4 | A1 | 0.040 | 20.0 | 0 | 4099 | 70 | 341 | 0.0619 | 16,361 | 332919 | 548768 | | 1.65 | |
| CPP-31 | C-4 | A1 | 0.040 | 20.0 | 0 | 4099 | 70 | 335 | 0.0502 | 13,470 | 353143 | 586456 | | 1.66 | |
| CPP-32 | C-4 | A1 | 0.040 | 20.0 | 0 | 4099 | 70 | 358 | 0.0766 | 19,257 | 353967 | 589856 | | 1.67 | |
| CPP-33 | C-4 | A1 | 0.040 | 20.0 | 0 | 4099 | 100 | 1010 | 0.0496 | 4,421 | 81625 | 136792 | | 1.68 | |
| CPP-34 | C-4 | A1 | 0.040 | 20.0 | 0 | 4099 | 100 | 1268 | 0.0472 | 3,350 | 75705 | 127705 | | 1.69 | |
| CPP-35 | C-4 | A1 | 0.040 | 20.0 | 0 | 4099 | 100 | 854 | 0.0515 | 5,428 | 86874 | 143796 | | 1.66 | |

TABLE 4
¹³C NMR data for select small scale polypropylene examples

| | | | | | | | | | | | | | 2,1- | | |
|---|---|---|---|---|---|---|---|---|---|---|---|---|---|---|---|
| | | | | | | | | | | | | | regio | 1,3- | |
| | | | | | | | | | | | | stereo | (ee) | regio | ave. |
| | | | | | | | | | | | | defects/ | defects/ | defects/ | meso |
| | | | | | | | mmrm + | | | | | 10000 | 10000 | 10000 | run |
| EX# | m | r | mmmm | mmmr | rmmr | mmrr | rmrr | rmrm | rrrr | mrrr | mrrm | monomer | monomer** | monomer | length |
| PP-7 | 0.986 | 0.014 | 0.939 | 0.037 | 0.005 | 0.001 | 0.003 | 0.004 | 0.002 | 0.001 | 0.006 | 40.4 | 53.7 | 11.4 | 94.8 |
| PP-10 | 0.971 | 0.029 | 0.904 | 0.051 | 0.006 | 0.003 | 0.008 | 0.009 | 0.005 | 0.003 | 0.012 | 96.1 | 31.5 | 39.2 | 60.0 |
| PP-14 | 0.979 | 0.021 | 0.951 | 0.008 | 0.005 | 0.018 | 0.009 | 0.003 | 0.000 | 0.001 | 0.006 | 147.7 | 43.8 | 6.3 | 50.6 |
| PP-15/16* | 0.992 | 0.008 | 0.976 | 0.006 | 0.003 | 0.008 | 0.003 | 0.002 | 0.000 | 0.000 | 0.001 | 64.3 | 41.7 | 19.6 | 79.6 |
| PP-17/18* | 0.939 | 0.061 | 0.882 | 0.015 | 0.006 | 0.032 | 0.021 | 0.019 | 0.003 | 0.004 | 0.018 | 341.8 | 35.0 | 47.4 | 23.6 |
| PP-20 | 0.974 | 0.026 | 0.894 | 0.058 | 0.015 | 0.002 | 0.000 | 0.009 | 0.004 | 0.003 | 0.013 | 60.2 | 45.8 | 36.1 | 70.4 |
| PP-24 | 0.933 | 0.067 | 0.839 | 0.061 | 0.018 | 0.013 | 0.009 | 0.008 | 0.014 | 0.007 | 0.031 | 147.0 | 0.0 | 71.6 | 45.7 |
| PP-28 | 0.969 | 0.031 | 0.943 | 0.007 | 0.001 | 0.016 | 0.014 | 0.006 | 0.001 | 0.006 | 0.006 | 179.5 | 31.9 | 15.1 | 44.2 |
| PP-29 | 0.948 | 0.052 | 0.902 | 0.016 | 0.002 | 0.030 | 0.019 | 0.009 | 0.002 | 0.003 | 0.017 | 280.7 | 22.6 | 37.5 | 29.3 |
| PP-34 | 0.914 | 0.086 | 0.833 | 0.024 | 0.007 | 0.049 | 0.030 | 0.021 | 0.005 | 0.006 | 0.025 | 471.8 | 15.2 | 52.2 | 18.5 |
| PP-37 | 0.976 | 0.024 | 0.879 | 0.070 | 0.014 | 0.018 | 0.001 | 0.005 | 0.004 | 0.001 | 0.007 | 118.3 | 33.6 | 25.1 | 56.5 |
| PP-40 | 0.951 | 0.049 | 0.806 | 0.103 | 0.018 | 0.035 | 0.001 | 0.010 | 0.010 | 0.002 | 0.015 | 219.8 | 25.3 | 50.5 | 33.8 |
| PP-48 | 0.979 | 0.021 | 0.955 | 0.006 | 0.005 | 0.016 | 0.009 | 0.003 | 0.000 | 0.001 | 0.006 | 133.2 | 41.6 | 5.6 | 55.4 |
| PP-50/51* | 0.976 | 0.024 | 0.951 | 0.010 | 0.001 | 0.020 | 0.006 | 0.003 | 0.000 | 0.001 | 0.009 | 139.3 | 34.6 | 25.8 | 50.1 |
| PP-52/53* | 0.930 | 0.046 | 0.879 | 0.019 | 0.007 | 0.035 | 0.000 | 0.017 | 0.002 | 0.005 | 0.013 | 364.9 | 26.3 | 50.9 | 22.6 |
| PP-57 | 0.978 | 0.022 | 0.954 | 0.008 | 0.003 | 0.015 | 0.007 | 0.003 | 0.000 | 0.001 | 0.008 | 128.0 | 34.4 | 14.7 | 56.5 |
| PP-58 | 0.926 | 0.074 | 0.858 | 0.019 | 0.006 | 0.036 | 0.035 | 0.017 | 0.004 | 0.005 | 0.021 | 425.1 | 22.0 | 0.0 | 22.4 |
| PP-65 | 0.923 | 0.077 | 0.826 | 0.050 | 0.006 | 0.042 | 0.021 | 0.019 | 0.005 | 0.006 | 0.025 | 387.3 | 17.9 | 74.9 | 20.8 |
| PP-66/67 | 0.966 | 0.034 | 0.918 | 0.025 | 0.008 | 0.023 | 0.005 | 0.003 | 0.002 | 0.003 | 0.014 | 153.8 | 26.0 | 19.8 | 50.1 |
| PP-69/ | 0.935 | 0.065 | 0.844 | 0.049 | 0.009 | 0.047 | 0.009 | 0.011 | 0.002 | 0.005 | 0.025 | 320.2 | 8.2 | 50.2 | 26.4 |
| 70/71* | | | | | | | | | | | | | | | |
| PP-73 | 0.967 | 0.033 | 0.922 | 0.025 | 0.004 | 0.026 | 0.005 | 0.003 | 0.001 | 0.001 | 0.014 | 170.4 | | | 58.7 |
| PP-75/ | 0.936 | 0.064 | 0.857 | 0.041 | 0.006 | 0.046 | 0.011 | 0.009 | 0.002 | 0.003 | 0.025 | 324.9 | | | 30.8 |
| 76/77* | | | | | | | | | | | | | | | |
| PP-84 | 0.971 | 0.029 | 0.933 | 0.017 | 0.006 | 0.022 | 0.004 | 0.004 | 0.001 | 0.002 | 0.011 | 144.0 | 34.7 | 42.0 | 45.3 |
| PP-88 | 0.927 | 0.073 | 0.849 | 0.029 | 0.010 | 0.043 | 0.019 | 0.016 | 0.004 | 0.006 | 0.025 | 374.0 | 19.0 | 58.5 | 22.1 |
| PP-90/ | 0.962 | 0.038 | 0.912 | 0.025 | 0.008 | 0.028 | 0.005 | 0.003 | 0.001 | 0.003 | 0.016 | 180.2 | 13.2 | 19.6 | 46.9 |
| 91/92* | | | | | | | | | | | | | | | |
| PP-93/ | 0.931 | 0.069 | 0.849 | 0.041 | 0.007 | 0.050 | 0.009 | 0.010 | 0.002 | 0.004 | 0.028 | 336.6 | 5.5 | 36.8 | 26.4 |
| 94/95* | | | | | | | | | | | | | | | |
| PP-96/ | 0.920 | 0.080 | 0.839 | 0.026 | 0.011 | 0.038 | 0.035 | 0.016 | 0.004 | 0.010 | 0.021 | 438.4 | 13.5 | 16.8 | 21.3 |
| 97/98* | | | | | | | | | | | | | | | |
| PP-99/ | 0.807 | 0.193 | 0.646 | 0.039 | 0.018 | 0.071 | 0.089 | 0.049 | 0.016 | 0.032 | 0.040 | 1021.1 | 5.4 | 30.5 | 9.5 |
| 100/101* | | | | | | | | | | | | | | | |
| PP-115/ | 0.984 | 0.016 | 0.967 | 0.004 | 0.005 | 0.007 | 0.006 | 0.003 | 0.001 | 0.002 | 0.004 | 78.5 | 107.4 | 20.1 | 48.5 |
| 116* | | | | | | | | | | | | | | | |
| PP-117/ | 0.960 | 0.040 | 0.922 | 0.008 | 0.008 | 0.016 | 0.018 | 0.009 | 0.003 | 0.006 | 0.009 | 202.0 | 53.1 | 81.0 | 29.8 |
| 118/119* | | | | | | | | | | | | | | | |
| PP-128 | 0.975 | 0.025 | 0.940 | 0.012 | 0.011 | 0.013 | 0.006 | 0.005 | 0.002 | 0.003 | 0.008 | 114.4 | 28.7 | 68.3 | 47.3 |
| PP-130 | 0.961 | 0.039 | 0.913 | 0.021 | 0.006 | 0.023 | 0.008 | 0.010 | 0.001 | 0.003 | 0.014 | 199.9 | 6.8 | 85.3 | 34.2 |
| CPP-1 | 0.948 | 0.052 | 0.875 | 0.043 | 0.002 | 0.043 | 0.009 | 0.003 | 0.001 | 0.003 | 0.021 | 270.5 | | 7.0 | 34.3 |
| CPP-5 | 0.950 | 0.050 | 0.885 | 0.037 | 0.002 | 0.040 | 0.008 | 0.004 | 0.002 | 0.002 | 0.020 | 260.0 | | 5.0 | 35.0 |
| CPP-6 | 0.893 | 0.107 | 0.763 | 0.073 | 0.005 | 0.077 | 0.019 | 0.010 | 0.005 | 0.008 | 0.041 | 529.0 | | 25.0 | 17.7 |
| CPP-9 | 0.898 | 0.102 | 0.776 | 0.068 | 0.004 | 0.073 | 0.018 | 0.009 | 0.005 | 0.008 | 0.039 | 502.5 | | 26.0 | 18.7 |
| CPP-14 | 0.887 | 0.113 | 0.764 | 0.055 | 0.014 | 0.074 | 0.024 | 0.010 | 0.007 | 0.009 | 0.043 | 531.8 | 7.6 | 20.5 | 17.9 |
| CPP-16 | 0.835 | 0.165 | 0.666 | 0.078 | 0.013 | 0.108 | 0.034 | 0.015 | 0.010 | 0.016 | 0.061 | 763.8 | 6.3 | 31.4 | 12.5 |
| CPP-18 | 0.887 | 0.113 | 0.728 | 0.092 | 0.013 | 0.083 | 0.017 | 0.009 | 0.008 | 0.008 | 0.043 | 539.6 | | 16.4 | 18.0 |
| CPP-21 | 0.768 | 0.232 | 0.458 | 0.148 | 0.052 | 0.146 | 0.052 | 0.023 | 0.020 | 0.025 | 0.075 | 1063.3 | | 27.0 | 9.2 |

*Polymers from replicate experiments were combined for NMR analysis.
*No 2,1-regio (te) or 2,1-regio (et) were observed.

Table 5 describes lab reactor scale slurry polymerization data using supported catalysts 1, 13, 14, and 15. Supported catalysts 1, 13, and 14 showed excellent particle morphology and activities when ran in bulk propylene at 70° C. The polymers produced were isotactic with pentad range from 0.687-0.926 (Table 6). Supported catalyst compounds 13 and 15 both exhibit higher than usual content of vinyl terminated chain ends (40%-67%).

TABLE 5
Propylene polymerization using supported catalysts 1 and 13-15.

| | | | | | Produc- | | | | | |
|---|---|---|---|---|---|---|---|---|---|---|
| Supported | Catalyst | H₂ | Time | Yield | tivity | Mn | Mw | | Tm | Tc |
| Complex | (mg) | (mmol) | (min) | (g) | (g/g · h) | (g/mol) | (g/mol) | PDI | (° C.) | (° C.) |
| 1 | 25.0 | 2 | 30 | 108.4 | 8,672 | 44,815 | 147,288 | 3.29 | 143.6 | 102.3 |
| 13 | 25.0 | 2 | 30 | 110.3 | 8,828 | 36,193 | 120,828 | 3.34 | 148.6 | 105.7 |
| 14 | 25.0 | 2 | 30 | 86.2 | 6,887 | 45,828 | 134,868 | 2.94 | 145.8 | 102.9 |
| 15 | 25.0 | 2 | 30 | 75.5 | 6,030 | 21,345 | 54,402 | 2.55 | 129.0 | 88.8 |

TABLE 6
NMR results regarding tacticity and chain-end unsaturations.

| | ¹³C NMR tacticity/ | | | | | | |
|---|---|---|---|---|---|---|---|
| | regioselectivity | | | ¹H NMR chain-end unsaturation | | | |
| Supported | | Total | 2,1 | % | % | % | % |
| Complex | mmmm | stereo* | defects\hat{ } | vinylene | trisubstituted | vinyl | vinylidene |
| 1 | 0.926 | 170 | 138 | 8.9% | 31.1% | 26.7% | 33.3% |
| 13 | 0.897 | 204 | 14 | 3.9% | 15.7% | 41.2% | 39.2% |
| 14 | 0.877 | 253 | 16 | 6.0% | 18.0% | 30.0% | 46.0% |
| 15 | 0.687 | 676 | 0 | 1.5% | 6.8% | 67.4% | 24.2% |

*stereo defects/10000 monomer;
\hat{ }2,1-regio defects/10000 monomer

Small Scale High throughput polymerization of propylene and ethylene-propylene was carried out in solution using MAO activation. The data of the high throughput polymerization in addition to the one in Table 3 are described in Table 7. The oxidized species 1-BF4 and 14-BF4 both show improvements to molecular weight capability of isotactic polypropylene (iPP) and ethylene-propylene (EP) rubber. In addition, these molecules also promote higher crystallinity (Tm) relative to parent complexes 1 and 14. Owing to, e.g., the versatility of these systems, all catalysts showed excellent activity and produced polymers of varying Mw (ca 20-300 kDa), Tm (ca 100-150° C.) and wt % of ethylene in EP (ca 20 wt %-50 wt %).

TABLE 7
High throughput polymerization of propylene and ethylene-propylene copolymerization
using ferrocene based catalysts. Conditions: 1 mL liquid propylene, 500 equiv MAO
at 70° C. In examples where ethylene was used, 60 psi of ethylene gas was added
on top of 1 mL of liquid propylene for a total approximate pressure of 175 psi.

| | | | | | | | | | Wt % |
|---|---|---|---|---|---|---|---|---|---|
| | Propylene | Ethylene | Quench | Yield | Productivity | Mn | Mw | Tm | C₂ in |
| Complex | (psi) | (psi) | time (s) | (mg) | (kg/mmol · h) | (g/mol) | (g/mol) | (° C.) | rubber |
| 1 | 115 | — | 68 | 238.6 | 421.1 | 72,707 | 116,963 | 148.5 | — |
| 1 | 115 | — | 71 | 257.9 | 435.9 | 71,238 | 158,006 | 148.4 | — |
| 1 | 115 | — | 74 | 228.3 | 370.2 | 57,175 | 109,785 | 147.2 | — |
| 1 | 115 | 60 | 24 | 383.3 | 2874.8 | 25,957 | 67,213 | — | 23.7 |
| 1 | 115 | 60 | 25 | 392.8 | 2828.2 | 28,306 | 79,397 | — | 22.1 |
| 1 | 115 | 60 | 17 | 291.4 | 3085.4 | 34,934 | 84,857 | — | 20.4 |
| 1-BF4 | 115 | — | 336 | 119.3 | 42.6 | 163,094 | 268,843 | 150.6 | — |
| 1-BF4 | 115 | — | 344 | 126.8 | 44.2 | 183,236 | 295,038 | 150.3 | — |
| 1-BF4 | 115 | — | 377 | 128.1 | 40.8 | 180,898 | 294,479 | 150.6 | — |
| 1-BF4 | 115 | 60 | 59 | 236.3 | 720.9 | 85,815 | 133,960 | — | 21.9 |
| 1-BF4 | 115 | 60 | 63 | 246 | 702.9 | 88,689 | 136,837 | — | 20.3 |
| 1-BF4 | 115 | 60 | 64 | 227.3 | 639.3 | 95,592 | 149,799 | — | 19.8 |
| 13 | 115 | — | 102 | 205 | 241.2 | 22,474 | 37,687 | 139.3 | — |
| 13 | 115 | — | 105 | 223.4 | 255.3 | 20,305 | 37,382 | 139.6 | — |
| 13 | 115 | — | 96 | 195.4 | 244.3 | 19,613 | 35,708 | 139.6 | — |
| 13 | 115 | 60 | 33 | 254.3 | 1387.1 | 36,468 | 94,412 | — | 34.4 |
| 13 | 115 | 60 | 33 | 255.9 | 1395.8 | 29,301 | 87,196 | — | 39.8 |
| 13 | 115 | 60 | 32 | 235.9 | 1326.9 | 38,252 | 91,409 | — | 36.2 |
| 14 | 115 | — | 107 | 218.8 | 245.4 | 41,340 | 63,570 | 138.3 | — |
| 14 | 115 | — | 118 | 221.4 | 225.2 | 32,134 | 53,581 | 137.8 | — |
| 14 | 115 | — | 120 | 220.5 | 220.5 | 32,156 | 55,857 | 138.3 | — |
| 14 | 115 | 60 | 38 | 246.5 | 1167.6 | 50,984 | 104,536 | — | 37.0 |
| 14 | 115 | 60 | 40 | 236.8 | 1065.6 | 36,042 | 91,965 | — | 35.4 |
| 14 | 115 | 60 | 39 | 226.6 | 1045.8 | 50,635 | 104,822 | — | 32.4 |
| 14-BF4 | 115 | — | 242 | 93.2 | 46.2 | 54,373 | 82,826 | 141.4 | — |
| 14-BF4 | 115 | — | 282 | 119.4 | 50.8 | 51,622 | 82,432 | 141.8 | — |
| 14-BF4 | 115 | 60 | 58 | 134.1 | 416.2 | 90,184 | 150,529 | — | 51.5 |
| 14-BF4 | 115 | 60 | 61 | 133.4 | 393.6 | 83,149 | 133,995 | — | 48.2 |
| 14-BF4 | 115 | 60 | 60 | 113.9 | 341.7 | 108,983 | 171,307 | — | 42.1 |
| 15 | 115 | — | 196 | 117.7 | 72.1 | 13,228 | 20,974 | 98.6 | — |
| 15 | 115 | — | 228 | 141.1 | 74.3 | 14,305 | 24,779 | 101.8 | — |
| 15 | 115 | — | 259 | 134.1 | 62.1 | 14,293 | 21,564 | 100.1 | — |
| 15 | 115 | 60 | 61 | 161.7 | 477.1 | 34,252 | 59,001 | — | 31.6 |
| 15 | 115 | 60 | 63 | 162.2 | 463.4 | 26,720 | 52,983 | — | 34.0 |
| 15 | 115 | 60 | 60 | 149.5 | 448.5 | 31,062 | 57,371 | — | 34.6 |

Overall, metallocene catalyst compounds of the present disclosure having a ferrocene moiety at the 4-position of an aryl ligand have been found to provide polymers at high activities. The polymers formed can have one or more of a high molecular weight, high comonomer incorporation, high melt temperature, narrow polydispersity index, and/or (in the case polypropylenes) isotacticity. Ethylene copolymers formed using catalysts of the present disclosure can have high molecular weight and high comonomer incorporation, where the high comonomer incorporation can improve processability of the ethylene copolymer formed while maintaining most, if not all, of the mechanical property advantages provided by high molecular weight. Interestingly, isotactic polypropylene can be obtained. In addition, high activity of catalysts of the present disclosure can be obtained even though the ferrocenyl substituent is located on a 6-membered ring of the indenyl, as compared to a ferrocenyl substituent located on a 5-membered ring of the indenyl which is the ring closer to the catalytic metal atom. The oxidation state of iron atom(s) of catalyst compounds of the present disclosure can also be readily tunable with oxidizing agents or reducing agents to provide tunability and controllability of polymer properties of polymers formed using catalyst compounds of the present disclosure.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All documents described herein are incorporated by reference herein, including any priority documents and or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

While the present disclosure has been described with respect to a number of embodiments and examples, those skilled in the art, having benefit of this disclosure, will appreciate that other embodiments can be devised which do not depart from the scope and spirit of the present disclosure.

We claim:

1. A catalyst compound represented by Formula (I): 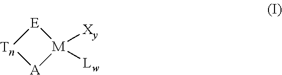
wherein:
M is a group 3-5 metal atom, a lanthanide metal atom, or an actinide metal atom of the Periodic Table of Elements;
E is a substituted polycyclic arenyl ligand bonded to M and is substituted by at least one ferrocenyl substituent bonded to an aromatic six-membered ring of the polycyclic arenyl ligand;
A is a monoanionic ligand bonded to M;
n is 0 or 1;
T is bonded to A and E, and is a bridging group containing a group 13, 14, 15, or 16 element of the Periodic Table of Elements, and is present when n is one and absent when n is zero;
each instance of X is independently a univalent anionic ligand, or two Xs are joined and bound to M to form a metallocycle ring, or two Xs are joined to form a chelating ligand, a diene ligand, or an alkylidene ligand;
each instance of L is independently a Lewis base, or two Ls are joined and bound to M to form a bidentate Lewis base;
an X may be joined to an L to form a monoanionic bidentate group;
y is 1, 2, or 3;
w is 0, 1, or 2; and
y+w is 4 or less.

2. The catalyst compound of claim 1, wherein the at least one ferrocenyl substituent is represented by Formula (Ia): 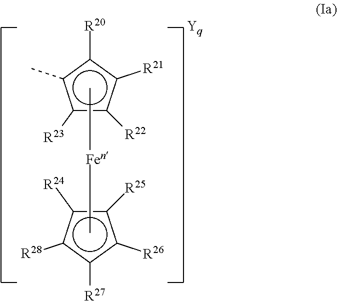
wherein Fe is Fe(II) or Fe(III) and each of R²⁰, R²¹, R²², R²³, R²⁴, R²⁵, R²⁶, R²⁷, and R²⁸ is independently hydrogen, hydrocarbyl, or any adjacent R²⁰, R²¹, R²², R²³, R²⁴, R²⁵, R²⁶, R²⁷, and R²⁸ may optionally be joined to form one or more hydrocarbyl rings or heterocyclic rings each having 5, 6, 7, or 8 ring atoms;
the dashed line indicates a bond to the polycyclic arenyl ligand of E of Formula (I);
n′ is the charge on Fe wherein n′ is zero when Fe is Fe(II), and n′ is +1 when Fe is Fe(III); and
Y, when present, is a non-coordinating anion with a charge of −1 and is present when q is 1 and n′ is +1, and is absent when q is 0 and n′ is 0.

3. (canceled)

4. (canceled)

5. The catalyst compound of claim 2, wherein Y is selected from the group consisting of tetrakis(3,5-bis(trifluoromethyl)phenyl borate, tetrafluoroborate, antimonyhexafluoride, phosphoroushexafluoride, tetrakis(perfluorophenylborate), and tetraphenylborate.

6. The catalyst compound of claim 2, wherein each of R²⁰, R²¹, R²², R²³, R²⁴, R²⁵, R²⁶, R²⁷, and R²⁸ of Formula (Ia) is hydrogen.

7. The catalyst compound of any of claim 1, wherein E is selected from the group consisting of substituted indenyl, fluorenyl, cyclopenta[b]naphthalenyl, cyclopenta[a]naphthalenyl, tetrahydro-s-indacenyl, and tetrahydro-as-indacenyl.

8. The catalyst compound of claim 1, wherein the at least one ferrocenyl substituent of Formula (Ia) is located at a 4-position of E.

9. The catalyst compound of any claim 1, wherein A is selected from the group consisting of substituted or unsubstituted cyclopentadienyl, indenyl, fluorenyl, cyclopenta[b]naphthalenyl, cyclopenta[a]naphthalenyl, tetrahydro-s-indacenyl, and tetrahydro-as-indacenyl.

10. The catalyst compound of claim 1, wherein A is a monoanionic ligand represented by formula JR″ₘ₋₁₋ₙ, wherein J is a heteroatom with a coordination number of three from group 15 or a heteroatom with a coordination number of two from group 16 of the Periodic Table of Elements; each instance of R″ is independently hydrocarbyl; and m is the coordination number of the heteroatom J such that “m−1−n” indicates the number of R″ substituents bonded to J, and n is 0 or 1.

11. The catalyst compound of claim 1, wherein the catalyst compound is represented by Formulas (IIa), (IIb): (IIIa), (IIIb), (IVa), or (IVb): 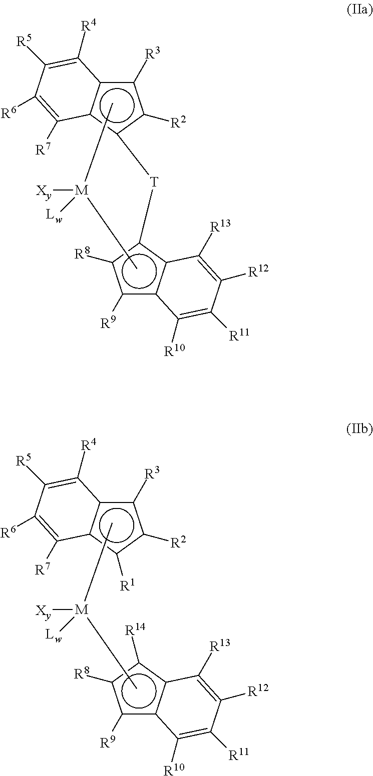 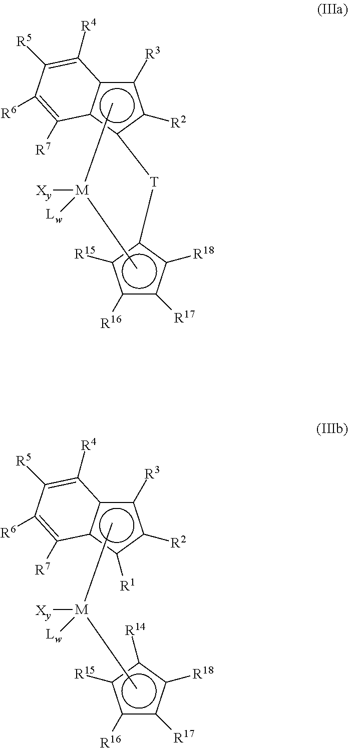 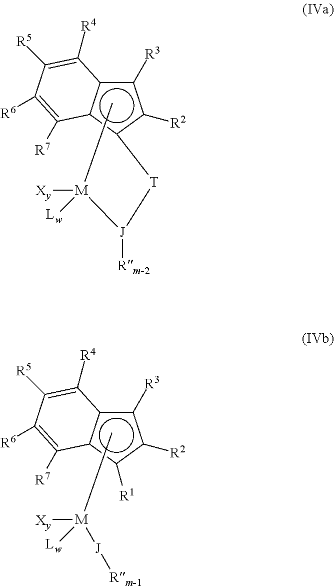
wherein:
M, T, L, X, y, and w are as described as for Formula (I);
each of R⁴, R⁵, R⁶ and R⁷ is independently a hydrogen, a substituted or unsubstituted hydrocarbyl, a heteroatom or heteroatom-containing group, or a ferrocenyl substituent provided that at least one of R⁴, R⁵, R⁶ or R⁷ is a ferrocenyl substituent, and optionally adjacent R⁴, R⁵, R⁶, and R⁷ that are not ferrocenyl may be joined to form one or more substituted hydrocarbyl rings or heterocyclic rings each having 5, 6, 7, or 8 ring atoms;
each of R¹⁰, R¹¹, R¹² and R¹³ of Formula (IIa) and Formula (IIb) is independently a hydrogen, substituted or unsubstituted hydrocarbyl, a heteroatom or heteroatom-containing group, or ferrocenyl substituent, and any adjacent R¹⁰, R¹¹, R¹² and R¹³ that are not ferrocenyl may be joined to form one or more substituted or unsubstituted hydrocarbyl rings or heterocyclic rings each having 5, 6, 7, or 8 ring atoms;
each of (when present) R¹, R², R³, R⁸, R⁹, R¹⁴, R¹⁵, R¹⁶, R¹⁷, R¹⁸, and R¹⁹ of Formula (IIa), Formula (IIb), Formula (IIIa), Formula (IIIb), Formula (IVa), and/or Formula (IVb) is independently a hydrogen, substituted or unsubstituted hydrocarbyl, a heteroatom or heteroatom-containing group, and any two adjacent R¹, R², R³, R⁸, R⁹, R¹⁴, R¹, R¹⁶, R¹⁷, R¹⁸, and R¹⁹ may optionally be joined to form one or more substituted or unsubstituted hydrocarbyl rings or heterocyclic rings each having 5, 6, 7, or 8 ring atoms;
J of Formula (IVa), and/or Formula (IVb) is a heteroatom with a coordination number of three from group 15 or with a coordination number of two from group 16 of the Periodic Table of Elements;
and each R″ is independently substituted or unsubstituted hydrocarbyl, and m is the coordination number of the heteroatom J such that “m−2” and “m−1” indicates the number of R″ substituents bonded to J.

12. (canceled)

13. (canceled)

14. The catalyst compound of claim 11, wherein J of Formula (IVa) and Formula (IVb) is nitrogen and each instance of un is selected from the group consisting of tert-butyl, neopentyl, cyclohexyl, cyclooctyl, cyclodecyl, cyclododeceyl, adamantan-1-yl, adamantan-2-yl, norborn-1-yl, norborn-2-yl, benzyl, and ethylphenyl.

15. The catalyst compound of claim 1, wherein each instance of X of Formula (I), Formula (IIa), Formula (IIb), Formula (IIIa), Formula (IIIb), Formula (IVa), and Formula (IVb) is independently selected from the group consisting of methyl, benzyl, trimethylsilyl, methylene(trimethylsilyl), neopentyl, ethyl, propyl, butyl, phenyl, hydrido, chloro, fluoro, bromo, iodo, trifluoromethanesulfonate, dimethylamido, diethylamido, dipropylamido, and diisopropylamido.

16. The catalyst compound of claim 1, wherein each instance of L of Formula (I), Formula (IIa), Formula (IIb), Formula (IIIa), Formula (IIIb), Formula (IVa), and Formula (IVb) is independently selected from the group consisting of Et₂O, MeOtBu, Et₃N, PhNMe₂, MePh₂N, tetrahydrofuran, and methyl acetate.

17. The catalyst compound of claim 1, wherein M of Formula (I), Formula (IIa), Formula (IIb), Formula (IIIa), Formula (IIIb), Formula (IVa), and Formula (IVb) is Zr, Hf, or Ti.

18. The catalyst compound of claim 1, wherein n is 1 and T of Formula (I), Formula (IIa), Formula (IIIa), and Formula (IVa) is selected from the group consisting of CH₂, CH₂CH₂, C(CH₃)₂, CPh₂, SiMe₂, SiPh₂, SiMePh, Si(CH₂)₃, Si(CH₂)₄, and Si(CH₂)₅.

19. The catalyst compound of claim 11, wherein the catalyst compound of Formula (IIa), Formula (IIIa), or Formula (IVa) is selected from the group consisting of:
rac-dimethylsilanediyl-bis(η⁵-4-ferrocenyl-2-methylinden-1-yl)zirconium dichloride,
rac-dimethylsilanediyl-bis(η⁵-4-ferrocenyl-2-methylinden-1-yl)zirconium dimethyl,
rac-dimethylsilanediyl-bis(η⁵-4-ferrocenyl-2-methylinden-1-yl)hafnium dichloride,
rac-dimethylsilanediyl-bis(η⁵-4-ferrocenyl-2-methylinden-1-yl)hafnium dimethyl,
rac-dimethylsilanediyl-bis(η⁵-2-butyl-4-ferrocenylinden-1-yl)zirconium dichloride,
rac-dimethylsilanediyl-bis(η⁵-2-butyl-4-ferrocenylinden-1-yl)zirconium dimethyl,
rac-dimethylsilanediyl-bis(η⁵-2-butyl-4-ferrocenylinden-1-yl)hafnium dichloride,
rac-dimethylsilanediyl-bis(η⁵-2-butyl-4-ferrocenylinden-1-yl)hafnium dimethyl,
rac-dimethylsilanediyl-bis(η⁵-6-tert-butyl-4-ferrocenyl-5-methoxy-2-methylinden-1-yl)zirconium dichloride,
rac-dimethylsilanediyl-bis(η⁵-6-tert-butyl-4-ferrocenyl-5-methoxy-2-methylinden-1-yl)zirconium dimethyl,
rac-dimethylsilanediyl-bis(η⁵-6-tert-butyl-4-ferrocenyl-5-methoxy-2-methylinden-1-yl)hafnium dichloride,
rac-dimethylsilanediyl-bis(η⁵-6-tert-butyl-4-ferrocenyl-5-methoxy-2-methylinden-1-yl)hafnium dimethyl,
rac-dimethylsilanediyl-bis(η⁵-4-ferrocenyl-2,6,6-trimethyl-1,5,6,7-tetrahydro-s-indacen-1-yl)zirconium dichloride,
rac-dimethylsilanediyl-bis(η⁵-4-ferrocenyl-2,6,6-trimethyl-1,5,6,7-tetrahydro-s-indacen-1-yl)zirconium dimethyl,
rac-dimethylsilanediyl-bis(η⁵-4-ferrocenyl-2,6,6-trimethyl-1,5,6,7-tetrahydro-s-indacen-1-yl)hafnium dichloride,
rac-dimethylsilanediyl-bis(η⁵-4-ferrocenyl-2,6,6-trimethyl-1,5,6,7-tetrahydro-s-indacen-1-yl)hafnium dimethyl,
(dimethylsilanediyl)(η⁵-2-butyl-4-ferrocenylinden-1-yl)(κ¹-tert-butylamido)dimethyltitanium,
(dimethylsilanediyl)(η⁵-2-butyl-4-ferrocenylinden-1-yl)(κ¹-tert-butylamido)dimethylzirconium,
(dimethylsilanediyl)(η⁵-2-butyl-4-ferrocenylinden-1-yl)(κ¹-tert-butylamido)dimethylhafnium,
(dimethylsilanediyl)(η⁵-2-butyl-4-ferrocenylinden-1-yl)(κ¹-tert-butylamido)titanium dichloride,
(dimethylsilanediyl)(η⁵-2-butyl-4-ferrocenylinden-1-yl)(κ¹-tert-butylamido)zirconium dichloride,
(dimethylsilanediyl)(η⁵-2-butyl-4-ferrocenylinden-1-yl)(κ¹-tert-butylamido)hafnium dichloride,
(dimethylsilanediyl)(η⁵-6-tert-butyl-4-ferrocenyl-5-methoxy-2-methyl-1H-inden-1-yl)-(κ¹-tert-butylamido)dimethyltitanium,
(dimethylsilanediyl)(η⁵-6-tert-butyl-4-ferrocenyl-5-methoxy-2-methyl-1H-inden-1-yl)-(κ¹-tert-butylamido)dimethylzirconium,
(dimethylsilanediyl)(η⁵-6-tert-butyl-4-ferrocenyl-5-methoxy-2-methyl-1H-inden-1-yl)-(κ¹-tert-butylamido)dimethylhafnium,
(dimethylsilanediyl)(η⁵-6-tert-butyl-4-ferrocenyl-5-methoxy-2-methyl-1H-inden-1-yl)-(κ¹-tert-butylamido)titanium dichloride,
(dimethylsilanediyl)(η⁵-6-tert-butyl-4-ferrocenyl-5-methoxy-2-methyl-1H-inden-1-yl)-(κ¹-tert-butylamido)zirconium dichloride,
(dimethylsilanediyl)(η⁵-6-tert-butyl-4-ferrocenyl-5-methoxy-2-methyl-1H-inden-1-yl)-(κ¹-tert-butylamido)hafnium dichloride,
(dimethylsilanediyl)(η⁵-4-ferrocenyl-2,6,6-trimethyl-1,5,6,7-tetrahydro-s-indacen-1-yl)(κ¹-tert-butylamido)dimethyltitanium,
(dimethylsilanediyl)(η⁵-4-ferrocenyl-2,6,6-trimethyl-1,5,6,7-tetrahydro-s-indacen-1-yl)(κ¹-tert-butylamido)dimethylzirconium,
(dimethylsilanediyl)(η⁵-4-ferrocenyl-2,6,6-trimethyl-1,5,6,7-tetrahydro-s-indacen-1-yl)(κ¹-tert-butylamido)dimethylhafnium,
(dimethylsilanediyl)(η⁵-4-ferrocenyl-2,6,6-trimethyl-1,5,6,7-tetrahydro-s-indacen-1-yl)(κ¹-tert-butylamido)titanium dichloride,
(dimethylsilanediyl)(η⁵-4-ferrocenyl-2,6,6-trimethyl-1,5,6,7-tetrahydro-s-indacen-1-yl)(κ¹-tert-butylamido)zirconium dichloride,
(dimethylsilanediyl)(η⁵-4-ferrocenyl-2,6,6-trimethyl-1,5,6,7-tetrahydro-s-indacen-1-yl)(κ¹-tert-butylamido)hafnium dichloride,
dimethylsilanediyl(η⁵-4-ferrocenyl-2-methylinden-1-yl)(tetramethylcyclopentadienyl)zirconium dichloride,
dimethylsilanediyl(η⁵-4-ferrocenyl-2-methylinden-1-yl)(tetramethylcyclopentadienyl)zirconium dimethyl,
dimethylsilanediyl(η⁵-4-ferrocenyl-2-methylinden-1-yl)(tetramethylcyclopentadienyl)hafnium dichloride,
dimethylsilanediyl(η⁵-4-ferrocenyl-2-methylinden-1-yl)(tetramethylcyclopentadienyl)hafnium dimethyl,
dimethylsilanediyl(η⁵-4-ferrocenyl-2-isopropylinden-1-yl)(tetramethylcyclopentadienyl)zirconium dichloride,
dimethylsilanediyl(η⁵-4-ferrocenyl-2-isopropylinden-1-yl)(tetramethylcyclopentadienyl)zirconium dimethyl,
dimethylsilanediyl(η⁵-4-ferrocenyl-2-isopropylinden-1-yl)(tetramethylcyclopentadienyl)hafnium dichloride,
dimethylsilanediyl(η⁵-4-ferrocenyl-2-isopropylinden-1-yl)(tetramethylcyclopentadienyl)hafnium dimethyl,
dimethylsilanediyl(η⁵-6-tert-butyl-4-ferrocenyl-5-methoxy-2-methylinden-1-yl) (tetramethylcyclopentadienyl)zirconium dichloride,
dimethylsilanediyl(η⁵-6-tert-butyl-4-ferrocenyl-5-methoxy-2-methylinden-1-yl) (tetramethylcyclopentadienyl)zirconium dimethyl,
dimethylsilanediyl(η⁵-6-tert-butyl-4-ferrocenyl-5-methoxy-2-methylinden-1-yl) (tetramethylcyclopentadienyl)hafnium dichloride,
dimethylsilanediyl(η⁵-6-tert-butyl-4-ferrocenyl-5-methoxy-2-methylinden-1-yl) (tetramethylcyclopentadienyl)hafnium dimethyl,
dimethylsilanediyl(η⁵-4-ferrocenyl-2-methyl-1,5,6,7-tetrahydro-s-indacen-1-yl)(tetramethylcyclopentadienyl)zirconium dichloride,
dimethylsilanediyl(η⁵-4-ferrocenyl-2-methyl-1,5,6,7-tetrahydro-s-indacen-1-yl)(tetramethylcyclopentadienyl)zirconium dimethyl,
dimethylsilanediyl(η⁵-4-ferrocenyl-2-methyl-1,5,6,7-tetrahydro-s-indacen-1-yl)(tetramethylcyclopentadienyl)hafnium dichloride,
dimethylsilanediyl(η⁵-4-ferrocenyl-2-methyl-1,5,6,7-tetrahydro-s-indacen-1-yl)(tetramethylcyclopentadienyl)hafnium dimethyl,
dimethylsilanediyl(η⁵-4-ferrocenyl-2,6,6-trimethyl-1,5,6,7-tetrahydro-s-indacen-1-yl)(tetramethylcyclopentadienyl)zirconium dichloride,
dimethylsilanediyl(η⁵-4-ferrocenyl-2,6,6-trimethyl-1,5,6,7-tetrahydro-s-indacen-1-yl)(tetramethylcyclopentadienyl)zirconium dimethyl,
dimethylsilanediyl(η⁵-4-ferrocenyl-2,6,6-trimethyl-1,5,6,7-tetrahydro-s-indacen-1-yl)(tetramethylcyclopentadienyl)hafnium dichloride, and
dimethylsilanediyl(η⁵-4-ferrocenyl-2,6,6-trimethyl-1,5,6,7-tetrahydro-s-indacen-1-yl)(tetramethylcyclopentadienyl)hafnium dimethyl.

20. (canceled)

21. (canceled)

22. A catalyst system comprising an activator and the catalyst compound of claim 1.

23. The catalyst system of claim 22, further comprising a support material.

24. (canceled)

25. The catalyst system of claim 22, wherein the activator comprises a non-coordinating anion activator and/or an alkylalumoxane.

26. (canceled)

27. A process for producing an ethylene alpha-olefin copolymer, the process comprising:
polymerizing ethylene and at least one C₃-C₂₀ alpha-olefin by introducing the ethylene and the at least one C₃-C₂₀ alpha-olefin with a catalyst system of claim 22, in one or more continuous stirred tank reactors or loop reactors, in series or in parallel, at a reactor pressure of 0.05 MPa to 1,500 MPa and a reactor temperature of 30° C. to 230° C. to form the ethylene alpha-olefin copolymer.

28. The process of claim 27, wherein the ethylene alpha-olefin copolymer has:
a comonomer content of C₃-C₂₀ alpha-olefin units of about 10 wt % to about 35 wt %, and
a z-average molecular weight (Mz) of about 200,000 g/mol to about 5,000,000 g/mol.

29. A process for producing a propylene homopolymer or a propylene copolymer, the process comprising:
polymerizing propylene and optionally a comonomer selected from the group consisting of C₂, C₄-C₂₀ alpha-olefin, and combinations thereof by introducing the propylene and the optional comonomer with a catalyst system of claim 22, in one or more continuous stirred tank reactors or loop reactors, in series or in parallel, at a reactor pressure of 0.05 MPa to 1,500 MPa and a reactor temperature of 30° C. to 230° C. to form the propylene homopolymer or the propylene copolymer.

30. (canceled)

31. The process of claim 29, wherein the process produces the propylene homopolymer and the propylene homopolymer has:
a z-average molecular weight (Mz) of about 200,000 g/mol to about 800,000 g/mol,
a polydispersity index (PDI) value of about 1 to about 3, and
a melt temperature (Tm) of about 135° C. to about 150° C.

32. The process of claim 29, wherein the process produces the propylene homopolymer and the propylene homopolymer has:
a meso dyad content of about 90% to about 99%,
an [mmmm] pentad content of about 80% to about 97%, and
less than 125 2,1-regio defects per 10,000 propylene units.
